(19) United States
(12) Patent Application Publication
(10) Pub. No.: US 2024/0413883 A1
(43) Pub. Date: Dec. 12, 2024

(54) DEVICE OF WIRELESS COMMUNICATION

(71) Applicant: GUANGDONG OPPO MOBILE TELECOMMUNICATIONS CORP., LTD., Dongguan (CN)

(72) Inventors: Pei ZHOU, Dongguan (CN); Lei HUANG, Singapore (SG)

(21) Appl. No.: 18/807,782

(22) Filed: Aug. 16, 2024

Related U.S. Application Data
(63) Continuation of application No. PCT/CN2022/076873, filed on Feb. 18, 2022.

(51) Int. Cl. H04B 7/08; H04B 7/06

(52) U.S. Cl. CPC H04B 7/086; H04B 7/0626

(57) ABSTRACT

A first AP includes: a memory configured to store a computer program, and a processor configured to invoke and execute the computer program stored in the memory, to perform acquiring target CSI. The target CSI includes CSI between a first-type AP and a first-type STA, where the first-type AP is an AP participating in a multi-AP coordinated transmission with a C-BF scheme in a multi-AP coordinated set, the first-type STA is an STA participating in the multi-AP coordinated transmission with the C-BF scheme, the target CSI is used to calculate a steering matrix corresponding to each first-type AP in the multi-AP coordinated set, and the steering matrix corresponding to the first-type AP is used by the first-type AP to perform the multi-AP coordinated transmission with the C-BF scheme.

### CROSS-REFERENCE TO RELATED APPLICATION

This application is a Continuation Application of International Application No. PCT/CN2022/076873 filed Feb. 18, 2022, which is incorporated herein by reference in its entirety.

### TECHNICAL FIELD

Embodiments of the present application relate to the field of communication, and in particular, to a method and a device of wireless communication.

### BACKGROUND

In some scenarios, a multi-access point (Access Point, AP) coordinated transmission technology of a coordinated beamforming (C-BF) scheme is introduced. The C-BF is that multiple APs transmit or align useful signals to a target station (STATION, STA) by a method of beamforming, while transmitting or aligning nulls to an STA of overlapping basic service set (OBSS), to achieve interference suppression and improve signal to interference plus noise ratio (SINR) of the communication link, thereby improving throughput and reducing communication latency. Therefore, how to calculate a steering matrix for the C-BF to achieve effective interference suppression is an urgent problem to be solved.

### SUMMARY

In a first aspect, a method of wireless communication is provided, including: acquiring by a first access point (AP), target channel state information (CSI), the target CSI includes CSI between a first-type AP and a first-type station (STA), where the first-type AP is an AP participating in a multi-AP coordinated transmission with a coordinated beamforming (C-BF) scheme in a multi-AP coordinated set, and the first-type STA is an STA participating in a multi-AP coordinated transmission with a C-BF scheme, and the target CSI is used to calculate a steering matrix corresponding to each first-type AP in the multi-AP coordinated set, and the steering matrix corresponding to the first-type AP is used by the first-type AP to perform the multi-AP coordinated transmission with the C-BF scheme.

In a second aspect, a method of wireless communication is provided, including: transmitting by a second access point (AP), first type of channel state information (CSI) and/or second-type CSI obtained by a second AP to a first AP, where the second AP is a first-type AP in a multi-AP coordinated set, the first-type CSI obtained by the second AP includes CSI between the second AP and a first-type station (STA) associated with the second AP, the second-type CSI obtained by the second AP includes CSI between the second AP and a first-type STA in an overlapping basic service set (OBSS) of the second AP, the first-type AP is an AP participating in a multi-AP coordinated transmission with a coordinated beamforming (C-BF) scheme, and the first-type STA is an STA participating in a multi-AP coordinated transmission with a C-BF scheme.

In a third aspect, a method of wireless communication is provided, including: acquiring by a master access point (AP), target channel state information (CSI), where the target CSI includes CSI between a first-type AP and a first-type station (STA), where the first-type AP is an AP participating in a multi-AP coordinated transmission with a coordinated beamforming (C-BF) scheme in a multi-AP coordinated set, the first-type STA is an STA participating in the multi-AP coordinated transmission with the C-BF scheme, the target CSI is used to calculate a steering matrix corresponding to each first type AP in the multi-AP coordinated set, and the steering matrix corresponding to the first-type AP is used by the first type AP to perform the multi-AP coordinated transmission with the C-BF scheme.

In a fourth aspect, an access point device is provided for performing the method in the above first aspect or its various implementations.

Specifically, the access point device includes a functional module for performing the method in the above first aspect or its various implementations.

In a fifth aspect, an access point device is provided for performing the method in the above second aspect or its various implementations.

Specifically, the access point device includes a functional module for performing the method in the above second aspect or its various implementations.

In a sixth aspect, a master access point device is provided for performing the method in the above third aspect or its various implementations.

Specifically, the master access point device includes a functional module for performing the method in the above third aspect or its various implementations.

In a seventh aspect, an access point device is provided, including a processor and a memory. The memory is configured to store a computer program, and the processor is configured to invoke and execute the computer program stored in the memory, to perform the method in the above first aspect or its various implementations.

In an eighth aspect, an access point device is provided, including a processor and a memory. The memory is configured to store a computer program, and the processor is configured to invoke and execute the computer program stored in the memory, to perform the method in the above second aspect or its various implementations.

In a ninth aspect, a master access point device is provided, including a processor and a memory. The memory is configured to store a computer program, and the processor is configured to invoke and execute the computer program stored in the memory, to perform the method in the above third aspect or its various implementations.

In a tenth aspect, a chip is provided for implementing the method in any one of the above first aspect to the above third aspect or their various implementations.

Specifically, the chip includes: a processor, configured to invoke and execute a computer program from a memory, to cause a device equipped with the apparatus to perform the method of any one of the above first aspect to the above third aspect or their various implementations.

In an eleventh aspect, a non-transitory computer readable storage medium is provided for storing a computer program, and the computer program causes a computer to perform the method of any one of the above first aspect to the above third aspect or their various implementations.

In a twelfth aspect, a computer program product is provided, including a computer program instruction, and the computer program instruction causes a computer to perform the method of any one of the above first aspect to the above third aspect or their various implementations.

In a thirteenth aspect, a computer program is provided, and the computer program, when being executed on a computer, causes the computer to perform the method of any one of the above first aspect to the above third aspect or their various implementations.

### BRIEF DESCRIPTION OF THE DRAWINGS

FIG. 1 is a schematic diagram of a communication system architecture, provided by the embodiments of the present application.

FIGS. 2A and 2B are schematic diagrams each showing a wired multi-AP coordinated architecture, applicable according to the embodiments of the present application.

FIG. 3 is a schematic diagram of a wireless multi-AP coordinated architecture, applicable according to the embodiments of the present application.

FIG. 4 is a schematic diagram of C-BF, provided according to the embodiments of the present application.

FIG. 5 is a flow chart of channel sounding of C-BF, provided according to the embodiments of the present application.

FIG. 6 is a schematic interaction diagram of a method of wireless communication, provided by the embodiments of the present application.

FIG. 7 is a schematic diagram of a sharing AP collecting CSI information in steps and shared APs responding synchronously.

FIG. 8 is a schematic diagram of a sharing AP collecting CSI information in steps and shared APs responding asynchronously.

FIG. 9 is a schematic diagram of a sharing AP collecting CSI information at one time and shared APs responding synchronously.

FIG. 10 is a schematic diagram of a sharing AP collecting CSI information at one time and shared APs responding asynchronously.

FIG. 11 is a schematic interaction diagram of a multi-AP coordinated transmission procedure, according to an embodiment of the present application.

FIG. 12 and FIG. 13 are schematic interaction diagrams of a sharing AP announcing a steering matrix by a coordinated transmission trigger frame.

FIG. 14 is a schematic diagram of a frame format of a coordinated transmission request frame, provided by the embodiments of the present application.

FIG. 15 is a schematic format diagram of a coordinated transmission scheme used field in the coordinated transmission request frame shown in FIG. 14.

FIG. 16 is a schematic format diagram of a C-BF command field in the coordinated transmission request frame shown in FIG. 14.

FIG. 17 is a schematic diagram of a frame format of a coordinated transmission response frame, provided by the embodiments of the present application.

FIG. 18 is a schematic format diagram of a coordinated transmission scheme accept field in the coordinated transmission response frame shown in FIG. 17.

FIG. 19 is a schematic format diagram of a C-BF information field in the coordinated transmission response frame shown in FIG. 17.

FIG. 20 is a schematic diagram of a frame format of a CSI request frame, provided by the embodiments of the present application.

FIG. 21 is a schematic diagram of a frame format of a CSI report frame, provided by the embodiments of the present application.

FIG. 22 is a schematic diagram of a frame format of a coordinated transmission announce frame, provided by the embodiments of the present application.

FIG. 23 is a schematic format diagram of a coordinated transmission scheme adopted field in the coordinated transmission announce frame shown in FIG. 22.

FIG. 24 is a schematic format diagram of a C-BF parameter field in the coordinated transmission announce frame shown in FIG. 22.

FIG. 25 is a schematic interaction diagram of a sharing AP calculating a steering matrix by a master AP and announcing the steering matrix by the sharing AP, provided by the embodiments of the present application.

FIG. 26 is another schematic interaction diagram of a sharing AP calculating a steering matrix by a master AP and announcing the steering matrix by the sharing AP, provided by the embodiments of the present application.

FIG. 27 is a schematic interaction diagram of a sharing AP calculating a steering matrix by a master AP and not announcing the steering matrix during a preparation phase, provided by the embodiments of the present application.

FIG. 28 is another schematic interaction diagram of a sharing AP calculating a steering matrix by a master AP and not announcing the steering matrix during a preparation phase, provided by the embodiments of the present application.

FIG. 29 is a schematic interaction diagram of a sharing AP calculating a steering matrix by a master AP and announcing the steering matrix by the sharing AP during a coordinated transmission phase, provided by the embodiments of the present application.

FIG. 30 is another schematic interaction diagram of a sharing AP calculating a steering matrix by a master AP and announcing the steering matrix by the sharing AP during a coordinated transmission phase, provided by the embodiments of the present application.

FIG. 31 is a schematic interaction diagram of a sharing AP calculating a steering matrix by a master AP and announcing the steering matrix by the master AP during a coordinated transmission phase, provided by the embodiments of the present application.

FIG. 32 is another schematic interaction diagram of a sharing AP calculating a steering matrix by a master AP and announcing the steering matrix by the master AP during a coordinated transmission phase, provided by the embodiments of the present application.

FIG. 33 is a schematic format diagram of a coordinated transmission matrix request frame, provided by the embodiments of the present application.

FIG. 34 is a schematic format diagram of a coordinated transmission matrix response frame, provided by the embodiments of the present application.

FIG. 35 and FIG. 36 are schematic interaction diagrams of transmitting CSI information by wired backhaul, provided by the embodiments of the present application.

FIG. 37 is a schematic block diagram of an access point device, provided by the embodiments of the present application.

FIG. 38 is a schematic block diagram of another access point device, provided by the embodiments of the present application.

FIG. 39 is a schematic block diagram of a master access point device, provided by the embodiments of the present application.

FIG. 40 is a schematic block diagram of a communication device, provided by the embodiments of the present application.

FIG. 41 is a schematic block diagram of a chip, provided by the embodiments of the present application.

FIG. 42 is a schematic block diagram of a communication system, provided by the embodiments of the present application.

### DETAILED DESCRIPTION

The technical solutions of the embodiments of the present application will be described below, in conjunction with the drawings in the embodiments of the present application. Obviously, the described embodiments are merely some but not all of the embodiments of the present application. All other embodiments obtained based on the embodiments of the present application by the ordinary skilled in the art shall belong to the protection scope of the present application.

The technical solutions of the embodiments of the present application may be applied to various communication systems, such as wireless local area network (WLAN), wireless fidelity (WiFi) or other communication systems, etc.

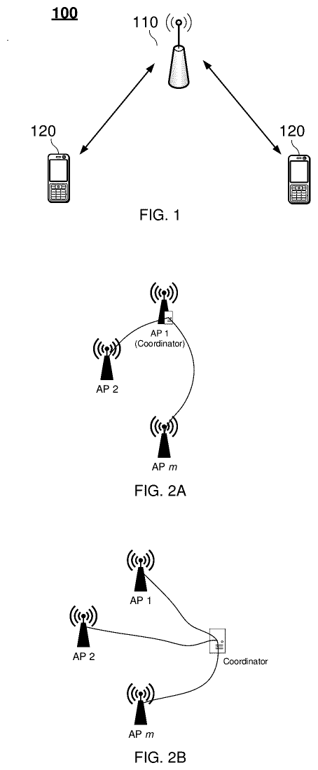

For example, a communication system 100 applied in the embodiments of the present application is shown in FIG. 1. The communication system 100 may include an access point (AP) 110 and stations (STATIONs, STAs) 120 which access a network by the access point 110.

In some scenarios, an AP may also be referred to as an AP STA. That is, in a sense, the AP is also a kind of STA.

In some scenarios, an STA is also referred to as a non-AP STA.

The communication in the communication system 100 may be a communication between an AP and a non-AP STA, a communication between a non-AP STA and a non-AP STA, or a communication between an STA and a peer STA. The peer STA may refer to a device that has a peer communication with the STA. For example, the peer STA may be an AP or a non-AP STA.

The AP is the equivalent of a bridge connecting a wired network and a wireless network, whose main role is to connect various wireless network clients together and then access the wireless network to Ethernet. The AP device may be a terminal device (e.g., a mobile phone) or network device (e.g., router) with a WiFi chip.

It should be understood that a role of the STA in the communication system is not absolute. For example, in some scenarios, in a case where a mobile phone is connected to a router, the mobile phone is the non-AP STA, and in a case where the mobile phone serves as a hotspot for other mobile phones, the mobile phone acts as the AP.

The AP and the non-AP STA may be devices applied in Vehicle to Everything, Internet of Things (IoT) nodes, sensors, etc., in IoT, smart cameras, smart remote controllers, smart watermeters, smart electricity meters, etc., in a smart home, and sensors in a smart city, etc.

In some embodiments, the non-AP STA may support an 802.11be standard. The non-AP STA may also support various wireless local area network (WLAN) standards of the current and future 802.11 family, such as 802.11ax, 802.11ac, 802.11n, 802.11g, 802.11b and 802.11a, etc.

In some embodiments, the AP may be a device supporting the 802.11be standard. The AP may also be a device supporting various WLAN standards of the current and future 802.11 family, such as 802.11ax, 802.11ac, 802.11n, 802.11g, 802.11b, and 802.11a, etc.

In the embodiments of the present application, the STA may be a mobile phone, a pad, a computer, a virtual reality (VR) device, an augmented reality (AR) device, a wireless device in industrial control, a set-top box, a wireless device in self driving, a vehicle-mounted communication device, a wireless device in remote medical, a wireless device in smart grid, a wireless device in transportation safety, a wireless device in smart city, a wireless device in smart home, a wireless communication chip/application-specific integrated circuit (ASIC)/system on chip (SoC), or the like, which support the WLAN/WiFi technology.

Frequency bands that the WLAN technology may support may include, but are not limited to: low frequency bands (e.g., 2.4 GHZ, 5 GHZ, 6 GHZ), high frequency bands (e.g., 60 GHz).

FIG. 1 exemplarily shows one AP STA and two non-AP STAs. Optionally, the communication system 100 may include multiple AP STAs and other numbers of non-AP STAs, which are not limited to the embodiments of the present application.

It should be understood that a device with a communication function in the network/system in the embodiments of the present application may be referred to as a communication device. In an example of the communication system 100 shown in FIG. 1, the communication devices may include an access point 110 and stations 120 with the communication function. The access point 110 and the stations 120 may be specific devices described above and will not be repeated here. The communication devices may also include other devices in the communication system 100, such as a network controller, a gateway and other network entities, which are not limited to the embodiments of the present application.

It should be understood that terms herein “system” and “network” are often used interchangeably herein. The term “and/or” herein is only an association relationship to describe associated objects, indicating that there may be three relationships, for example, “A and/or B” may indicate three cases of: A alone, both A and B, and B alone. In addition, the character “/” herein generally indicates that associated objects before and after this character are in an “or” relationship.

It should be understood that the “indication” mentioned in the embodiments of the present application may be a direct indication or an indirect indication, or may represent that there is an association relationship. For example, A indicating B may mean that A directly indicates B, e.g., that B may be obtained by A; or it may mean that A indirectly indicates B, e.g., that A indicates C, and B may be obtained by C; or it may mean that there is an association relationship between A and B.

In the description of the embodiments of the present application, the term “corresponding” may mean a direct or indirect corresponding relationship between the two, or an association relationship between the two, or a relationship of indicating and being indicated, or configuring and being configured, etc.

In the embodiments of the present application, “predefined” may be implemented by pre-saving corresponding codes, tables or other manners that may be used for indicating related information, in the device (for example, including the access point and the station), and the present application does not limit its specific implementation. For example, the predefined may mean defined in a protocol.

In the embodiments of the present application, the “protocol” may refer to a standard protocol in the field of communication, which may include, for example, a WiFi protocol, and related protocols applied in the future WiFi communication system, and the present application is not limited thereto.

To facilitate the understanding of the technical solutions of the embodiments of the present application, establishment of a multi-AP coordinated set related to the present application is described below.

The establishment of the multi-AP coordinated set includes the following two phases: a multi-AP coordinated capability discovery phase and a multi-AP coordinated set establishment phase.

In the multi-AP coordinated capability discovery phase, an AP, by receiving a beacon frame or other management frames transmitted by a neighbor AP, may discover multi-AP coordinated capabilities of each other.

In the multi-AP coordinated set establishment phase, an AP that initiates a multi-AP coordinated transmission is referred to as a master AP (MAP), and the MAP selects a slave AP (SAP) (one or more SAPs) around it to participate in the multi-AP coordinated transmission. In this process, MAP and SAP will interact with each other with some information for configuring the multi-AP coordinated set, and the specific steps and interacted information are as follows:
1) transmitting, by the MAP, a request frame to SAPs, which mainly includes the following information: assigning identities (IDs) of the SAPs during the multi-AP coordinated transmission, and assigning an ID of the multi-AP coordinated set;
2) replying, by the SAPs, to the MAP with a response frame, which mainly includes the following information: information of STAs associated with the SAP, including the IDs of the STAs and capability information of participating in the multi-AP coordinated transmission; and priorities of the STAs participating in the multi-AP coordinated transmission.

APs participating in the multi-AP coordinated transmission may include the following roles:
MAP (Master AP), SAP (Slave AP), Coordinating AP, Coordinated AP, sharing AP, and shared AP.

Herein, in the multi-AP coordinated set establishment phase, the AP in the MAP role initiates a request for the multi-AP coordinated set establishment to the AP in the SAP role; in a channel sounding phase, the coordinating AP in the coordinating AP role initiates channel sounding, and the AP in the coordinated AP role participates in the channel sounding; in a preparation phase and/or a coordinated transmission phase, the AP in the sharing AP role shares its transmission opportunity (TXOP) resource with the AP in the shared AP role, for the coordinated transmission.

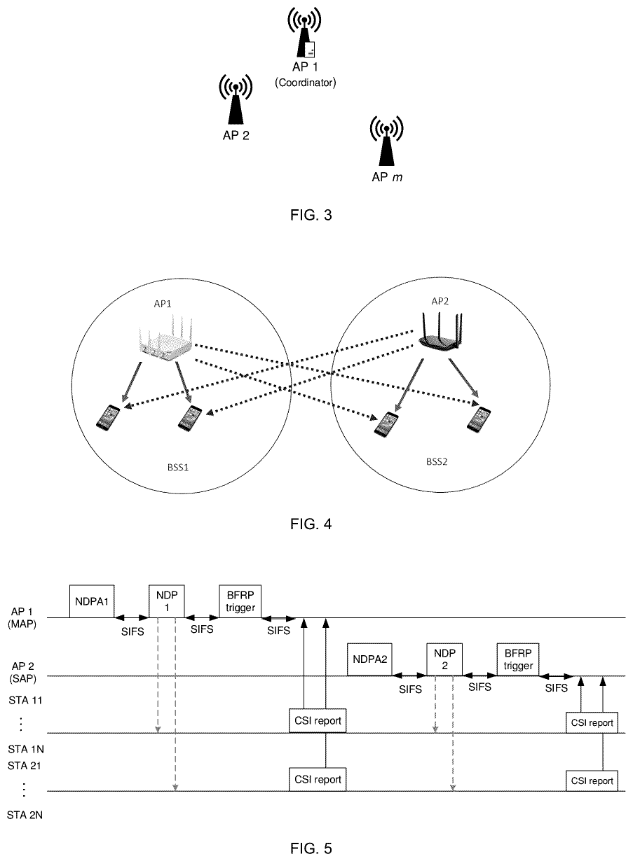

In some embodiments, the present application may be applied to a wired multi-AP coordinated transmission architecture as shown in FIGS. 2A and 2B, or may be applied to a wireless multi-AP coordinated transmission architecture as shown in FIG. 3.

In the wired multi-AP coordinated transmission architecture, as shown FIG. 2A, a coordinator in the network is in a certain AP and controls other APs by a wired connection; as shown in FIG. 2B, there is an independent coordinator in the network that controls other APs by a wired connection. For the wired multi-AP coordinated transmission architecture, the multi-AP coordinated set establishment is set by a network operator directly at a controller.

In the wireless multi-AP coordinated transmission architecture, a coordinator in the network is in a certain AP (called MAP) and controls other APs (called SAPs) wirelessly.

To facilitate the understanding of the technical solutions of the embodiments of the present application, coordinated beamforming (C-BF) related to the present application is described below.

802.11be introduces the multi-AP coordinated transmission technology with the C-BF scheme. The C-BF is that multiple APs transmit or align useful signals to a target STA by the method of beamforming, while transmitting or aligning nulls to an STA of the overlapping basic service set (OBSS), and thus, interference suppression may be achieved and the signal to interference plus noise ratio (SINR) of the communication link may be improved, thereby improving throughput and reducing communication latency. As shown in FIG. 4, solid lines represent the useful signals transmitted by the AP, and dotted lines represent the nulls transmitted by the AP.

To facilitate the understanding of the technical solutions of the embodiments of the present application, information interaction in the channel sounding phase related to the present application is described below.

In some embodiments, multiple APs in the multi-AP coordinated set may perform sequential channel sounding.

For example, multiple APs sequentially transmit null data physical layer protocol data unit (Null Data PPDU, NDP) to associated STAs and non-associated OBSS STAs for the channel sounding. Each AP collects channel sounding results, namely, channel state information (CSI), by transmitting a beamforming report poll (BFRP) trigger frame. Both associated STAs and OBSS STAs may feed back the channel sounding results.

As shown in FIG. 5, the multi-AP coordinated set includes AP1 and AP2, the AP1 is an MAP, the AP2 is an SAP. The AP1 is associated with STA11 to STAIN, and the AP2 is associated with STA21 to STA2N. In the channel sounding phase, the AP1 transmits an NDP Announcement (NDPA) 1 frame to announce that it will transmit an NDP, and transmits an NDP1 after a short interframe space (SIFS). The STAs associated with the AP1 and the AP2 receive the NDP1 and obtain the channel sounding result. The AP1 transmits a BFRP Trigger frame to trigger the AP1, the AP2 and their associated STAs to report the channel sounding results. Then, the AP2 transmits an NDPA2 frame to announce that it will transmit an NDP, and transmits an NDP2 after an SIFS. The STAs associated with the AP1 and the AP2 receive the NDP2 and obtain the channel sounding results. The AP2 transmits a BFRP trigger frame to trigger the STAs associated with the AP1 and the AP2 to report the channel sounding results.

An AP in the multi-AP coordinated set performing the multi-AP coordinated transmission first needs to calculate a steering matrix. Specifically, the AP may calculate the steering matrix for the multi-AP coordinated transmission according to the collected channel sounding results.

However, in practical applications, after completing the channel sounding, an SAP in the multi-AP coordinated set may not participate in the multi-AP coordinated transmission due to some reasons (such as the channel state being busy). Calculating the steering matrix based on all the collected channel sounding results will cause performance loss. Therefore, how to calculate the steering matrix for the multi-AP coordinated transmission is an urgent problem to be solved.

To facilitate the understanding of the technical solutions of the embodiments of the present application, the technical solutions of the present application are described in detail below by specific embodiments. The following related technologies as optional solutions, may be arbitrarily combined with the technical solutions of the embodiments of the present application, and they all belong to the protection scope of the embodiments of the present application. The embodiments of the present application include at least a part of the following content.

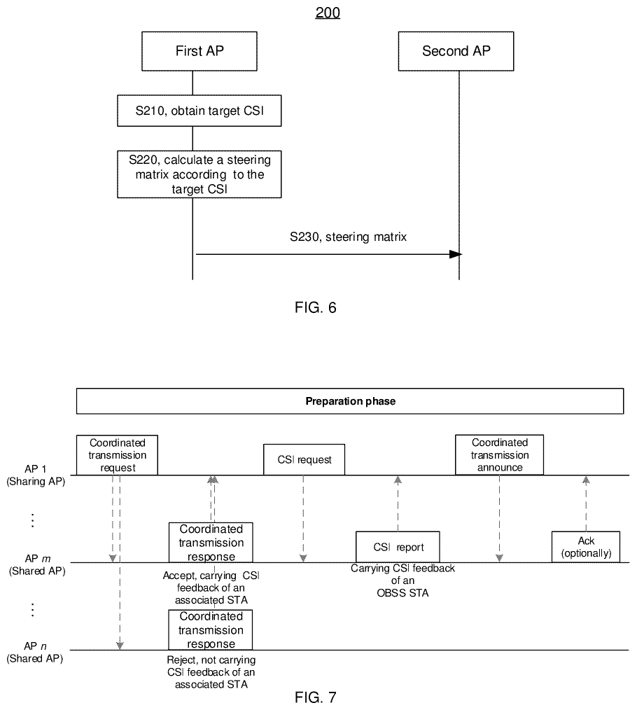

FIG. 6 is a schematic interaction diagram of a method 200 of wireless communication, according to the embodiments of the present application. As shown in FIG. 6, the method 200 includes the following content:

S210: acquiring by a first access point (AP), target channel state information (CSI).

In the embodiments of the present application, participating in the multi-AP coordinated transmission with the C-BF scheme is also referred to as participating in C-BF, and the multi-AP coordinated transmission is also referred to as a coordinated transmission. For example, an AP participating in the multi-AP coordinated transmission with the C-BF scheme may also be expressed as an AP participating in C-BF, and an STA participating in the multi-AP coordinated transmission with the C-BF scheme may be expressed as an STA participating in C-BF.

For the convenience of distinction and explanation, in the embodiments of the present application, an AP participating in C-BF in the multi-AP coordinated set is denoted as a first-type AP, an AP not participating in C-BF in the multi-AP coordinated set is denoted as a second-type AP, and an STA participating in C-BF in STAs associated with an AP in the multi-AP coordinated set is denoted as a first-type STA, and an STA not participating in C-BF in the STAs associated with the AP in the multi-AP coordinated set is denoted as a second-type STA.

In some embodiments, the target CSI includes CSI between a first-type AP and a first-type STA.

For example, the target CSI includes first-type CSI and/or second-type CSI, where the first-type CSI includes CSI between the first-type AP and the first-type STA associated with the first-type AP, and the second-type CSI includes CSI between the first-type AP and an STA not associated with the first-type AP, for example, CSI between the first-type AP and a first-type STA in the OBSS of the first-type AP.

In some embodiments, the target CSI is used to calculate a steering matrix corresponding to each first-type AP in the multi-AP coordinated set, and the steering matrix corresponding to the first-type AP is used for the first-type AP to perform the multi-AP coordinated transmission with the C-BF scheme.

In the embodiments of the present application, the target CSI may be understood as usable CSI (or valid CSI) used to calculate the steering matrix, and CSI related to the second-type AP or the second-type STA may be considered as unusable CSI (or invalid CSI). Therefore, the coordinated transmission according to the steering matrix calculated based on the target CSI is beneficial to ensure that the first-type AP transmits useful signals to a target STA and nulls to the OBSS STAs, thereby achieving effective interference suppression and improving the SINR of the communication link.

In the embodiments of the present application, the steering matrix is also referred to as a C-BF steering matrix or a transmission matrix (Tx Matrix).

In some embodiments, the first AP is a sharing AP (Sharing AP) in the multi-AP coordinated set.

In some embodiments, the first AP is both a sharing AP and an MAP (Controller).

The following description takes the role of the first AP as the sharing AP as an example, but the present application is not limited thereto.

In some embodiments of the present application, the method 200 further includes: receiving by the first AP, first information transmitted by at least one second AP, where the first information is used to indicate whether the second AP participates in C-BF and/or whether an STA associated with the second AP participates in C-BF.

In some embodiments, the at least one second AP is a shared AP, for example, the at least one second AP includes all shared APs in the multi-AP coordinated set.

In some embodiments, the sharing AP may obtain target information, according to the first information reported by all shared APs, and according to participation of the sharing AP and its associated STAs in the C-BF, where the target information is used to indicate participation of APs of the multi-AP coordinated set in the multi-AP coordinated transmission with the C-BF scheme and/or the participation of stations (STAs) associated with the APs of the multi-AP coordinated set in the multi-AP coordinated transmission with the C-BF scheme.

In some embodiments of the present application, the method 200 further includes:
receiving by the first AP, first CSI transmitted by at least one third AP.

In some embodiments, the at least one third AP is a shared AP.

In some embodiments, the at least one third AP includes shared APs participating in C-BF in the multi-AP coordinated set.

For example, the at least one third AP includes APs participating in C-BF among the at least one second AP.

In some other embodiments, the at least one third AP includes all shared APs in the multi-AP coordinated set.

That is, only the first-type AP may report the CSI to the sharing AP, or all shared APs (including the first-type AP and the second-type AP) may report the CSI to the sharing AP.

In some embodiments, information components of the first CSI may be one of the following cases where:
Case 1: the first CSI includes the first-type CSI obtained by the shared APs through the channel sounding and/or the CSI between the shared APs and the OBSS STAs (including the OBSS STAs participating in C-BF and the OBSS STAs not participating in C-BF);
Case 2: the first CSI includes the first-type CSI and/or the second-type CSI obtained by the shared APs through the channel sounding;
Case 3: the first CSI includes all CSI obtained by the shared APs through the channel sounding.

In some embodiments, there is a wired connection between the sharing AP and the shared APs, and the shared APs may transmit the first CSI to the sharing AP via the wired connection. For example, after the channel sounding is completed, all shared APs may transmit all CSI obtained through the channel sounding to the sharing AP via the wired connection.

In some other embodiments, there is a wireless connection between the sharing AP and the shared APs, and the shared APs may transmit the first CSI to the sharing AP via a signaling.

In some embodiments of the present application, the CSI used to determine the target CSI is denoted as candidate CSI. When the sharing AP participates in the C-BF, the candidate CSI includes first CSI obtained from each third AP of the at least one third AP and CSI obtained by the sharing AP through the channel sounding. Alternatively, when the sharing AP does not participate in the C-BF, the candidate CSI includes the first CSI obtained from each third AP of the at least one third AP.

In some embodiments of the present application, the target CSI is determined by the sharing AP among the candidate CSI according to the target information.

For example, when the CSI obtained by the sharing AP from the at least one shared AP includes invalid CSI, the sharing AP may determine the target CSI from among the candidate CSI according to the target information.

In some embodiments, the sharing AP removes the following invalid CSI from the candidate CSI according to the target information, to obtain the target CSI:
CSI between the first-type AP and a second-type STA associated with the first-type AP;
CSI between the first-type AP and an STA associated with the second-type AP.

It should be understood that in the embodiments of the present application, the CSI obtained by APs (including the sharing AP and the shared APs) may be obtained by the APs during the channel sounding phase, and the specific channel sounding procedure is not limited to the embodiments of the present application. For example, the channel sounding may be performed by the method as shown in FIG. 5, but the present application is not limited thereto.

In some embodiments, after performing the channel sounding, the AP in the multi-AP coordinated set stores the CSI obtained through the channel sounding. For example, the first CSI obtained by the sharing AP from the shared APs may be acquired during a most recent channel sounding phase.

Optionally, the CSI stored by the AP may include CSI between the AP and associated STAs and CSI between the AP and non-associated STAs (e.g., OBSS STAs), where the associated STAs refer to STAs associated with the AP, and the OBSS STAs refer to STAs in an OBSS of the AP.

In some embodiments of the present application, when a shared AP transmits both the first information and the first CSI to the sharing AP, the first information and the first CSI may be transmitted by the shared AP via a same frame, or may be transmitted via different frames.

In some embodiments of the present application, when the first CSI includes the first-type CSI and the second-type CSI obtained by the shared APs through the channel sounding, the first-type CSI and the second-type CSI may be transmitted via a same frame, or may be transmitted via different frames.

That is, the sharing AP may at one time collect the first-type CSI and the second-type CSI obtained by the shared APs, or may in steps collect the first-type CSI and the second-type CSI obtained by the shared APs.

In some embodiments, if a shared AP does not participate in the C-BF, the shared AP may only transmit the first information to the sharing AP without transmitting the first CSI.

In some embodiments, if a shared AP participates in the C-BF, the shared AP may transmit the first information and the first CSI to the sharing AP.

The following describes a specific implementation of a shared AP transmitting the first information and/or the first CSI to the sharing AP, in conjunction with specific embodiments.

In some embodiments of the present disclosure, the method 200 further includes:
transmitting by the first AP, a first request frame to at least one second AP, where the first request frame is used to request the at least one second AP to participate in the multi-AP coordinated transmission with the C-BF scheme.

In some embodiments, the at least one second AP may be a shared AP.

In some embodiments, the at least one second AP includes all shared APs in the multi-AP coordinated set.

In some embodiments, the first request frame is also referred to as a coordinated transmission request (Coordinated TX Request) frame, or other similar names, which is not limited to the present application.

In some embodiments, the first request frame is transmitted by broadcasting, multicasting, or unicasting.

Correspondingly, the at least one shared AP may receive the first request frame synchronously or asynchronously.

In some embodiments, in a case where the first request frame indicates to request to participate in the multi-AP coordinated transmission with the C-BF scheme, it may be considered that the sharing AP requests a shared AP to report the participation of the shared AP and its associated STAs in the C-BF.

In some embodiments, in a case where the first request frame indicates to request to participate in the multi-AP coordinated transmission with the C-BF scheme, the sharing AP requests a shared AP to feed back the CSI, by default.

In some embodiments, the first request frame may further be used to indicate whether the sharing AP requests a shared AP to feed back the CSI.

Optionally, in a case where the sharing AP requests to feed back the CSI, the shared AP may report all CSI obtained by the shared AP, or report the first-type CSI obtained by the shared AP and CSI between the shared AP and all OBSS STAs (including the OBSS STAs participating in C-BF and the OBSS STAs not participating in C-BF). In a case where the sharing AP does not request to feed back the CSI, the shared AP may not feed back the CSI.

In some embodiments, in a case where the first request frame does not indicate the type of CSI requested to be fed back, the first-type CSI obtained by a shared AP and the CSI between the shared AP and all OBSS STAs (including the OBSS STAs participating in C-BF and the OBSS STAs not participating in C-BF) are fed back by default.

In some embodiments, the first request frame may also be used to indicate the type of CSI that the sharing AP requests a shared AP to feed back.

For example, the first request frame is used to indicate whether to request the shared AP to feed back the obtained first-type CSI and/or the CSI between the shared AP and all OBSS STAs (including the OBSS STAs participating in C-BF and the OBSS STAs not participating in C-BF).

For another example, the first request frame is used to indicate whether to request the shared AP to feed back the obtained first-type CSI and/or second-type CSI.

In summary, in some embodiments, information components that the first request frame requests a shared AP to feed back may be implemented in the following methods:
feedback method 1: participation information (corresponding to the first information mentioned above) of the shared AP and its associated STAs in C-BF;
feedback method 2: participation information of the shared AP and its associated STAs in C-BF, and the CSI obtained by the shared AP (i.e., all CSI);
feedback method 3: participation information of the shared AP and its associated STAs in C-BF, and the first-type CSI obtained by the shared AP;
feedback method 4: participation information of the shared AP and its associated STAs in C-BF, the first-type CSI obtained by the shared AP, and the CSI between the shared AP and non-associated OBSS STAs (including OBSS STAs participating in C-BF and OBSS STAs not participating in C-BF).

In some embodiments, the first request frame includes at least one of:
first indication information, to indicate a coordinated transmission scheme requested to be used by the first AP;
second indication information, to indicate whether to feed back the first-type CSI obtained by the second AP; or
third indication information, to indicate whether to feed back CSI between the second AP and non-associated OBSS STAs, obtained by the second AP.

In some embodiments, the first indication information is used to indicate to request to participate in the multi-AP coordinated transmission with the C-BF scheme.

In some embodiments, in a case where the first indication information indicates to request to participate in the multi-AP coordinated transmission with the C-BF scheme, it may be considered that the sharing AP requests a shared AP to report the participation of the shared AP and its associated STAs in C-BF.

In some embodiments, the sharing AP may respectively indicate the type of CSI fed back by the shared APs by independent indication information.

For example, the second indication information corresponds to 1 bit, and the third indication information corresponds to another 1 bit. A binary value of the 1 bit corresponding to the second indication information is used to indicate whether to feed back the first-type CSI obtained by the second AP, and a binary value of the 1 bit corresponding to the third indication information is used to indicate whether to feed back the CSI between the second AP and the non-associated OBSS STAs obtained by the second AP. As an example, the binary value of 1 indicates feedback, and the binary value of 0 indicates no feedback.

In some other embodiments, the sharing AP may indicate whether a shared AP feeds back the first-type CSI obtained by the second AP and the CSI between the second AP and the non-associated OBSS STAs obtained by the second AP, by one piece of indication information. For example, different binary values of this indication information are used to indicate types of the CSI fed back.

As an example, the indication information corresponds to 2 bits, the binary value of 00 indicates not to feed back CSI, the binary value of 01 indicates to feed back the first-type CSI obtained by the second AP, the binary value of 10 indicates to feed back the CSI between the second AP and the non-associated OBSS STAs obtained by the second AP, and the binary value of 11 indicates to feed back the first-type CSI obtained by the second AP and the CSI between the second AP and the non-associated OBSS STAs obtained by the second AP.

In some embodiments of the present application, the method 200 further includes:
receiving by the first AP, a first response frame transmitted by the at least one second AP, where the first response frame is used to indicate whether the second AP accepts to participate in the multi-AP coordinated transmission with the C-BF scheme.

In some embodiments, the first response frame is transmitted synchronously or asynchronously by the at least one second AP.

For example, in a case where the first request frame is transmitted by broadcasting or multicasting, the first AP receives the first response frame synchronously transmitted by the at least one second AP.

For another example, in a case where the first request frame is transmitted by unicasting, the first AP receives the first response frame asynchronously transmitted by the at least one second AP.

In some embodiments, the first response frame is also referred to as a coordinated transmission response (Coordinated TX Response) frame, or other similar names, which is not limited to the present application.

In some embodiments of the present application, the first response frame includes the first information but does not include the first CSI.

That is, the first response frame only indicates participation of a shared AP and its associated STAs in C-BF, but does not indicate the CSI information.

In some embodiments, if a shared AP does not participate in C-BF, the first information may not include participation information of the STAs associated with the shared AP, which means that all STAs associated with the shared AP do not participate in C-BF.

In some embodiments, if a shared AP participates in C-BF, the first information may include participation information of the STAs associated with the shared AP.

In some embodiments, if all STAs associated with a shared AP participate in C-BF, the first information may also not indicate participation information of the STAs associated with the shared AP, which means that all STAs associated with the shared AP participate in C-BF.

In some embodiments, the first information may directly indicate a first-type STA set and/or a second-type STA set corresponding to a shared AP.

For example, the first information includes a list of STAs participating in C-BF (i.e., the first-type STA set) and/or a list of STAs not participating in C-BF (i.e., the second-type STA set), the list of STAs participating in C-BF is used to indicate the first-type STAs associated with a shared AP, and the list of STAs not participating in C-BF is used to indicate the second-type STAs associated with the shared AP.

For example, the first information may explicitly indicate IDs of STAs participating in C-BF or IDs of STAs not participating in C-BF associated with a shared AP.

In some other embodiments, the first information may indicate the first-type STA set and/or the second-type STA set corresponding to a shared AP by a bitmap.

For example, the first information includes a list of associated STAs and a C-BF bitmap, the list of associated STAs is used to indicate all STAs associated with the shared AP, the C-BF bitmap includes at least K bits, each bit corresponds to an STA in the list of associated STAs, for example, the first bit corresponds to the first STA in the list of associated STAs, the second bit corresponds to the second STA in the list of associated STAs, and so on. A binary value of each bit is used to indicate whether a corresponding STA participates in C-BF, where K is the number of STAs included in the list of associated STAs, and K is a positive integer.

Optionally, if the sharing AP may be aware of information of the STAs associated with the shared AP, the first information may also not include the list of associated STAs, but only needs to include the C-BF bitmap, as long as the sharing AP and the shared AP have a same understanding of correspondence between each bit in the C-BF bitmap and the STA.

In some embodiments of the present application, a shared AP may report the CSI according to the indication of the sharing AP.

For example, if the first request frame indicates the shared AP to report the CSI between the shared AP and the associated first-type STAs and the CSI between the shared AP and the OBSS STAs (corresponding to the aforementioned feedback method 4), the first response frame may include the CSI between the sharing AP and the associated first-type STAs and the CSI between the shared AP and the OBSS STAs.

For another example, if the first request frame indicates the shared AP to report the CSI between the shared AP and the associated first-type STAs (corresponding to the aforementioned feedback method 3), the first response frame may include the CSI between the sharing AP and the associated first-type STAs.

For another example, if the first request frame indicates the shared AP to report the participation information of the shared AP and its associated STAs in C-BF (corresponding to the aforementioned feedback method 1), the first response frame may not include the CSI information.

Optionally, in a case where the first request frame does not indicate the type of CSI to be reported, a shared AP may not report the CSI, or may report all the obtained CSI (i.e., report by adopting the aforementioned feedback method 2), or may only report the obtained first-type CSI (i.e., report by adopting the aforementioned feedback method 3), or may report the obtained first-type CSI and the CSI between the shared AP and the OBSS STAs (i.e., report by adopting the aforementioned feedback method 4).

In some other embodiments of the present application, the first response frame may include the first information and a part or all of the first CSI.

That is, the first response frame may be used to indicate the participation of a shared AP and its associated STAs in C-BF, and may also be used to indicate a part or all of the first CSI.

Optionally, the first CSI may be transmitted by one frame, or may be transmitted by a plurality of frames.

In some embodiments, the first response frame may include the first information, and the first-type CSI obtained by a shared AP.

In some other embodiments, the first response frame may include the first information, and the first-type CSI obtained by a shared AP, and the CSI between the second AP and the non-associated OBSS STAs.

In yet some other embodiments, the first response frame may include the first information, and all CSI obtained by a shared AP.

In some embodiments, the first response frame includes at least one of:
fourth indication information, to indicate whether the second AP accepts a coordinated transmission scheme requested to be used;
a list of associated STAs participating in C-BF, including STAs associated with the second AP and participating in the multi-AP coordinated transmission with the C-BF scheme;
a list of associated STAs not participating in C-BF, including STAs associated with the second AP and not participating in the multi-AP coordinated transmission with the C-BF scheme; or
at least one CSI, including the first-type CSI obtained by the second AP and/or CSI between the second AP and non-associated OBSS STAs obtained by the second AP.

In some embodiments, it is mandatory that the first response frame includes the list of associated STAs participating in C-BF, and it is optional that the first response frame includes the list of associated STAs not participating in C-BF.

In some embodiments, in a case where the fourth indication information is used to indicate that the second AP accepts the coordinated transmission with the C-BF scheme, the first response frame includes the list of associated STAs participating in C-BF, or includes the list of associated STAs participating in C-BF and at least one CSI. Optionally, it may also include the list of associated STAs not participating in C-BF.

In some embodiments, when the fourth indication information indicates the coordinated transmission scheme requested to be used is rejected, the first response frame may not include a list of associated STAs participating in C-BF, a list of associated STAs not participating in C-BF, and at least one CSI, which means that all STAs associated with a shared AP do not participate in C-BF.

In some embodiments, when the fourth indication information indicates that the coordinated transmission scheme requested to be used is accepted, and the first request frame indicates to not feed back the CSI, the first response frame may include the list of associated STAs participating in C-BF and/or the list of associated STAs not participating in C-BF, that is, it does not include the CSI information.

In some embodiments, when the fourth indication information indicates that the coordinated transmission scheme requested to be used is accepted, and the first request frame indicates to feed back the first-type CSI obtained by the second AP, the first response frame may include the list of associated STAs participating in C-BF and/or the list of associated STAs not participating in C-BF, and the first-type CSI obtained by the second AP.

In some embodiments, when the fourth indication information indicates the coordinated transmission scheme requested to be used is accepted, and the first request frame indicates to feed back the first-type CSI obtained by the second AP and the CSI between the second AP and the non-associated OBSS STAs obtained by the second AP, the first response frame may include the list of associated STAs participating in C-BF and/or the list of associated STAs not participating in C-BF, and the first-type CSI and the CSI between the second AP and the non-associated OBSS STAs, obtained by the second AP.

It should be noted that the above is described only by taking an example in which the first response frame indicates the participation of the STA in C-BF by indicating the list of STAs participating in C-BF and/or the list of STAs not participating in C-BF. In other embodiments, the participation of the STAs in C-BF may also be indicated by a bitmap, which is not limited to the present application.

For example, the first response frame includes at least one of:
fourth indication information, to indicate whether the second AP accepts a coordinated transmission scheme requested to be used;
a list of associated STAs, including all STAs associated with the second AP;
a C-BF bitmap, to indicate STAs participating in C-BF and/or not participating in C-BF associated with the second AP; or
at least one CSI, including the first-type CSI obtained by the second AP and/or the CSI between the second AP and the non-associated OBSS STAs obtained by the second AP.

In some embodiments of the present application, the method 200 further includes:
transmitting by the first AP, a second request frame to at least one third AP in the multi-AP coordinated set, where the second request frame is used to request the third AP to feed back CSI information.

In some embodiments, in a case where the first request frame requests a shared AP to feed back the first information only (corresponding to the aforementioned feedback method 1), the sharing AP may request the shared AP to feed back the first-type CSI and the CSI between the shared AP and the non-associated OBSS STAs, by the second request frame.

For another example, in a case where the first request frame requests a shared AP to feed back the first-type CSI only (such as the aforementioned feedback method 3), the sharing AP may request the shared AP to feed back the CSI between the shared AP and the non-associated OBSS STAs, by the second request frame. That is, the sharing AP may collect the CSI information obtained by the shared AP, in steps.

In some embodiments, the second request frame is also referred to as a CSI request frame, or other similar names may be also adopted, which is not limited to the present application.

In some embodiments, the at least one third AP may be an AP participating in C-BF among the at least one second AP.

In some embodiments, the second request frame is transmitted by broadcasting, multicasting or unicasting.

Correspondingly, the at least one third AP may receive the second request frame synchronously or asynchronously.

In some embodiments, the second request frame may carry the aforementioned target information.

In some embodiments, the target information is obtained by aggregating by the sharing AP according to the first information carried in the first response frame transmitted by a shared AP.

That is, the sharing AP may announce to the APs participating in C-BF, the participation of APs of the multi-AP coordinated set in C-BF and/or the participation of STAs associated with the APs in C-BF, by the second request frame.

Furthermore, the third AP participating in C-BF, when performing the CSI feedback, may remove invalid CSI from the pre-stored CSI according to the target information, and only feed back valid CSI.

In some embodiments, the target information may be used to indicate at least one of:
at least one AP, including the first-type AP in the multi-AP coordinated set and/or the second-type AP in the multi-AP coordinated set; or
at least one STA set, each STA set corresponding to a first-type AP, and the STA set including the first-type STAs in STAs associated with the corresponding first-type AP, and/or the second-type STAs in the STAs associated with the corresponding first-type AP.

That is, the at least one AP includes at least one first-type AP and/or at least one second-type AP.

That is, each STA set in the at least one STA set corresponds to one first-type AP, and each STA set includes the first-type STAs associated with the first-type AP and/or the second-type STAs associated with the first-type AP.

In some embodiments, the AP in the multi-AP coordinated set may be aware of APs included in the multi-AP coordinated set, and STAs associated with other APs in the multi-AP coordinated set. For example, in the multi-AP coordinated set establishment phase, each AP may be aware of STAs associated with other APs by information exchange.

Specific implementations of the target information are described below in conjunction with specific embodiments.

Case 1: the target information only indicates at least one first-type AP.

Optionally, in this case, it may be considered that all STAs associated with the at least one first-type AP participate in C-BF, all other APs in the multi-AP coordinated set except the at least one first-type AP are the second-type APs, and all STAs associated with the second-type APs are second-type STAs.

Optionally, in a case where APs in the multi-AP coordinated set can be aware of STAs associated with other APs, and all STAs associated with APs participating in C-BF participate in C-BF, the target information may only indicate the APs participating in C-BF without indicating participation of their associated STAs.

Case 2: the target information only indicates at least one second-type AP.

Optionally, in this case, it may be considered that all STAs associated with the at least one second-type AP do not participate in C-BF, all other APs in the multi-AP coordinated set except the at least one second-type AP are first-type APs, and all STAs associated with the first-type AP are first-type STAs.

Optionally, in a case where the APs in the multi-AP coordinated set can be aware of STAs associated with other APs, and all STAs associated with the APs participating in C-BF participate in C-BF, the target information may only indicate the APs not participating in C-BF.

Case 3: the target information only indicates at least one first-type AP and at least one first-type STA set.

Optionally, in the case 3, the number of first-type APs and the number of first-type STA sets may be the same, each first-type AP corresponds to a first-type STA set, and each first-type STA set is used to indicate STAs participating in C-BF and associated with the corresponding first-type AP, and then, other STAs associated with the first-type AP are all second-type STAs.

Optionally, in the case 3, the number of first-type APs and the number of first-type STA sets may be different, for example, the number of first-type APs is greater than the number of first-type STA sets.

Optionally, in this case, for the first-type AP that does not correspond to the first-type STA set, it may be considered that all STAs associated with the first-type AP participate in C-BF, and for the first-type AP that corresponds to the first-type STA set, STAs participating in C-BF among STAs associated with the first-type AP may be determined according to the first-type STA set corresponding to the first-type AP, and then, other STAs associated with the first-type AP are all second-type STAs.

Case 4: the target information only indicates at least one first-type AP and at least one second-type STA set.

Optionally, in the case 4, the number of first-type APs and the number of second-type STA sets may be the same, each first-type AP corresponds to a second-type STA set, each second-type STA set is used to indicate STAs that are associated with the corresponding first-type AP and do not participate in C-BF, and then, other STAs associated with the first-type AP are all first-type STAs.

Optionally, in the case 4, the number of first-type APs and the number of second-type STA sets may be different, for example, the number of first-type APs is greater than the number of second-type STA sets.

Optionally, in this case, for a first-type AP that does not correspond to the second-type STA sets, it may be considered that all STAs associated with the first-type AP participate in C-BF, and for a first-type AP corresponding to a second-type STA set, STAs that do not participate in C-BF among STAs associated with the first-type AP may be determined according to the second-type STA set corresponding to the first-type AP, and then, other STAs associated with the first-type AP are all first-type STAs.

In some embodiments, the target information may directly indicate at least one first-type AP and/or at least one second-type AP.

For example, the first information includes the IDs of at least one first-type AP, or the IDs of at least one second-type AP.

That is, the first AP may explicitly indicate the IDs of the APs participating in C-BF, or the IDs of the APs not participating in C-BF.

In some other embodiments, the target information may indicate at least one first-type AP and/or at least one second-type AP by a bitmap.

For example, the target information includes a first C-BF bitmap, the first C-BF bitmap includes at least N bits, each bit corresponds to an AP in the multi-AP coordinated set. For example, the first bit corresponds to the first AP in the multi-AP coordinated set, the second bit corresponds to the second AP in the multi-AP coordinated set, and so on. The binary value of each bit is used to indicate whether the corresponding AP participates with C-BF, where N is the number of APs included in the multi-AP coordinated set, and N is a positive integer greater than 1.

Optionally, if an AP in the multi-AP coordinated set may be aware of which APs the multi-AP cooperation set includes, the target information may not include IDs of APs in the multi-AP coordinated set, and only needs to include the first C-BF bitmap, as long as the APs in the multi-AP coordinated set have a consistent understanding of the correspondence between each bit in the first C-BF bitmap and the AP.

In some embodiments, the target information may directly indicate at least one first-type STA set and/or at least one second-type STA set.

For example, the target information includes at least one STA list participating in C-BF (i.e., the first-type STA set) and/or at least one STA list not participating in C-BF (i.e., the second-type STA set), where each STA list participating in C-BF corresponds to a first-type AP, and each STA list not participating in C-BF corresponds to a first-type AP, the STA list participating in C-BF is used to indicate first-type STAs associated with the corresponding first-type AP, and the STA list not participating in C-BF is used to indicate second-type STAs associated with the corresponding first-type AP.

For example, the first AP may indicate the IDs of the STAs participating in C-BF or the IDs of the STAs not participating in C-BF, associated with the first-type AP.

In some other embodiments, the target information may indicate at least one first-type STA set and/or at least one second-type STA set by a bitmap.

For example, the target information includes at least one associated STA list and at least one second C-BF bitmap, where each STA list corresponds to a first-type AP, and each second C-BF bitmap corresponds to a first-type AP. The associated STA list is used to indicate all STAs associated with the corresponding first-type AP. The second C-BF bitmap includes K bits, and each bit corresponds to an STA in the associated STA list of the first-type AP. For example, the first bit corresponds to the first STA in the associated STA list of the first-type AP, the second bit corresponds to the second STA in the associated STA list of the first-type AP, and so on. The binary value of each bit is used to indicate whether the corresponding STA participates with C-BF, where K is the number of STAs associated with the first-type AP, and K is a positive integer.

Optionally, if an AP in the multi-AP coordinated set may be aware of STA information associated with other APs in the multi-AP coordinated set, the target information may not include the at least one associated STA list, only needs to include at least one second C-BF bitmap, as long as the APs in the multi-AP coordinated set have a consistent understanding of the correspondence between each bit in the second C-BF bitmap and the STA.

In some embodiments of the present application, the second request frame includes at least one of:
fifth indication information, where the fifth indication information is used to indicate the third AP to feed back first-type CSI and/or second-type CSI;
AP number information, to indicate a number of APs included in the second request frame;
an AP list, including APs participating in the multi-AP coordinated transmission with the C-BF scheme and/or APs not participating in the multi-AP coordinated transmission with the C-BF scheme in the multi-AP coordinated set;
at least one list of associated STAs participating in C-BF, where each list of associated STAs participating in C-BF corresponds to an AP participating in the multi-AP coordinated transmission with the C-BF scheme, and the list of associated STAs participating in C-BF is used to indicate STAs participating in the multi-AP coordinated transmission with the C-BF scheme and associated with a corresponding AP; or
at least one list of associated STAs not participating in C-BF, where each list of associated STAs not participating in C-BF corresponds to an AP participating in the multi-AP coordinated transmission with the C-BF scheme, and the list of associated STAs not participating in C-BF is used to indicate STAs associated with a corresponding AP and not participating in the multi-AP coordinated transmission with the C-BF scheme.

In some other embodiments of the present application, the second request frame includes at least one of:
fifth indication information, where the fifth indication information is used to indicate the third AP to feed back first-type CSI and/or second-type CSI;
AP number information, to indicate a number of APs included in the second request frame;
an AP list, including APs participating in the multi-AP coordinated transmission with the C-BF scheme and/or APs not participating in the multi-AP coordinated transmission with the C-BF scheme in the multi-AP coordinated set;
at least one list of associated STAs, where each list of associated STAs corresponds to an AP participating in the multi-AP coordinated transmission with the C-BF scheme, and the list of associated STAs is used to indicate STAs associated with the corresponding AP; or
at least one second C-BF bitmap, where each second C-BF bitmap corresponds to an AP participating in the multi-AP coordinated transmission with the C-BF scheme, and the second C-BF bitmap is used to indicate STAs participating in the multi-AP coordinated transmission with the C-BF scheme and/or STAs not participating in the multi-AP coordinated transmission with the C-BF scheme in the list of associated STAs of the corresponding AP.

Optionally, the fifth indication information may be 1 bit, and different binary values of the 1 bit are used to indicate the type of CSI fed back. For example, the binary value of 0 indicates to feed back the second-type CSI, and the binary value of 1 indicates to feed back the first-type CSI and the second-type CSI.

In some embodiments, the AP list includes a list of APs participating in C-BF, or includes a list of APs participating in C-BF and a list of APs not participating in C-BF.

In some embodiments, it is mandatory that the second request frame includes a list of APs participating in C-BF, and it is optional that the second request frame includes a list of APs not participating in C-BF.

In some embodiments of the present application, the method 200 further includes:
receiving by the first AP, a second response frame transmitted by the at least one third AP, where the second response frame includes CSI information fed back by the third AP.

In some embodiments, the second response frame is also referred to as a CSI report frame, a CSI response frame, or other similar names may also be adopted, which is not limited to the present application.

In some embodiments, the second response frame is transmitted synchronously or asynchronously by the at least one third AP.

For example, in a case where the second request frame is transmitted by broadcasting or multicasting, the first AP receives the second response frame transmitted by the at least one third AP synchronously.

For another example, in a case where the second request frame is transmitted by unicasting, the first AP receives the second response frame transmitted by the at least one third AP asynchronously.

In some embodiments, the second response frame includes the first-type CSI obtained by the third AP and/or the second-type CSI obtained by the third AP. That is, the third AP only feeds back the valid CSI.

For example, the third AP may remove invalid CSI among the pre-stored CSI according to the target information, and further include only the valid CSI in the second response frame.

In some embodiments, the first response frame does not include CSI information, and the second response frame includes the first-type CSI obtained by the third AP and the second-type CSI obtained by the third AP.

In some other embodiments, the first response frame includes the first-type CSI obtained by the third AP, and the second response frame includes the second-type CSI obtained by the third AP.

In summary, methods in which the sharing AP acquires the first CSI from a shared AP are as follows:
acquisition method 1: acquiring from the first response frame, where the first response frame may include the first-type CSI obtained by the shared AP and the CSI between the shared AP and the non-associated OBSS STAs;
acquisition method 2: acquiring from the first response frame and the second response frame, where the first response frame may include the first-type CSI obtained by the shared AP, and the second response frame includes the CSI between the shared AP and the non-associated OBSS STAs participating in C-BF obtained by the shared AP, that is, the first-type CSI is acquired from the first response frame, and the second-type CSI is acquired from the second response frame.
acquisition method 3: acquiring from the second response frame, where the second response frame may include the first-type CSI and the second-type CSI obtained by the shared AP. In this case, the first response frame does not include the CSI information.

The sharing AP may obtain candidate CSI according to the first CSI acquired from the shared AP, and further, may remove invalid CSI from the candidate CSI according to the target information, to obtain the target CSI.

For example, the sharing AP removes the following invalid CSI from the candidate CSI according to the target information, to obtain the target CSI:
CSI between the first-type AP and the second-type STAs associated with the first-type AP;
CSI between the first-type AP and STAs associated with a second-type AP.

In some embodiments of the present application, as shown in FIG. 6, the method 200 further includes:
S220: determining by the first AP, the steering matrix corresponding to each first-type AP according to the target CSI.

Specifically, the sharing AP may obtain the first CSI from the shared APs, and further, remove the invalid CSI from the obtained first CSI according to the target information to obtain the target CSI. Then, the sharing AP may determine the steering matrixes corresponding to the APs participating in C-BF according to the target CSI. That is, the sharing AP only considers the CSI between the first-type AP and the first-type STA when calculating the steering matrix, so that the coordinated transmission is performed based on the calculated steering matrix, which may enable the AP to transmit the useful signals to the target STA, and nulls to the OBSS STAs, thereby reducing interference and improving the performance of the transmission.

In some embodiments of the present application, the method 200 further includes:
S230, transmitting by the first AP, the steering matrix corresponding to each first-type AP, to the each first-type AP in the multi-AP coordinated set.

In some embodiments, there is a wired connection between the sharing AP and the shared APs, and for each of the shared APs participating in C-BF, the sharing AP may transmit the steering matrix corresponding to the shared AP to the shared AP via the wired connection.

In some other embodiments, there is a wireless connection between the sharing AP and the shared APs, and the sharing AP may transmit the steering matrixes corresponding to the shared APs participating in C-BF, to the shared APs via a signaling.

In some embodiments, the steering matrix corresponding to the first-type AP may be transmitted by a first announce frame.

In some embodiments, the first announce frame is also referred to as a coordinated transmission announce (Coordinated TX Announce) frame, or other similar names are adopted, which are not limited to the present application.

In some embodiments, the first announce frame is transmitted by broadcasting or multicasting, and the first announce frame includes the steering matrix corresponding to each first-type AP.

In some embodiments, the first announce frame is transmitted by unicasting, and the first announce frame may include the steering matrix corresponding to a single first-type AP.

In conjunction with FIG. 7 to FIG. 10, taking the sharing AP as an AP1 and the shared APs including an AP m and an AP n as an example, interaction schemes of the coordinated transmission request, the coordinated transmission response, the CSI request frame, the CSI report frame, and the coordinated transmission announce frame are described.

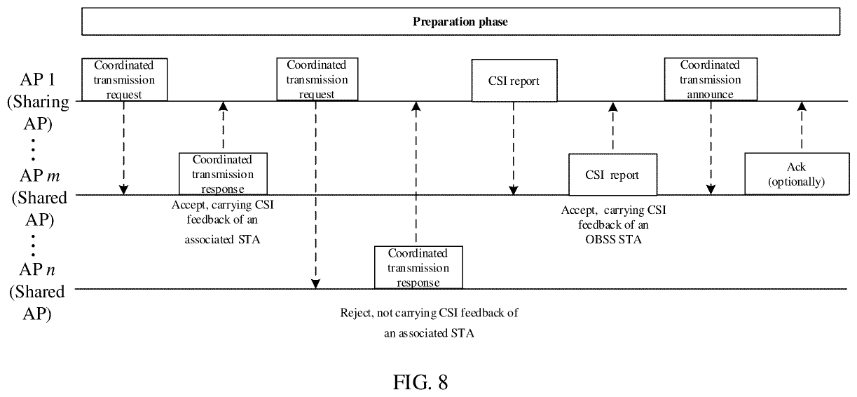

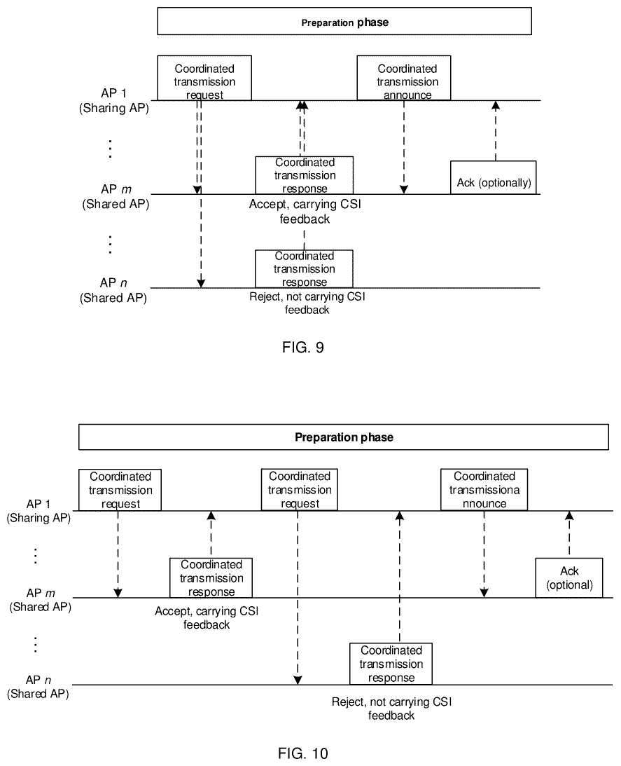

FIG. 7 and FIG. 8 are schematic interaction diagrams of the sharing AP in steps collecting CSI information obtained by the shared APs, while FIG. 9 and FIG. 10 are schematic interaction diagrams of the sharing AP at one time collecting CSI information obtained by the shared APs. Herein, FIG. 7 and FIG. 8 are respectively schematic diagrams of the shared APs responding synchronously and asynchronously, when the sharing AP in steps collects CSI information obtained by the shared APs, and FIG. 9 and FIG. 10 respectively are schematic diagrams of the sharing APs responding synchronously and asynchronously, when the shared AP at one time collects CSI information obtained by the shared APs.

As shown in FIG. 7, the sharing AP transmits the coordinated transmission request frame to the shared APs, to request the shared APs to participate in the multi-AP coordinated transmission with the C-BF scheme, or in other words, inquire the shared APs whether to participate in the multi-AP coordinated transmission with the C-BF scheme, and at the same time, indicate the shared APs to feed back the obtained first-type CSI. After receiving the coordinated transmission request frame, the shared APs synchronously reply with the coordinated transmission response frame.

For example, the AP m replies with the coordinated transmission response frame to indicate that the request of the sharing AP is accepted. The AP m may also indicate in the coordinated transmission response frame, the participation of the AP m and its associated STAs in C-BF, as well as the CSI between the AP m and the associated STAs participating in C-BF obtained by the AP m. That is, the AP m may feed back the first information and the obtained first-type CSI.

For another example, the AP n replies with the coordinated transmission response frame to indicate that the request of the sharing AP is rejected. In this case, the AP n may not indicate the participation of the STA associated with the AP n in C-BF, in the coordinated transmission response frame, because all STAs associated with the AP n do not participate in C-BF. And the AP n also does not report the CSI obtained by the AP n in the coordinated transmission response frame.

Further, as shown in FIG. 7, the sharing AP transmits the CSI request frame to a shared AP (e.g., the AP m) participating in C-BF, to request the AP participating in C-BF to feed back the second-type CSI. Optionally, the CSI request frame may also indicate that the AP n does not participate in C-BF.

The AP m, after receiving the CSI request frame, replies with the CSI report frame that carries the CSI (i.e., the second-type CSI) between the AP m and its associated OBSS STAs participating in C-BF obtained by the AP m. That is, the CSI carried in the CSI report frame by AP m does not include the CSI between the AP m and the STAs associated with the AP n.

At this point, the sharing AP may obtain the CSI and the target information reported by a shared AP. Further, for each of the APs participating in C-BF, the sharing AP may determine the target CSI according to the above information, and determine the steering matrix corresponding to the AP according to the target CSI. For example, according to the first-type CSI and the second-type CSI obtained by the AP m, the steering matrix corresponding to the AP m is determined.

Further, for each of the shared APs participating in C-BF, the sharing AP may transmit the coordinated transmission announce frame, to inform the steering matrix corresponding to the shared AP to the shared AP. For example, the sharing AP transmits the coordinated transmission announce frame to the AP m, to indicate the steering matrix corresponding to the AP m.

Optionally, a shared AP that receives the coordinated transmission announce frame may confirm the coordinated transmission announce frame transmitted by the sharing AP by an acknowledgment (Ack) frame, or the shared AP may not transmit the Ack frame, and by default, accept the coordinated transmission announce frame transmitted by the sharing AP.

As shown in FIG. 8, the sharing AP transmits the coordinated transmission request frame to the shared APs by unicasting, to request the shared APs to participate in the multi-AP coordinated transmission with the C-BF scheme, or in other words, inquire the shared APs whether to participate in the multi-AP coordinated transmission with the C-BF scheme, and at the same time, indicate the shared APs to feed back the first-type CSI. The shared APs may asynchronously reply with the coordinated transmission response frame.

For example, after the sharing AP transmits the coordinated transmission request frame to the AP m, the AP m replies with the coordinated transmission response frame, to indicate that the request of the sharing AP is accepted. The AP m may also indicate the participation of the AP m and its associated STA in C-BF and the first-type CSI obtained by the AP m, in the coordinated transmission response frame. That is, the AP m may feed back the first information and the obtained first-type CSI.

For another example, after the sharing AP transmits the coordinated transmission request frame to the AP n, the AP n replies with the coordinated transmission response frame, to indicate that the request of the sharing AP is rejected. In this case, the AP n may not indicate the participation of the STA associated with the AP n in C-BF, in the coordinated transmission response frame, because all STAs associated with the AP n do not participate in C-BF. And the AP n also does not report the CSI obtained by the AP n in the coordinated transmission response frame.

Further, as shown in FIG. 8, the sharing AP transmits the CSI request frame to a shared AP (e.g., AP m) participating in C-BF, to request the AP participating in C-BF to feed back the second-type CSI. Optionally, the CSI request frame may also indicate that the AP n does not participate in C-BF.

The AP m, after receiving the CSI request frame, replies with the CSI report frame that carries the CSI (i.e., the second-type CSI) between the AP m and its associated OBSS STAs participating in C-BF, obtained by the AP m. That is, the CSI carried in the CSI report frame by the AP m does not include the CSI between AP m and the STAs associated with the AP n.

At this point, the sharing AP may obtain the CSI and the target information reported by the shared APs. Further, for each of the APs participating in C-BF, the sharing AP may determine the target CSI according to the above information, and determine the steering matrix corresponding to the AP according to the target CSI. For example, according to the first-type CSI and the second-type CSI obtained by the AP m, the steering matrix corresponding to the AP m is determined.

Further, for each of the shared APs participating in C-BF, the sharing AP may transmit the coordinated transmission announce frame, to inform the steering matrix corresponding to the shared AP to the shared AP. For example, the sharing AP transmits the coordinated transmission announce frame to the AP m, to indicate the steering matrix corresponding to the AP m.

Optionally, a shared AP that receives the coordinated transmission announce frame may confirm the coordinated transmission announce frame transmitted by the sharing AP by an acknowledgment (Ack) frame, or the shared AP may not transmit the Ack frame, and by default, accept the coordinated transmission announce frame transmitted by the sharing AP.

As shown in FIG. 9, the sharing AP may transmit the coordinated transmission request frame to the shared APs, to request the shared APs to participate in the multi-AP coordinated transmission with the C-BF scheme, or in other words, inquire the shared APs whether to participate in the multi-AP coordinated transmission with the C-BF scheme, and at the same time, indicate the shared APs to feed back the obtained first-type CSI and the CSI between the shared APs and the non-associated OBSS STAs. After receiving the coordinated transmission request frame, the shared APs synchronously reply with the coordinated transmission response frame.

For example, the AP m replies with the coordinated transmission response frame, to indicate that the request of the sharing AP is accepted. The AP m may also indicate in the coordinated transmission response frame, the participation of the AP m and its associated STAs in C-BF, as well as the first-type CSI and the CSI between the shared AP and the non-associated OBSS STAs obtained by the AP m.

For another example, the AP n replies with the coordinated transmission response frame to indicate that the request of the sharing AP is rejected. In this case, the AP n may not indicate the participation of the STA associated with the AP n in C-BF, in the coordinated transmission response frame, because all STAs associated with the AP n do not participate in C-BF. And the AP n also does not report the CSI obtained by the AP n in the coordinated transmission response frame.

At this point, the sharing AP may obtain the CSI and the target information reported by the shared APs. Further, for each of the APs participating in C-BF, the sharing AP may determine the target CSI according to the above information, and determine the steering matrix corresponding to the AP according to the target CSI. For example, according to the first-type CSI and the second-type CSI obtained by the AP m, the steering matrix corresponding to the AP m is determined.

Further, for each of the shared APs participating in C-BF, the sharing AP may transmit the coordinated transmission announce frame, to inform the steering matrix corresponding to the shared AP to the shared AP. For example, the sharing AP transmits the coordinated transmission announce frame to the AP m, to indicate the steering matrix corresponding to the AP m.

Optionally, a shared AP that receives the coordinated transmission announce frame may confirm the coordinated transmission announce frame transmitted by the sharing AP by an acknowledgment (Ack) frame, or the shared AP may not transmit the Ack frame, and by default, accept the coordinated transmission announce frame transmitted by the sharing AP.

As shown in FIG. 10, the sharing AP transmits the coordinated transmission request frame to the shared APs by unicasting, to request the shared APs to participate in the multi-AP coordinated transmission with the C-BF scheme, or in other words, inquire the shared APs whether to participate in the multi-AP coordinated transmission with the C-BF scheme, and at the same time, indicate the shared APs to feed back the obtained first-type CSI and CSI between the shared AP and the non-associated OBSS STAs. The shared APs may asynchronously reply with the coordinated transmission response frame.

For example, after the sharing AP transmits the coordinated transmission request frame to the AP m, the AP m replies with the coordinated transmission response frame, to indicate that the request of the sharing AP is accepted. The AP m may also indicate the participation of the AP m and its associated STA in C-BF, as well as the first-type CSI and CSI between the shared AP and the non-associated OBSS STAs obtained by the AP m, in the coordinated transmission response frame.

For another example, after the sharing AP transmits the coordinated transmission request frame to the AP n, the AP n replies with the coordinated transmission response frame, to indicate that the request of the sharing AP is rejected. In this case, the AP n may not indicate the participation of the STA associated with the AP n in C-BF, in the coordinated transmission response frame, because all STAs associated with the AP n do not participate in C-BF. And the AP n also does not report the CSI obtained by the AP n in the coordinated transmission response frame.

At this point, the sharing AP may obtain the CSI and the target information reported by the shared APs. Further, for each of the APs participating in C-BF, the sharing AP may determine the target CSI according to the above information, and determine the steering matrix corresponding to the AP according to the target CSI. For example, according to the first-type CSI and the second-type CSI obtained by the AP m, the steering matrix corresponding to the AP m is determined.

Further, for each of the shared APs participating in C-BF, the sharing AP may transmit the coordinated transmission announce frame, to inform the steering matrix corresponding to shared AP to the shared AP. For example, the sharing AP transmits the coordinated transmission announce frame to the AP m, to indicate the steering matrix corresponding to the AP m.

Optionally, a shared AP that receives the coordinated transmission announce frame may confirm the coordinated transmission announce frame transmitted by the sharing AP by an acknowledgment (Ack) frame, or the shared AP may not transmit the Ack frame, and by default, accept the coordinated transmission announce frame transmitted by the sharing AP.

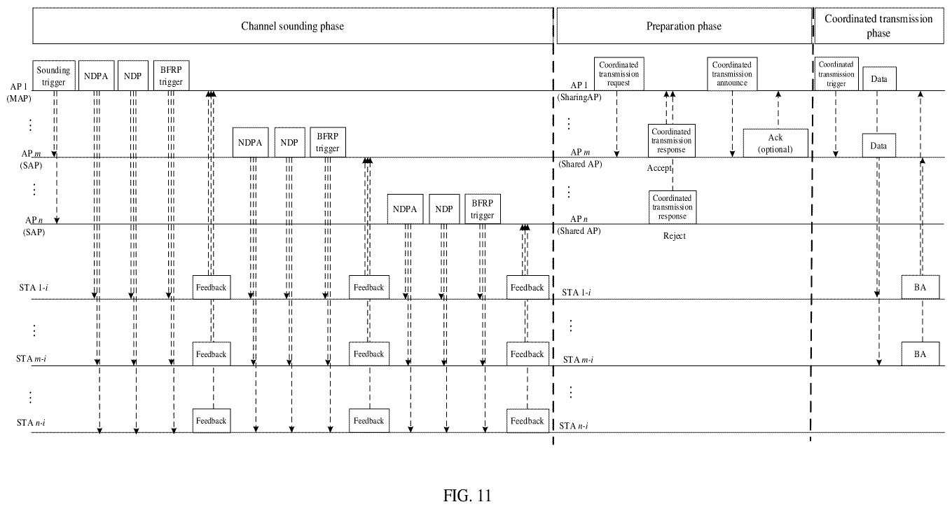

In conjunction with a specific example of FIG. 11, the procedure of the multi-AP coordinated transmission with the C-BF scheme according to the embodiments of the present application is described.

In the example of FIG. 11, the establishment of a multi-AP coordinated set supporting C-BF has been completed, where in the channel sounding phase, an AP1 is an MAP, an AP m and an AP n are SAPs in the multi-AP coordinated set, where an STA 1-i is associated with the AP 1, an STA m-i is associated with the AP m, and an STA n-i is associated with the AP n, where i represents an i^{th} STA associated with the AP.

### I. Channel Sounding Phase

In the channel sounding phase, APs (including the MAP and SAPs) in the multi-AP coordinated set perform sequential channel sounding, and each AP obtains and stores channel state information between the AP and each STA (including associated STAs and OBSS STAs). For the specific sounding method, please refer to the relevant description of the embodiments shown in FIG. 5, which will not be repeated here.

As an example but not a limitation, the channel state information stored by the APs in the multi-AP coordinated set may be as shown in Table 1. After completing the channel sounding, the AP 1 may store a row of channel state information corresponding to the AP 1, the AP m may store a row of channel state information corresponding to the AP m, the AP n may store a row of channel state information corresponding to the AP n, and so on.

TABLE 1
Channel state information obtained
by each AP through channel sounding

| | STA 1-i | . . . | STA m-i | . . . | STA n-i |
|---|---|---|---|---|---|
| AP 1 | H(1, 1-i) | . . . | H(1, m-i) | . . . | H(1, n-i) |
| . . . | . . . | . . . | . . . | . . . | . . . |
| AP m | H(m, 1-i) | . . . | H(m, m-i) | . . . | H(m, n-i) |
| . . . | . . . | . . . | . . . | . . . | . . . |
| AP n | H(n, 1-i) | . . . | H(n, m-i) | . . . | H(n, n-i) |

Herein, H(1,1-i) represents the channel state information between the AP 1 and STA 1-i, H(m,1-i) represents the channel state information between the AP m and STA 1-i, H(n,1-i) represents the channel state information between the AP n and STA 1-i, and the meanings of other channel state information are similar and are not repeated here.

### II. Preparation Phase

In the preparation phase, the sharing APs transmit a coordinated transmission request frame, for example, which may be transmitted by broadcasting or multicasting, or may also be transmitted by unicasting. The shared APs reply with a coordinated transmission response frame, for example, reply with the coordinated transmission response frame synchronously or asynchronously.

Optionally, during the preparation phase, the sharing AP may also transmit a CSI request frame (not shown in FIG. 11), for example, may transmit by broadcasting or multicasting, or by unicasting. The shared APs reply with the CSI report frame, for example, synchronously or asynchronously. Specific interaction schemes refer to the relevant descriptions of FIG. 7 to FIG. 10.

The following describes report methods of the participation information and CSI information in conjunction with specific interaction schemes.

Embodiment 1: The preparation phase does not include the interaction of the CSI request frame and the CSI report frame, and the CSI is acquired by the coordinated transmission response frame, corresponding to the aforementioned acquisition method 1. Specific interaction schemes refer to the relevant descriptions of FIG. 9 and FIG. 10.

For example, if a shared AP participates in C-BF, the following information is carried in the coordinated transmission response frame:
a list of STAs associated with the shared AP (optional);
a list of STAs participating in C-BF and associated with the shared AP (mandatory);
CSI between the shared AP and the associated STAs participating in C-BF (i.e., removing CSI between the shared AP and its associated STAs not participating in C-BF);
CSI between the shared AP and the non-associated OBSS STAs.

For another example, if a shared AP does not participate in C-BF, the following information is carried in the coordinated transmission response frame:
a list of STAs associated with the shared AP (optional).

Furthermore, the sharing AP calculates a steering matrix corresponding to each AP participating in C-BF based on the collected CSI described above.

For example, if the sharing AP collects the following information:
1) a list of STAs associated with each shared AP (e.g., AP 1 and AP m) participating in C-BF (optional);
2) a list of STAs participating in C-BF and associated with each shared AP participating in C-BF (mandatory), for example:
STA 1-i associated with the AP 1 being participating in C-BF;
STA m-i associated with the AP m being participating in C-BF;
3) CSI between each shared AP and its associated STAs participating in C-BF, for example:
CSI between the AP 1 and the STA 1-i, i.e., H(1,1-i);
CSI between the AP m and the STA m-i, i.e., H(m, m-i);
4) CSI between each shared AP and the non-associated OBSS STAs, for example:
CSI between the AP 1 and the STA m-i, i.e., H(1, m-i), and CSI between the AP 1 and the STA n-i, i.e., H(1, n-i);
CSI between the AP m and the STA 1-i, i.e., H(m, 1-i), and CSI between the AP m and the STA n-i, i.e., H(m, n-i).

Then, when the sharing AP calculates the steering matrices corresponding to the APs (for example, AP 1 and AP m) participating in C-BF, the following invalid CSI information in Table 1 needs to be removed:

1) CSI between the AP participating in C-BF and its associated STAs not participating in C-BF, for example:
when calculating the steering matrix of the AP 1, removing other CSI information except H(1,1-i) and H(1,m-i) in Table 1;
when calculating the steering matrix of the AP m, removing other CSI information except H(m, 1-i) and H(m, m-i) in Table 1;
2) CSI between the AP participating in C-BF and the STA (e.g., STA n-i) associated with the AP (e.g., AP n) not participating in C-BF.

For example, when calculating the steering matrix corresponding to the AP 1, H(1, n-i) in Table 1 is removed; when calculating the steering matrix of the AP m, H(m, n-i) in Table 1 is removed.

Further, when the sharing AP calculates the steering matrix corresponding to the AP 1, it may use the CSI information (H(1,1-i), H(1 m-i)) to calculate the C-BF steering matrix corresponding to the AP 1. When the sharing AP calculates the steering matrix corresponding to the AP m, it may use the CSI information (H(m, 1-i), H(m, m-i)) to calculate the C-BF steering matrix corresponding to the AP m.

Embodiment 2: the preparation phase includes the interaction of the CSI request frame and the CSI report frame, and the CSI is acquired by the coordinated transmission response frame and the CSI report frame, corresponding to the aforementioned acquisition method 2. Specific interaction schemes refer to the relevant descriptions of FIG. 7 and FIG. 8.

For example, if a shared AP participates in C-BF, the following information is carried in the coordinated transmission response frame:
a list of STAs associated with the shared AP (optional);
a list of STAs participating in C-BF and associated with the shared AP (mandatory);
CSI between the shared AP and the associated STAs participating in C-BF (i.e., removing CSI between the shared AP and its associated STAs not participating in C-BF), that is, the first-type CSI

For another example, if a shared AP does not participate in C-BF, the following information is carried in the coordinated transmission response frame:
a list of STAs associated with the shared AP (optional).

In the preparation phase, the sharing AP may transmit the CSI Request frame to a shared AP participating in C-BF, to request the shared AP to report the CSI between the AP and the OBSS STAs participating in C-BF (i.e., the second-type CSI). In addition, the CSI Request frame may also carry the target information.

The shared AP replies with the CSI Report to the sharing AP, where the CSI Report frame carries the CSI between the shared AP and the OBSS STAs participating in C-BF. That is, the shared AP will remove the CSI between the shared AP and the OBSS STAs not participating in C-BF.

Furthermore, the sharing AP calculates a steering matrix corresponding to each AP participating in C-BF based on the collected CSI described above.

As an example, the sharing AP collects the following information:
1) a list of STAs associated with each shared AP (e.g., AP 1 and AP m) participating in C-BF (optional);
2) a list of STAs participating in C-BF and associated with each shared AP participating in C-BF (mandatory), for example:
STA 1-i associated with the AP 1 being participating in C-BF;
STA m-i associated with the AP m being participating in C-BF;
3) CSI between each shared AP and its associated STAs participating in C-BF, for example:
CSI between the AP 1 and the STA 1-i, i.e., H(1,1-i);
CSI between the AP m and the STA m-i, i.e., H(m, m-i);
4) CSI between each shared AP and the non-associated OBSS STAs, for example:
CSI between the AP 1 and the STA m-i, i.e., H(1, m-i);
CSI between the AP m and the STA 1-i, i.e., H(m, 1-i).

Then, when the sharing AP calculates the steering matrix corresponding to the AP 1, it may use the CSI information (H(1,1-i), H(1 m-i)) to calculate the C-BF steering matrix corresponding to the AP 1. When the sharing AP calculates the steering matrix corresponding to the AP m, it may use the CSI information (H(m, 1-i), H(m, m-i)) to calculate the C-BF steering matrix corresponding to the AP m.

Embodiment 3: the preparation phase includes the interaction of the CSI request frame and the CSI report frame, and the CSI is acquired by the CSI report frame, corresponding to the aforementioned acquisition method 3. Specific interaction schemes refer to the relevant descriptions of FIG. 7 and FIG. 8.

Different from Embodiment 2, the coordinated transmission response frame does not include the CSI information, and the CSI report frame includes the first-type CSI and the second-type CSI obtained by the AP, and in this case, for each of the APs participating in C-BF, the sharing AP may calculate the steering matrix corresponding to the AP according to the method described in Embodiment 2.

It should be understood that the method for calculating the C-BF steering matrix is not limited to the present application. However, the principle for calculating the C-BF steering matrix is to enhance the signal quality (e.g. SINR) of STAs participating in C-BF and associated with the AP, and to weaken the signal quality of the non-associated STAs participating in C-BF (i.e., STAs participating in C-BF under other APs) (i.e., nulls of the transmitted signal is aligned to the non-associated STAs participating in C-BF). Optionally, the multi-AP coordinated transmission with the C-BF scheme in the embodiments of the present application may be applicable to relatively static scenarios where locations of the APs and/or STAs are relatively fixed and the wireless channel changes in the environment are relatively weak. When the environment of the wireless communication changes significantly (for example, the APs and/or STAs undergo significant location changes or other APs and/or STAs are newly added), the channel state information pre-stored by the APs cannot accurately reflect the CSI information between each AP and each STA. Coordinated transmission based on a steering matrix calculated based on the channel state information before the wireless communication environment changes may result in poor performance of C-BF. In this case, it is necessary to re-perform the previous channel sounding or perform partial channel sounding to obtain the latest and more accurate channel state information, and then re-calculate a new steering matrix according to the latest channel state information, to enable the performance of C-BF to be maintained at the best state.

It is worth noting that when the wireless communication environment changes significantly (for example, the AP and/or STA undergo a significant position change or other APs and/or STAs are newly added), the pre-stored channel state information cannot accurately reflect the channel state information between each AP and each STA. The coordinated transmission based on a steering matrix calculated based on the channel state information before the wireless communication environment changes may result in poor performance of C-BF. At this time, it is necessary to re-perform the previous channel sounding or perform partial channel sounding to obtain the latest and more accurate channel state information, and then re-calculate a new steering matrix according to the latest channel state information, to enable the performance of C-BF to be maintained at the best state.

After calculating and obtaining the steering matrixes corresponding to the APs participating in C-BF, the sharing AP may transmit each steering matrix participating in C-BF to each shared AP participating in C-BF by the coordinated transmission announce frame.

### III. Coordinated Transmission Phase

In the coordinated transmission phase, the sharing AP transmits a coordinated TX trigger frame to trigger APs participating in C-BF to perform the multi-AP coordinated transmission. For example, the shared APs participating in C-BF transmit data according to the steering matrix announced by the sharing AP.

Optionally, each STA replies with a block acknowledgement (BA) frame after receiving the data transmitted by the AP.

It should be understood that FIG. 11 only takes an example in which the MAP and the sharing AP are the same AP. In other embodiments, the MAP and the sharing AP may also be different APs, which are not limited to the present application.

In some embodiments of the present application, the sharing AP may also announce each steering matrix participating in C-BF to each AP participating in C-BF during the coordinated transmission phase. In this case, during the preparation phase, the sharing AP may not transmit the coordinated transmission announce frame. For example, the sharing AP may carry each steering matrix participating in C-BF in the coordinated transmission trigger frame. Further, the shared APs participating in C-BF may perform the data transmission according to their corresponding steering matrix. That is, the steps in which the sharing AP transmits the coordinated transmission announce and the shared APs reply with the response (optional) are omitted.

That is, during the coordinated transmission phase, the sharing AP uses the coordinated transmission trigger frame to implement the function of the coordinated transmission announce frame. In this case, the format design of the coordinated transmission trigger frame is similar to the frame format design of the coordinated transmission announce frame.

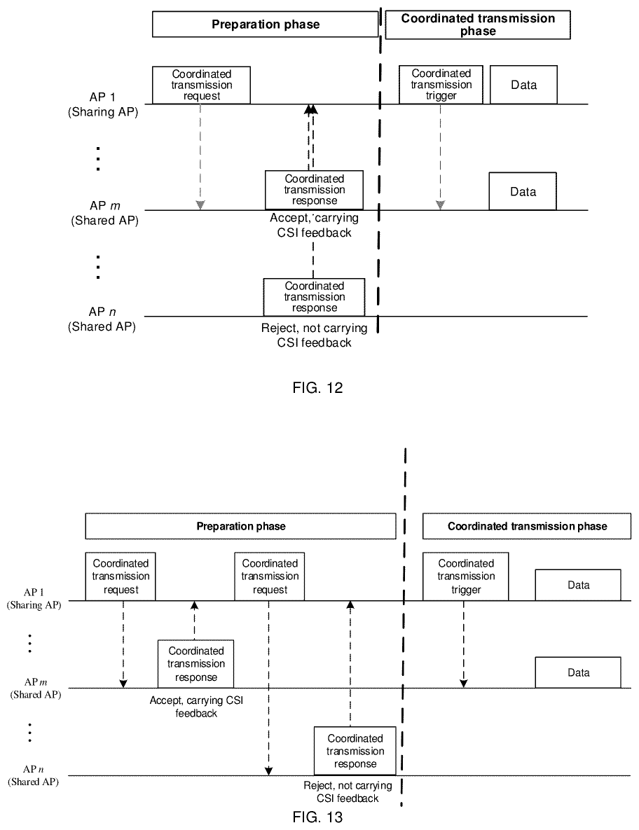

FIG. 12 and FIG. 13 are schematic diagrams of interaction in which the function of the coordinated transmission announce frame is implemented by the coordinated transmission trigger frame. Herein, during the preparation phase in FIG. 12, the shared APs may synchronously reply to the coordinated transmission request frame of the sharing AP, and during the preparation phase in FIG. 13, the shared APs may asynchronously reply to the coordinated transmission request frame of the sharing AP. It should be understood that during the preparation phase, the sharing AP may in steps collect the CSI obtained by the shared APs, or at one time collect the CSI obtained by the shared APs, that is, the interaction methods in the preparation phase of FIG. 12 and FIG. 13 may also adopt the interaction methods in FIG. 7 and FIG. 8, which will not be repeated here.

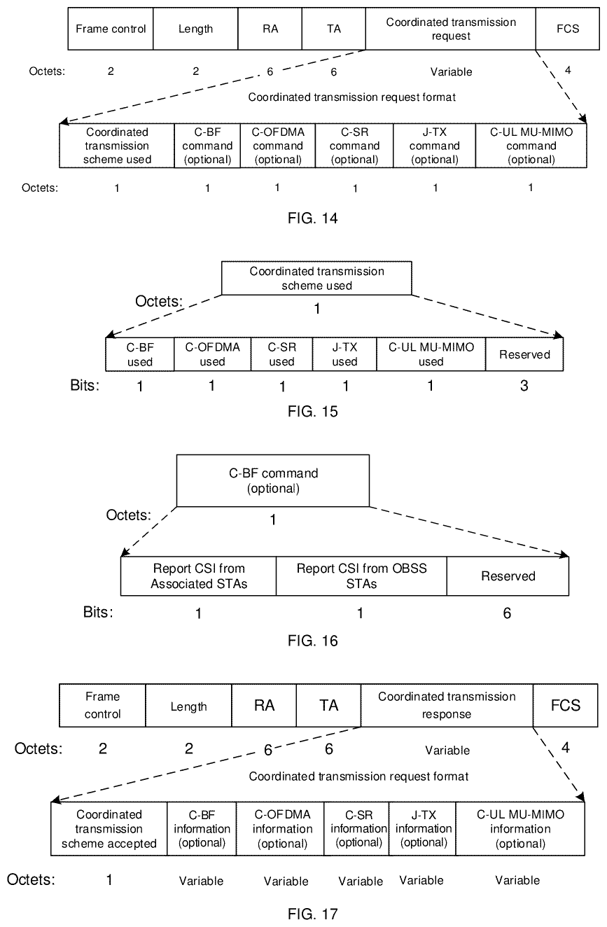

Frame format designs of the coordinated transmission request frame, the coordinated transmission response frame, the CSI request frame, the CSI report frame and the coordinated transmission announce frame are described below, in conjunction with FIG. 14 to FIG. 24.

It should be understood that information carried in frame formats and a location and size of each field in frame formats shown in FIG. 14 to FIG. 24 are only examples, which may be flexibly adjusted according to actual needs or the carried information, which is not limited to the present application.

FIG. 14 is a schematic diagram of a frame format of a coordinated transmission request frame, provided by the embodiments of the present application, which may include the following domains (or fields):
frame control (occupying 2 bytes), duration (occupying 2 bytes), receiving address (RA) (occupying 6 bytes), transmission address (TA) (occupying 6 bytes), coordinated TX request (occupying a variable number of bytes), frame check sequence (FCS, occupying 4 bytes).

In some embodiments, as shown in FIG. 14, the coordinated transmission request field includes at least one of:
a coordinated TX scheme used field, to indicate a coordinated transmission scheme requested to be used, that is, to carry the aforementioned second indication information;
a C-BF command field, to indicate a command used when the multi-AP coordinated transmission with the C-BF scheme is adopted;
a C-OFDMA command field, to indicate a command used when the multi-AP coordinated transmission with a C-OFDMA scheme is adopted;
a C-SR command field, to indicate a command used when the multi-AP coordinated transmission with a C-SR scheme is adopted;
a J-TX command field, to indicate a command used when the multi-AP coordinated transmission with a J-TX scheme is adopted;
a C-UL MU MIMO command field, to indicate a command used when the multi-AP coordinated transmission with a C-UL MU MIMO scheme is adopted.

In some embodiments, as shown in FIG. 15, the coordinated TX scheme used field includes at least one of the following fields:
a C-BF used field, to indicate whether to request to use the multi-AP coordinated transmission with the C-BF scheme;
a C-OFDMA used field, to indicate whether to request to use the multi-AP coordinated transmission with the C-OFDMA scheme;
a C-SR used field, to indicate whether to request to use the multi-AP coordinated transmission with the C-SR scheme;
a J-TX used field, to indicate whether to request to use the multi-AP coordinated transmission with the J-TX scheme; or
a C-UL MU MIMO used field, to indicate whether to request to use the multi-AP coordinated transmission with the C-UL MU MIMO scheme.

Optionally, the binary value of the C-BF used field being 1, indicates that the shared APs are requested to perform the multi-AP coordinated transmission with the C-BF scheme, in this case, the coordinated transmission request frame includes the C-BF command field. The binary value of the C-BF used field being 0, indicates that the shared APs are not requested to perform the multi-AP coordinated transmission with the C-BF scheme, in this case, the coordinated transmission request frame does not include the C-BF command field.

Optionally, the binary value of the C-OFDMA used field being 1, indicates that the shared APs are requested to perform the multi-AP coordinated transmission with the C-OFDMA scheme, in this case, the coordinated transmission request frame includes the C-OFDMA command field. The binary value of the C-OFDMA used field being 0, indicates that the shared APs are not requested to perform the multi-AP coordinated transmission with the C-OFDMA scheme, in this case, the coordinated transmission request frame does not include the C-OFDMA command field.

Optionally, the binary value of the C-SR used field being 1, indicates that the shared APs are requested to perform the multi-AP coordinated transmission with the C-SR scheme, in this case, the coordinated transmission request frame includes the C-SR command field. The binary value of the C-SR used field being 0, indicates that the shared APs are not requested to perform the multi-AP coordinated transmission with the C-SR scheme, in this case, the coordinated transmission request frame does not include the C-SR command field.

Optionally, the binary value of the J-TX used field being 1, indicates that the shared APs are requested to perform the multi-AP coordinated transmission with the J-TX scheme, in this case, the coordinated transmission request frame includes the J-TX command field. The binary value of the J-TX used field being 0, indicates that the shared APs are not requested to perform the multi-AP coordinated transmission with the J-TX scheme, in this case, the coordinated transmission request frame does not include the J-TX command field.

Optionally, the binary value of the C-UL MU-MIMO used field being 1, indicates that the shared APs are requested to perform the multi-AP coordinated transmission with the C-UL MU-MIMO scheme, in this case, the coordinated transmission request frame includes the C-UL MU-MIMO command field. The binary value of the C-UL MU-MIMO used field being 0, indicates that the shared APs are not requested to perform the multi-AP coordinated transmission with the C-UL MU-MIMO scheme, in this case, the coordinated transmission request frame does not include the C-UL MU-MIMO command field.

In some embodiments, as shown in FIG. 16, the C-BF command field includes at least one of:
a reporting associated STA's CSI (Report CSI from Associated STAs) field, to indicate whether to feed back the first-type CSI obtained by the second AP, that is, to carry the aforementioned second indication information; or
a reporting OBSS STA's CSI (Report CSI from OBSS STAs) field, to indicate whether to feed back CSI between the second AP and non-associated OBSS STAs, obtained by the second AP, that is, to carry the aforementioned third indication information.

In some embodiments, the binary value 1 of the Report CSI from Associated STAs field indicates that the shared APs feed back the CSI between the shared AP and their associated STAs participating in C-BF, and the binary value 0 indicates that the shared AP does not feed back the CSI between the shared APs and their associated STAs participating in C-BF.

In some embodiments, the binary value 1 of the Report CSI from OBSS STAs field indicates that the shared APs feed back the CSI between the shared APs and the non-associated OBSS STAs, and the binary value 0 indicates that the shared APs do not feed back the CSI between the shared APs and the non-associated OBSS STAs.

FIG. 17 to FIG. 19 are schematic diagrams of a frame format of a coordinated transmission response frame, provided by the embodiments of the present application.

As shown in FIG. 17, the coordinated transmission response frame may include the following domains (or fields):
frame control (occupying 2 bytes), duration (occupying 2 bytes), receiving address (RA) (occupying 6 bytes), transmission address (TA) (occupying 6 bytes), coordinated TX response (occupying a variable number of bytes), FCS (occupying 4 bytes).

In some embodiments, as shown in FIG. 17, the coordinated transmission response field includes at least one of:
a coordinated TX scheme accept field, to indicate whether the third AP accepts a requested coordinated transmission scheme;
a C-BF information field (C-BF Info. field), to indicate information related to the second AP with C-BF;
a C-OFDMA information field (C-OFDMA Info. field), to indicate information related to the second AP with C-OFDMA;
a C-SR information field (C-SR Info. field), to indicate information related to the second AP with C-SR;
a J-TX information field (J-TX Info. field), to indicate information related to the second AP with J-TX;
a C-UL MU MIMO information field (C-UL MU MIMO Info. field), to indicate information related to the second AP with C-UL MU MIMO.

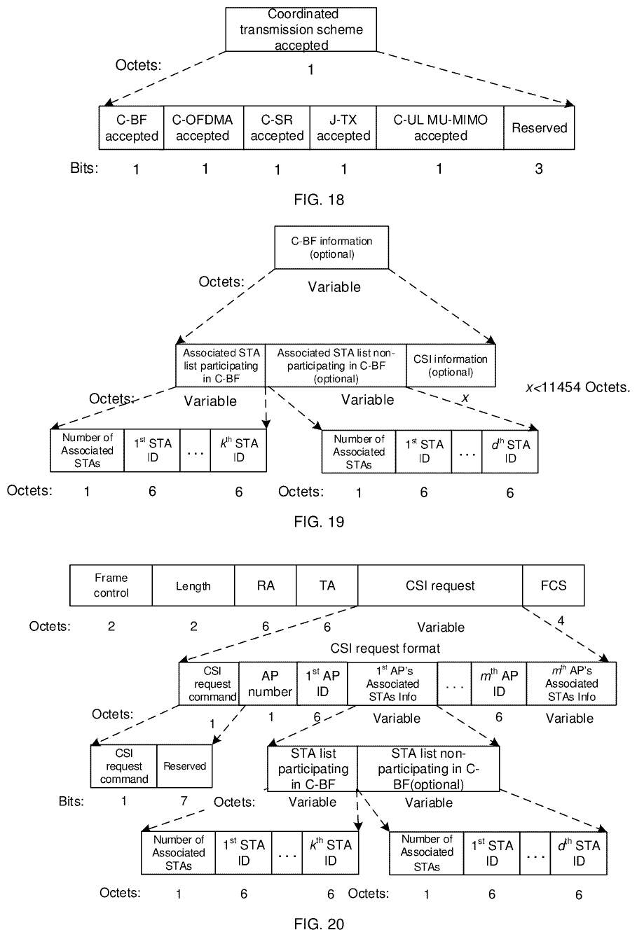

In some embodiments, as shown in FIG. 18, the coordinated transmission scheme accept field includes at least one of the following fields:
a C-BF accept field, to indicate whether the coordinated transmission with a C-BF scheme is accepted;
a C-OFDMA accept field, to indicate whether the coordinated transmission with a C-OFDMA scheme is accepted;
a C-SR accept field, to indicate whether the coordinated transmission with a C-SR scheme is accepted;
a J-TX accept field, to indicate whether the coordinated transmission with a J-TX scheme is accepted; or
a C-UL MU MIMO accept field, to indicate whether the coordinated transmission with a C-UL MU MIMO scheme is accepted.

Optionally, the binary value of the C-BF accept field being 1, indicates that the multi-AP coordinated transmission with the C-BF scheme is accepted, in this case, the coordinated transmission response frame includes the C-BF information field. The binary value of the C-BF accept field being 0, indicates that the multi-AP coordinated transmission with the C-BF scheme is rejected, in this case, the coordinated transmission response frame does not include the C-BF information field.

Optionally, the binary value of the C-OFDMA accept field being 1, indicates that the multi-AP coordinated transmission with the C-OFDMA scheme is accepted, in this case, the coordinated transmission response frame includes the C-OFDMA information field. The binary value of the C-OFDMA accept field being 0, indicates that the multi-AP coordinated transmission with the C-OFDMA scheme is rejected, in this case, the coordinated transmission response frame does not include the C-OFDMA information field.

Optionally, the binary value of the C-SR accept field being 1, indicates that the multi-AP coordinated transmission with the C-SR scheme is accepted, in this case, the coordinated transmission response frame includes the C-SR information field. The binary value of the C-SR accept field being 0, indicates that the multi-AP coordinated transmission with the C-SR scheme is rejected, in this case, the coordinated transmission response frame does not include the C-SR information field.

Optionally, the binary value of the J-TX accept field being 1, indicates that the multi-AP coordinated transmission with the J-TX scheme is accepted, in this case, the coordinated transmission response frame includes the J-TX information field. The binary value of the J-TX accept field being 0, indicates that the multi-AP coordinated transmission with the J-TX scheme is rejected, in this case, the coordinated transmission response frame does not include the J-TX information field.

Optionally, the binary value of the C-UL MU-MIMO accept field being 1, indicates that the multi-AP coordinated transmission with the C-UL MU-MIMO scheme is accepted, in this case, the coordinated transmission response frame includes the C-UL MU-MIMO information field. The binary value of the C-UL MU-MIMO accept field being 0, indicates that the multi-AP coordinated transmission with the C-UL MU-MIMO scheme is rejected, in this case, the coordinated transmission response frame does not include the C-UL MU-MIMO information field.

In some embodiments, as shown in FIG. 19, the C-BF information field includes at least one of:
an associated STA list participating in C-BF field (Associated STA List for C-BF subfield), to indicate STAs associated with the second AP participating in the multi-AP coordinated transmission with the C-BF scheme;
an associated STA list non-participating in C-BF field (Associated STA List for no C-BF subfield), to indicate STAs associated with the second AP not participating in the multi-AP coordinated transmission with the C-BF scheme; or
a CSI information field, to indicate the first-type CSI obtained by the second AP and/or CSI between the second AP and non-associated OBSS STAs obtained by the second AP.

In some embodiments, as shown in FIG. 19, the Associated STA List for C-BF subfield includes at least one of:
an associated STA number (Number of Associated STAs) field, to indicate the number of STAs participating in C-BF associated with the second AP; or
at least one STA ID field, where a k^{th} STA ID is used to indicate an ID of the k^{th} STA participating in C-BF associated with the second AP.

In some embodiments, as shown in FIG. 19, the Associated STA List for no C-BF subfield includes at least one of:
an associated STA number (Number of Associated STAs) field, to indicate the number of STAs not participating in C-BF associated with the second AP; or
at least one STA ID field, where a d^{th} STA ID is used to indicate an ID of the d^{th} STA not participating in C-BF associated with the second AP.

Optionally, when the binary value of the C-BF accept field is 1, the coordinated transmission response frame includes the CSI information field; when the binary value of the C-BF accept field is 0, the coordinated transmission response frame does not include the CSI information field.

In some embodiments, if the binary value of the Report CSI from Associated STAs field of the coordinated transmission request frame is 1, the coordinated transmission response frame carries the first-type CSI obtained by the shared APs, otherwise, it does not carry the first-type CSI obtained by the shared APs; if the binary value of the Report CSI from OBSS STAs is 1, the coordinated transmission response frame carries the CSI between the shared APs and the non-associated OBSS STAs, otherwise, it does not carry the CSI between the shared APs and the non-associated OBSS STAs.

In some embodiments, a length x of the CSI information field satisfies that the coordinated transmission (TX) response frame does not exceed 11454 bytes, otherwise, the coordinated transmission response frame needs to be segmented.

FIG. 20 is a schematic diagram of a frame format of a CSI request frame, provided by the embodiments of the present application, which may include the following domains (or fields):
frame control (occupying 2 bytes), duration (occupying 2 bytes), receiving address (RA) (occupying 6 bytes), transmission address (TA) (occupying 6 bytes), CSI request (occupying a variable number of bytes), FCS (occupying 4 bytes).

In some embodiments, as shown in FIG. 20, the CSI request field includes at least one of:
a CSI request command field, to indicate to request the third AP to feed back the first-type CSI and/or the second-type CSI;
an AP number (Number of APs) field, to indicate the number of APs included in the CSI request frame;
at least one AP ID field, to indicate APs participating in the multi-AP coordinated transmission with the C-BF scheme and/or APs not participating in the multi-AP coordinated transmission with the C-BF scheme; or
at least one associated STA information (AP's Associated STAs Info) field, where each associated STA information field corresponds to an AP indicated by the at least one AP ID field, and each associated STA information field is used to indicate STAs participating in C-BF and/or STAs not participating in C-BF associated with a corresponding AP.

In some embodiments, the binary value 0 of the CSI request command field indicates that the sharing AP requests the shared APs to feed back the CSI between the shared APs and the OBSS STAs participating in C-BF; the binary value 1 of the CSI request command field indicates that the sharing AP requests the shared APs to feed back the CSI between the shared APs and their associated STAs participating in C-BF and the CSI between the shared APs and the OBSS STAs participating in C-BF.

In some embodiments, as shown in FIG. 20, the at least one AP ID field may include a first AP ID (1^{st} AP ID) field, . . . , an m-th AP ID (m^{th} AP ID) field, etc., the first AP ID (1^{st} AP ID) field indicates an ID of the first AP participating in C-BF, and the m^{th} AP ID indicates an ID of the m^{th} AP participating in C-BF.

In some embodiments, as shown in FIG. 20, the at least one associated STA list field may include a first AP's STA information (1^{st} AP's Associated STAs Info) field, . . . , an m^{th} AP's associated STA list (m^{th} AP's Associated STAs Info) field, etc. The 1^{st} AP's Associated STAs Info field indicates the STAs participating in C-BF and/or the STAs not participating in C-BF associated with the first AP participating in C-BF, and the m^{th} AP's Associated STAs Info indicates the STAs participating in C-BF and/or the STAs not participating in C-BF associated with the math AP participating in C-BF.

In some embodiments, as shown in FIG. 20, each associated STA information field includes at least one of:
an associated STA list participating in C-BF (Associated STA List for C-BF) field, where the STA list participating in C-BF field is used to indicate STAs participating in the multi-AP coordinated transmission with the C-BF scheme and associated with a corresponding AP; or
an associated STA list non-participating in C-BF (Associated STA List for no C-BF) field, where the STA list non-participating in C-BF field is used to indicate STAs not participating in the multi-AP coordinated transmission with the C-BF scheme and associated with a corresponding AP.

In some embodiments, as shown in FIG. 20, each Associated STA List for C-BF field includes at least one of:
an associated STA number (Number of Associated STAs) field, to indicate the number of STAs participating in C-BF associated with a corresponding AP; or
at least one STA ID field, where a k^{th} STA ID is used to indicate an ID of the k^{th} STA participating in C-BF associated with a corresponding AP.

In some embodiments, as shown in FIG. 20, the Associated STA List for no C-BF field includes at least one of:
an associated STA number (Number of Associated STAs) field, to indicate the number of STAs not participating in C-BF associated with the corresponding AP; or
at least one STA ID field, where a d^{th} STA ID is used to indicate an ID of the d^{th} STA not participating in C-BF associated with a corresponding AP.

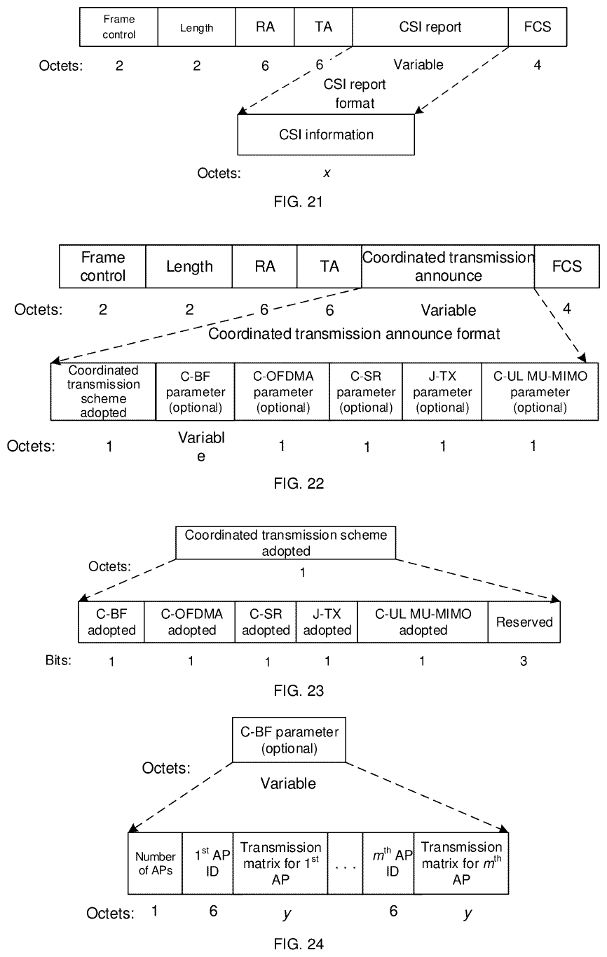

FIG. 21 is a schematic diagram of a frame format of a CSI report frame, provided by the embodiments of the present application, which may include the following domains (or fields):
frame control (occupying 2 bytes), duration (occupying 2 bytes), receiving address (RA) (occupying 6 bytes), transmission address (TA) (occupying 6 bytes), CSI report (occupying a variable number of bytes), FCS (occupying 4 bytes).

In some embodiments, as shown in FIG. 21, the CSI report field may include a CSI information field (CSI Information field) for carrying CSI information reported by the AP.

For example, the CSI information field is used to carry the CSI between the shared APs and the non-associated OBSS STAs, or may also be used to carry the CSI between the shared APs and the associated STAs participating in C-BF, and the CSI between the shared APs and the non-associated OBSS STAs.

In some embodiments, a length x of the CSI Information field satisfies that the CSI report frame does not exceed 11454 bytes, otherwise, the CSI report frame needs to be segmented.

FIG. 22 is a schematic diagram of a frame format of a coordinated transmission announce frame, provided by the embodiments of the present application, which may include the following domains (or fields):
frame control (occupying 2 bytes), duration (occupying 2 bytes), receiving address (RA, occupying 6 bytes), transmission address (TA, occupying 6 bytes), coordinated TX announce (variable number of occupied bytes), FCS (occupying 4 bytes).

In some embodiments, as shown in FIG. 22, the coordinated transmission announce field includes at least one of:
a coordinated TX scheme adopted field, to indicate a scheme adopted to perform the multi-AP coordinated transmission;
a C-BF parameter field (C-BF Parameters field), to indicate a parameter or command adopted to perform the multi-AP coordinated transmission with the C-BF scheme;
a coordinated orthogonal frequency division multiple access (C-OFDMA) parameter field (C-OFDMA Parameters field), to indicate a parameter or command adopted to perform the multi-AP coordinated transmission with a C-OFDMA scheme;
a coordinated spatial reuse (C-SR) parameter field (C-SR Parameters field), to indicate a parameter or command adopted to perform the multi-AP coordinated transmission with a C-SR scheme;
a joint transmission (J-TX) parameter field (J-TX Parameters field), to indicate a parameter or command adopted to perform the multi-AP coordinated transmission with a J-TX scheme; or
a coordinated uplink multiple user multiple input multiple output (C-UL MU MIMO) parameter field (C-UL MU-MIMO Parameters field), to indicate a parameter or command adopted to perform the multi-AP coordinated transmission with a C-UL MU MIMO scheme.

In some embodiments, as shown in FIG. 23, the coordinated TX scheme adopted field includes at least one of:
a C-BF adopted field, to indicate whether the multi-AP coordinated transmission with the C-BF scheme is adopted;
a C-OFDMA adopted field, to indicate whether the multi-AP coordinated transmission with the C-OFDMA scheme is adopted;
a C-SR adopted field, to indicate whether the multi-AP coordinated transmission with the C-SR scheme is adopted;
a J-TX adopted field, to indicate whether the multi-AP coordinated transmission with the J-TX scheme is adopted; or
a C-UL MU MIMO adopted field, to indicate whether the multi-AP coordinated transmission with the C-UL MU MIMO scheme is adopted.

Optionally, the binary value of the C-BF adopted field being 1, indicates to perform the multi-AP coordinated transmission with the C-BF scheme, in this case, the first frame includes the C-BF Parameters field. The binary value of the C-BF adopted field being 0, indicates not to perform the multi-AP coordinated transmission with the C-BF scheme, in this case, the first frame does not include the C-BF Parameters field.

Optionally, the binary value of the C-OFDMA adopted field being 1, indicates to perform the multi-AP coordinated transmission with the C-OFDMA scheme, in this case, the first frame includes the C-OFDMA Parameters field. The binary value of the C-OFDMA adopted field being 0, indicates not to perform the multi-AP coordinated transmission with the C-OFDMA scheme, in this case, the first frame does not include the C-OFDMA Parameters field.

Optionally, the binary value of the C-SR adopted field being 1, indicates to perform the multi-AP coordinated transmission with the C-SR scheme, in this case, the first frame includes the C-SR Parameters field. The binary value of the C-SR adopted field being 0, indicates not to perform the multi-AP coordinated transmission with the C-SR scheme, in this case, the first frame does not include the C-SR Parameters field.

Optionally, the binary value of the J-TX adopted field being 1, indicates to perform the multi-AP coordinated transmission with the J-TX scheme, in this case, the first frame includes the J-TX Parameters field. The binary value of the J-TX adopted field being 0, indicates not to perform the multi-AP coordinated transmission with the J-TX scheme, in this case, the first frame does not include the J-TX Parameters field.

Optionally, the binary value of the C-UL MU-MIMO adopted field being 1, indicates to perform the multi-AP coordinated transmission with the C-UL MU-MIMO scheme, in this case, the first frame includes the C-UL MU-MIMO Parameters field. The binary value of the C-UL MU-MIMO adopted field being 0, indicates not to perform the multi-AP coordinated transmission with the C-UL MU-MIMO scheme, in this case, the first frame does not include the C-UL MU-MIMO Parameters field.

In some embodiments, as shown in FIG. 24, the C-BF parameter field includes at least one of:
an AP number (Number of APs) field, to indicate the number of APs included in the coordinated transmission announce frame;
at least one AP ID field, to indicate APs participating in the multi-AP coordinated transmission with the C-BF scheme; or
at least one steering matrix field, where each steering matrix field corresponds to an AP indicated by the at least one AP ID field, and the steering matrix field is used to indicate the steering matrix adopted by a corresponding AP to perform the multi-AP coordinated transmission with the C-BF scheme.

In some embodiments, as shown in FIG. 24, the at least one AP ID field may include a first AP ID (i.e., 1^{st} AP ID) field, . . . , an m^{th} AP ID (i.e., m^{th} AP ID) field, etc., the first AP ID (1st AP ID) field indicates an ID of the first AP participating in C-BF, and the m^{th} AP ID indicates an ID of the m^{th} AP participating in C-BF.

In some embodiments, as shown in FIG. 24, the at least one steering matrix field may include a first AP's steering matrix (TX Matrix for 1^{st} AP) field, . . . , a m^{th} AP's steering matrix (TX Matrix for m^{th} AP) field, etc., the TX Matrix for 1^{st} AP field indicates a steering matrix corresponding to the 1^{st} AP participating in C-BF, and the TX Matrix for m^{th} AP indicates a steering matrix corresponding to the m^{th} AP participating in C-BF.

In some embodiments of the present application, for each of the APs participating in C-BF, the steering matrix corresponding to the AP may also be calculated by a master AP.

In some embodiments, for each of the APs participating in C-BF, the sharing AP, after determining the target CSI, transmits the target CSI to the master AP, and the master AP calculates the steering matrix corresponding to the AP according to the target CSI. The specific calculation method refers to the relevant description of the aforementioned embodiments, which will not be repeated here for the sake of brevity.

In some other embodiments, the sharing AP may transmit candidate CSI and the target information for calculating the target CSI to the master AP, and for each of the APs participating in C-BF, the master AP calculates the steering matrix corresponding to the AP according to the candidate CSI and the target information.

For example, after collecting the CSI information fed back by the shared APs completely, the sharing AP may transmit the collected CSI to the master AP.

Optionally, if the sharing AP also participates in C-BF, the sharing AP may also transmit the CSI obtained by the sharing AP to the master AP. For example, CSI between the sharing AP and its associated STAs participating in C-BF and CSI between the sharing AP and the non-associated OBSS STAs are transmitted to the master AP.

That is, the sharing AP may transmit the target CSI to the master AP, or may transmit the candidate CSI and the target information to the master AP.

In some embodiments, there is a wired connection between the sharing AP and the master AP, and the target CSI or the candidate CSI may be transmitted via the wired connection.

In some embodiments, there is a wireless connection between the sharing AP and the master AP, and the target CSI or the candidate CSI may be transmitted via the wireless connection.

In some embodiments, the candidate CSI and the target information may be transmitted by a third request frame.

In some embodiments, the third request frame may be used to carry the target CSI.

In some embodiments, the third request frame is also referred to as a coordinated transmission matrix request (Coordinated TX Matrix Request) frame, or other similar names are adopted, which are not limited to the present application.

In some embodiments, the candidate CSI may include first CSI obtained from the shared APs (the sharing AP does not participate in C-BF), or include the first CSI obtained from the shared APs and CSI obtained by the sharing AP (the sharing AP participates in C-BF), for example, CSI between the sharing AP and its associated STAs participating in C-BF and CSI between the sharing AP and the non-associated OBSS STAs.

In some embodiments, an indicating method of the target information refers to the relevant description of the aforementioned embodiments, which will not be repeated here for the sake of brevity.

In some embodiments, the master AP removes the following CSI among the candidate CSI according to the target information, to obtain the target CSI:
CSI between the first-type AP and a second-type STA associated with the first-type AP;
CSI between the first-type AP and an STA associated with a second-type AP.

In some embodiments, the master AP, after calculating the steering matrix corresponding to each first-type AP according to the target CSI, may transmit the steering matrix corresponding to each first-type AP to the sharing AP.

In some embodiments, there is a wired connection between the sharing AP and the master AP, and the steering matrix corresponding to each first-type AP may be transmitted via the wired connection.

In some embodiments, there is a wireless connection between the sharing AP and the master AP, and the steering matrix corresponding to each first-type AP may be transmitted via the wireless connection.

Furthermore, the sharing AP may transmit the steering matrix corresponding to each first-type AP to the each first-type AP, for example, by transmitting the steering matrix corresponding to each first-type AP to the each first-type AP by the aforementioned first announce frame.

In some embodiments, the master AP may carry the steering matrix corresponding to each first-type AP calculated by the master AP, through a third response frame.

In some embodiments, the third response frame is also referred to as a coordinated transmission matrix response (Coordinated TX Matrix Response) frame, or other similar names are adopted, which are not limited to the present application.

In some other embodiments, the master AP, after calculating the steering matrix corresponding to each first-type AP according to the target CSI, may transmit the steering matrix corresponding to each first-type AP to the each first-type AP.

In some embodiments, there is a wired connection between the shared APs and the master AP, and the steering matrix corresponding to each first-type AP may be transmitted via the wired connection.

In some embodiments, there is a wireless connection between the shared APs and the master AP, and the steering matrix corresponding to each first-type AP may be transmitted via the wireless connection.

In some embodiments, the master AP may transmit the steering matrix corresponding to each first-type AP to the each first-type AP, through a second announce frame. Herein, the second announce frame may be designed with a frame format similar to that of the first announce frame, which will not repeated here.

In some embodiments, the second announce frame may be a coordinated transmission trigger frame.

For example, the master AP, after calculating the steering matrix corresponding to each first-type AP according to the target CSI, may announce each steering matrix participating in C-BF to each AP participating in C-BF, during the coordinated transmission phase. In this case, during the preparation phase, the master AP may not transmit the coordinated transmission announce frame. For example, the master AP may carry each steering matrix participating in C-BF in the coordinated transmission trigger frame. Further, each of the shared APs participating in C-BF may perform the data transmission according to its corresponding steering matrix. That is, the steps of the coordinated transmission announce and the response (optional) are omitted.

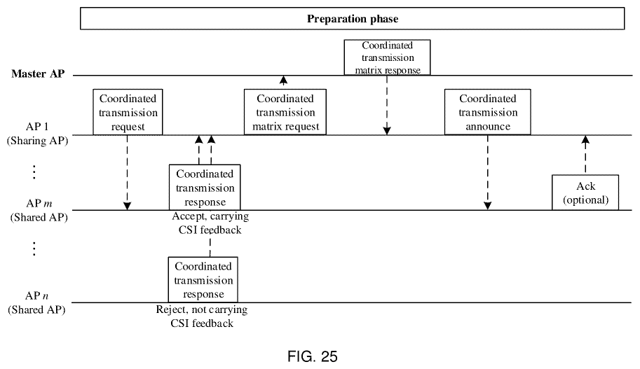

Interaction schemes of the coordinated transmission matrix request frame, the coordinated transmission response frame, and the coordinated transmission announce frame are described in conjunction with FIG. 25 to FIG. 32, taking an example in which the sharing AP is an AP1, and the shared APs include an AP m and an AP n.

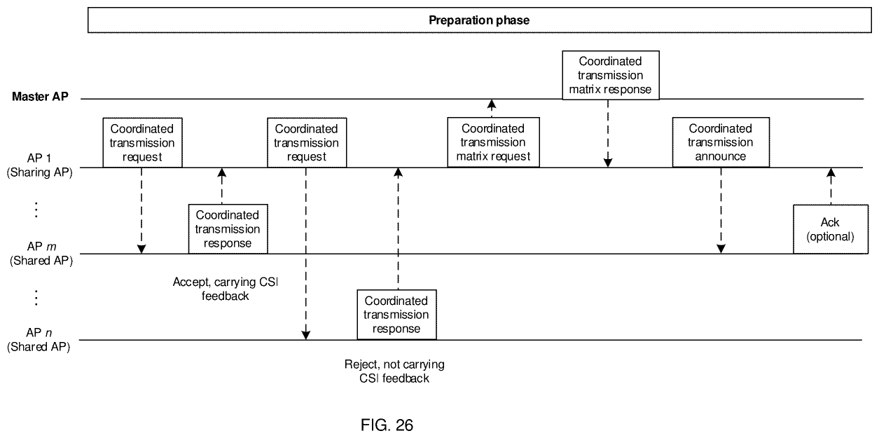

In FIG. 25 and FIG. 26, the sharing AP at one time collects the CSI information obtained by the shared APs by the coordinated transmission response frame. The difference between FIG. 25 and FIG. 26 is that the shared APs synchronously and asynchronously reply with the coordinated transmission response frame.

Optionally, in FIG. 25 and FIG. 26, the sharing AP may also in steps collect the CSI information obtained by the shared APs. Specific interaction schemes refer to relevant descriptions of the embodiments shown in FIG. 7 and FIG. 8, which will not be repeated here for the sake of brevity.

Further, as shown in FIG. 25 and FIG. 26, the sharing AP, after collecting the CSI information of the shared APs, may transmit the coordinated transmission matrix request frame to the master AP, to request the master AP to calculate the steering matrixes each corresponding to a respective one of the APs participating in C-BF.

Optionally, the coordinated transmission matrix request frame may carry the collected CSI and the aforementioned target information, the master AP determines the target CSI among the collected CSI according to the target information, and then, for each of the APs participating in C-BF, determines the steering matrixes corresponding to the AP based on the target CSI.

Optionally, the coordinated transmission matrix request frame may carry the target CSI, and for each of the APs participating in C-BF, the master AP may directly determine the steering matrix corresponding to the AP according to the target CSI.

The master AP, after calculating the steering matrix corresponding to each AP participating in C-BF, may transmit the steering matrix corresponding to each AP participating in C-BF to the sharing AP.

For example, the AP m participates in C-BF, and the master AP may transmit the coordinated transmission matrix response frame to the sharing AP, and the coordinated transmission response frame includes the steering matrix corresponding to the AP m.

Furthermore, for each of the APs participating in C-BF, the sharing AP may transmit the coordinated transmission announce frame to the AP participating in C-BF, to inform the steering matrix corresponding to the AP to the AP. For example, the sharing AP transmits the coordinated transmission announce frame to the AP m, to indicate the steering matrix corresponding to the AP m.

Optionally, a shared AP that receives the coordinated transmission announce frame may confirm the coordinated transmission announce frame transmitted by the sharing AP by an acknowledgment (Ack) frame, or the shared AP may not transmit the Ack frame, and by default, accept the coordinated transmission announce frame transmitted by the sharing AP.

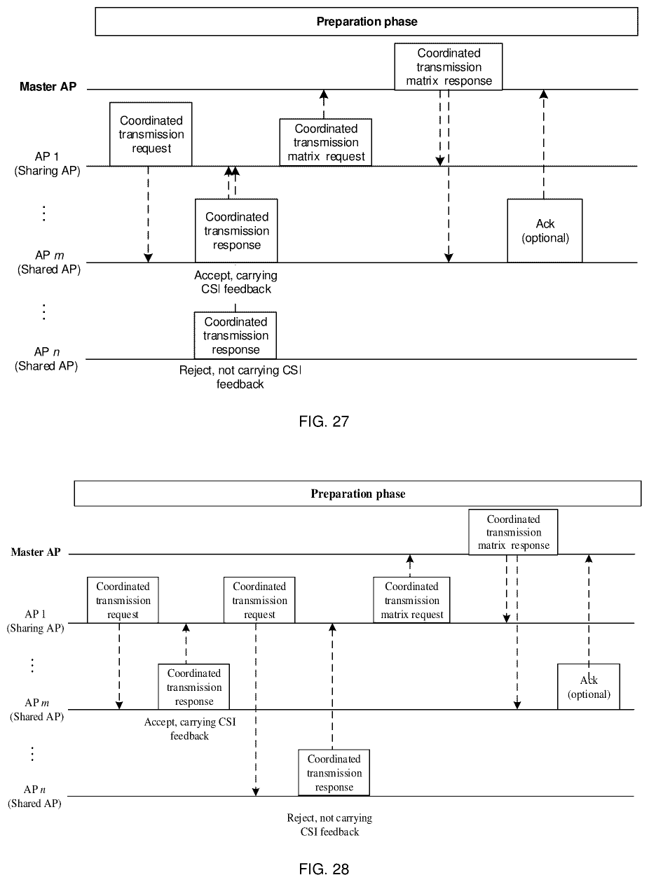

In FIG. 27 and FIG. 28, the sharing AP at one time collects the CSI information obtained by the shared APs by the coordinated transmission response frame. The difference between FIG. 27 and FIG. 28 is that, the shared APs synchronously and asynchronously reply with the coordinated transmission response frame.

Optionally, in FIG. 27 and FIG. 28, the sharing AP may also in steps collect the CSI information obtained by the shared APs. Specific interaction schemes refer to relevant descriptions of the embodiments shown in FIG. 7 and FIG. 8, which will not be repeated here for the sake of brevity.

The difference between FIG. 27 and FIG. 28, and FIG. 25 and FIG. 26 is that: after the master AP calculates the steering matrix corresponding to each AP participating in C-BF, the master AP may directly transmit the steering matrix corresponding to each AP participating in C-BF to the AP participating in C-BF, by the coordinated transmission matrix response frame. That is, the steps in which the master AP first transmits the steering matrix corresponding to each AP participating in C-BF to the sharing AP by the coordinated transmission matrix response frame are omitted, but the master AP directly announces the calculated steering matrix.

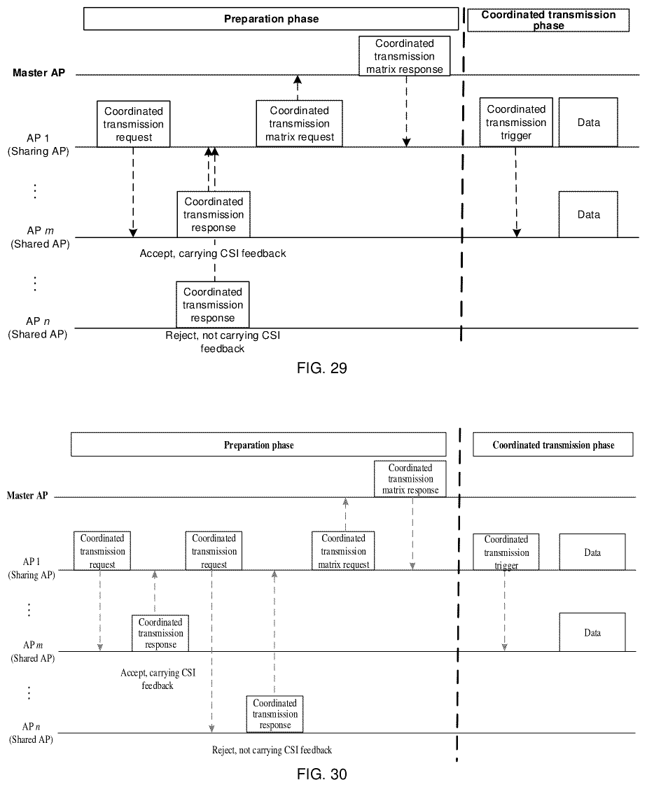

In FIG. 29 and FIG. 30, the sharing AP at one time collects the CSI information obtained by the shared APs by the coordinated transmission response frame. The difference between FIG. 29 and FIG. 30 is that, the shared APs synchronously and asynchronously reply with the coordinated transmission response frame.

Optionally, in FIG. 29 and FIG. 30, the sharing AP may also in steps collect the CSI information obtained by the shared APs. Specific interaction schemes refer to relevant descriptions of the embodiments shown in FIG. 7 and FIG. 8, which will not be repeated here for the sake of brevity.

The difference between FIG. 29 and FIG. 30, and FIG. 25 and FIG. 26 is that: after the sharing AP is aware of the steering matrix corresponding to each AP participating in C-BF by the coordinated transmission matrix response frame, the sharing AP may transmit the steering matrix corresponding to each AP participating in C-BF to the each AP participating in C-BF, during the coordinated transmission phase. That is, the steps in which the sharing AP transmits the coordinated transmission announce and the sharing AP replies the response (optional) are omitted.

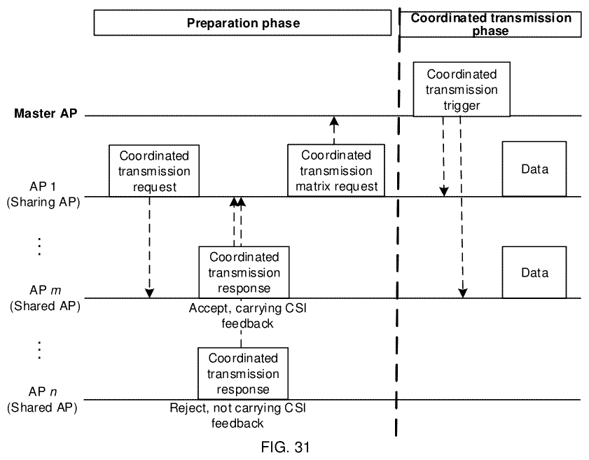

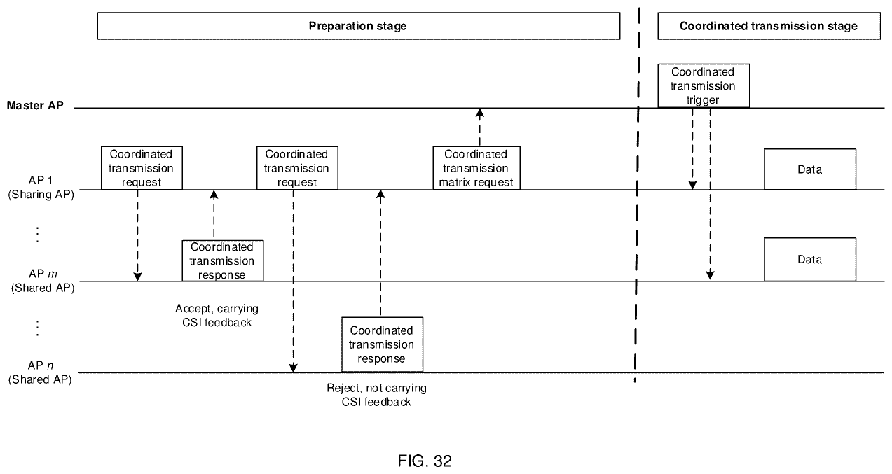

In FIG. 31 and FIG. 32, the sharing AP at one time collects the CSI information obtained by the shared APs by the coordinated transmission response frame. The difference between FIG. 31 and FIG. 32 is that, the shared APs synchronously and asynchronously reply with the coordinated transmission response frame.

Optionally, in FIG. 31 and FIG. 32, the sharing AP may also in steps collect the CSI information obtained by the shared APs. Specific interaction schemes refer to relevant descriptions of the embodiments shown in FIG. 7 and FIG. 8, which will not be repeated here for the sake of brevity.

The difference between FIG. 31 and FIG. 32, and FIG. 29 and FIG. 30 is that: after the master AP calculates the steering matrix corresponding to each AP participating in C-BF, the master AP may announce the steering corresponding to each AP participating in C-BF during the coordinated transmission phase, for example, by carrying the steering matrix corresponding to each AP participating in C-BF by the coordinated transmission trigger frame. That is, the steps of the coordinated transmission matrix response frame, the coordinated transmission notification frame and the shared APs replying the response (optional) in the preparation phase are omitted.

That is, in FIG. 31 and FIG. 32, the coordinated transmission announce frame and the coordinated transmission trigger frame are combined.

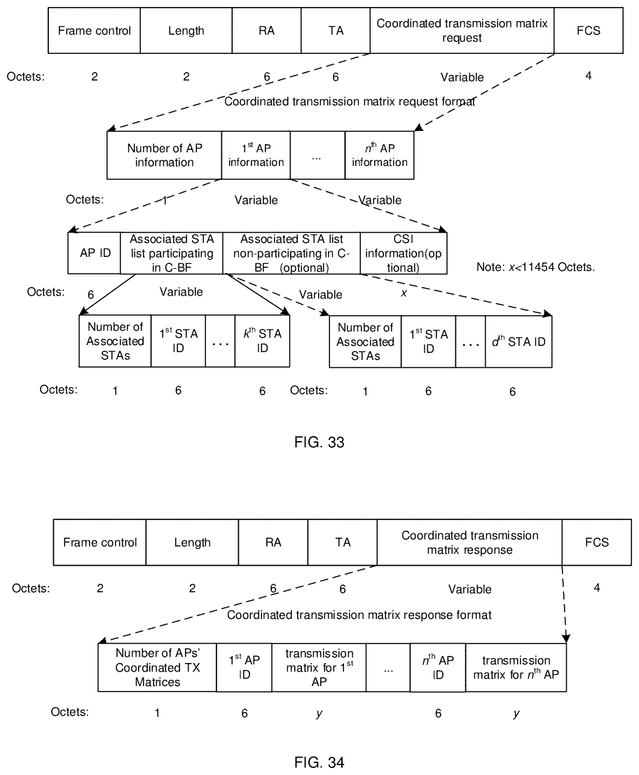

Frame structure designs of the coordinated transmission matrix request frame and the coordinated transmission matrix response frame are described below in conjunction with FIG. 33 and FIG. 34.

It should be understood that the information carried in frame formats and a location and size of each field in frame formats shown in FIG. 33 and FIG. 34 are only examples, which may be flexibly adjusted according to actual needs or the carried information, which are not limited to the present application.

FIG. 33 is a schematic diagram of a frame format of a coordinated transmission matrix request frame, provided by the embodiments of the present application, which may include the following domains (or fields):
frame control (occupying 2 bytes), duration (occupying 2 bytes), receiving address (RA) (occupying 6 bytes), transmission address (TA) (occupying 6 bytes), coordinated transmission matrix request (occupying a variable number of bytes), FCS (occupying 4 bytes).

In some embodiments, the coordinated steering matrix request field includes at least one of:
an AP information number field, to indicate the number of AP information carried by the coordinated transmission matrix request frame; or
at least one AP information (APs' Info) field, to indicate information of APs participating in the multi-AP coordinated transmission with the C-BF scheme.

In some embodiments, as shown in FIG. 33, the AP information field includes at least one of:
an AP ID field, to indicate an AP participating in the multi-AP coordinated transmission with the C-BF scheme;
an associated STA list participating in C-BF field, to indicate STAs participating in the multi-AP coordinated transmission with the C-BF scheme and associated with the AP indicated by the AP ID;
an associated STA list non-participating in C-BF field, to indicate STAs not participating in the multi-AP coordinated transmission with the C-BF scheme and associated with the AP indicated by the AP ID field; or
a CSI information field, to indicate CSI obtained by an AP indicated by the AP ID field.

In some embodiments, the CSI information field is used to indicate the first-type CSI and/or the second-type CSI obtained by the AP indicated by the AP ID field. That is, all the CSI carried by the CSI information field is valid CSI. In this case, the AP information field may not include the associated STA list participating in C-BF field and the associated STA list non-participating in C-BF field, that is, the master AP does not need to remove the invalid CSI.

In some embodiments, the CSI carried by the CSI information field includes valid CSI and invalid CSI.

For example, the CSI information field is used to indicate the first-type CSI and/or the CSI between the AP and the non-associated OBSS STAs, obtained by the AP indicated by the AP ID field.

In this case, the AP information field may include the associated STA list participating in C-BF field and/or the associated STA list non-participating in C-BF field. The master AP may remove the invalid CSI according to the participation of the STA, to obtain the target CSI.

In some embodiments, as shown in FIG. 33, the associated STA list participating in C-BF field (Associated STA List for C-BF subfield) includes at least one of:
an associated STA number (Number of Associated STAs) field, to indicate the number of STAs participating in C-BF associated with the AP; or
at least one STA ID field, where a k^{th} STA ID is used to indicate an ID of the k^{th} STA participating in C-BF associated with the second AP.

In some embodiments, as shown in FIG. 33, the associated STA list non-participating in C-BF field (Associated STA List for no C-BF subfield) includes at least one of:
an associated STA number (Number of Associated STAs) field, to indicate the number of STAs not participating in C-BF associated with the AP; or
at least one STA ID field, where a d^{th} STA ID is used to indicate an ID of the d^{th} STA not participating in C-BF associated with the AP.

In some embodiments, a length x of the CSI Information field satisfies that the coordinated transmission matrix request frame does not exceed 11454 bytes, otherwise, the coordinated transmission matrix request frame needs to be segmented.

FIG. 34 is a schematic diagram of a frame format of a coordinated transmission matrix response frame, provided by the embodiments of the present application, which may include the following domains (or fields):
frame control (occupying 2 bytes), duration (occupying 2 bytes), RA (occupying 6 bytes), TA (occupying 6 bytes), coordinated transmission matrix response (Coordinated TX Matrix Response) (occupying a variable number of bytes), FCS (occupying 4 bytes).

In some embodiments, the coordinated steering matrix response field includes at least one of:
a steering matrix number (Number of APs' TX Matrix) field, used to indicate the number of steering matrices of APs carried by the coordinated steering matrix response frame;
at least one AP ID field, to indicate APs participating in the multi-AP coordinated transmission with the C-BF scheme, where n^{th} AP ID represents an ID of the n^{th} AP; or
at least one steering matrix field, where each steering matrix field corresponds to an AP indicated by the at least one AP ID field, and the steering matrix field is used to indicate a steering matrix adopted by a corresponding AP to perform the multi-AP coordinated transmission with the C-BF scheme.

In some embodiments, as shown in FIG. 34, the at least one AP ID field may include a first AP ID (1^{st} AP ID) field, . . . , an m-th AP ID (m^{th} AP ID) field, etc., the first AP ID (1^{st} AP ID) field indicates an ID of the first AP participating in C-BF, and the m^{th} AP ID indicates an ID of the m^{th} AP participating in C-BF.

In some embodiments, as shown in FIG. 34, the at least one steering matrix field may include a steering matrix for the first AP (TX Matrix for 1^{st} AP) field, . . . , a steering matrix used for the m^{th} AP (TX Matrix for m^{th} AP) field, etc., the TX Matrix for 1^{st} AP field indicates the steering matrix corresponding to the first AP participating in C-BF, and the TX Matrix for m^{th} AP indicates the steering matrix corresponding to the m^{th} AP participating in C-BF.

In some embodiments of the present application, the sharing AP and the shared APs may also report the CSI information to the MAP. Further, the steering matrix is calculated by the MAP.

For example, in a case where the shared APs and the MAP, as well as the sharing AP and the MAP are connected via wired backhaul, the shared APs and the sharing AP may transmit the CSI information to the MAP via the wired backhaul.

For another example, in a case where the shared APs and the MAP, as well as the sharing AP and the MAP are connected via wireless backhaul, the shared APs and the sharing AP may transmit the CSI information to the MAP via the wireless backhaul.

In some embodiments, the shared APs may report all CSI (including the valid CSI and the invalid CSI) obtained by the channel sounding to the MAP, or may report the first-type CSI and the CSI between the shared APs and the non-associated OBSS STAs obtained by the shared APs, to the MAP.

In some embodiments, the sharing AP may report all CSI (including valid CSI and invalid CSI) obtained through the channel sounding to the MAP, or may report the obtained first-type CSI and CSI between the shared APs and the non-associated OBSS STAs to the MAP.

In some embodiments, the sharing AP may also report participation information of the sharing AP in C-BF and participation information of its associated STA in C-BF to the MAP.

For example, in a case where the sharing AP and the MAP are connected via a wired backhaul, the sharing AP may report the participation information of the sharing AP in C-BF and the participation information of its associated STA in C-BF to the MAP via the wired backhaul.

For another example, in a case where the sharing AP and the MAP are connected via a wireless backhaul, the sharing AP may report the participation information of the sharing AP in C-BF and the participation information of its associated STA in C-BF to the MAP via the wireless backhaul.

In some embodiments, the shared APs may also report participation information of the shared APs in C-BF and participation information of their associated STAs in C-BF to the MAP.

For example, in a case where the non-shared APs and the MAP are connected via a wired backhaul, the shared APs may report the participation information of the shared APs in C-BF and the participation information of their associated STAs in C-BF to the MAP via the wired backhaul.

For another example, in a case where the shared APs and the MAP are connected via a wireless backhaul, the shared APs may report the participation information of the shared APs in C-BF and the participation information of its associated STAs in C-BF to the MAP via the wireless backhaul.

Further, the MAP may calculate the steering matrix corresponding to each AP participating in C-BF according to the obtained CSI information in conjunction with the above-mentioned participation information. The specific calculation method refers to the relevant description of the aforementioned embodiments, which will not be repeated here.

In some embodiments, the MAP, after calculating the steering matrix corresponding to each AP participating in C-BF (also including the sharing AP, when the sharing AP also participates in C-BF), may transmit the steering matrix corresponding to each AP participating in C-BF to each AP participating in C-BF.

For example, in a case where the AP participating in C-BF and the MAP are connected via a wired backhaul, the MAP may transmit the steering matrix corresponding to each AP participating in C-BF to each AP participating in C-BF via the wired backhaul.

For another example, in a case where the AP participating in C-BF and the MAP are connected via a wireless backhaul, the MAP may transmit the steering matrix corresponding to each AP participating in C-BF to each AP participating in C-BF via the wireless backhaul.

In some other embodiments, the MAP, after calculating the steering matrix corresponding to each AP participating in C-BF (also including the sharing AP, when the sharing AP also participates in C-BF), may transmit the steering matrix corresponding to each AP participating in C-BF to the sharing AP.

For example, in a case where the sharing AP and the MAP are connected via a wired backhaul, the MAP may transmit the steering matrix corresponding to each AP participating in C-BF to the sharing AP via the wired backhaul.

For another example, in a case where the sharing AP and the MAP are connected via a wireless backhaul, the MAP may transmit the steering matrix corresponding to each AP participating in C-BF to the sharing AP via the wireless backhaul.

In some embodiments, the sharing AP may transmit the steering matrix corresponding to each shared AP participating in C-BF (the steering matrix may be calculated by the sharing AP or by the MAP) to the shared APs participating in C-BF.

For example, in a case where the sharing AP and the shared APs are connected via a wired backhaul, the sharing AP may transmit the steering matrix corresponding to each shared APs participating in C-BF to each shared AP participating in C-BF via the wired backhaul.

For another example, in a case where the sharing AP and the shared APs are connected via a wireless backhaul, the sharing AP may transmit the steering matrix corresponding to each shared AP participating in C-BF to each shared AP participating in C-BF via the wireless backhaul.

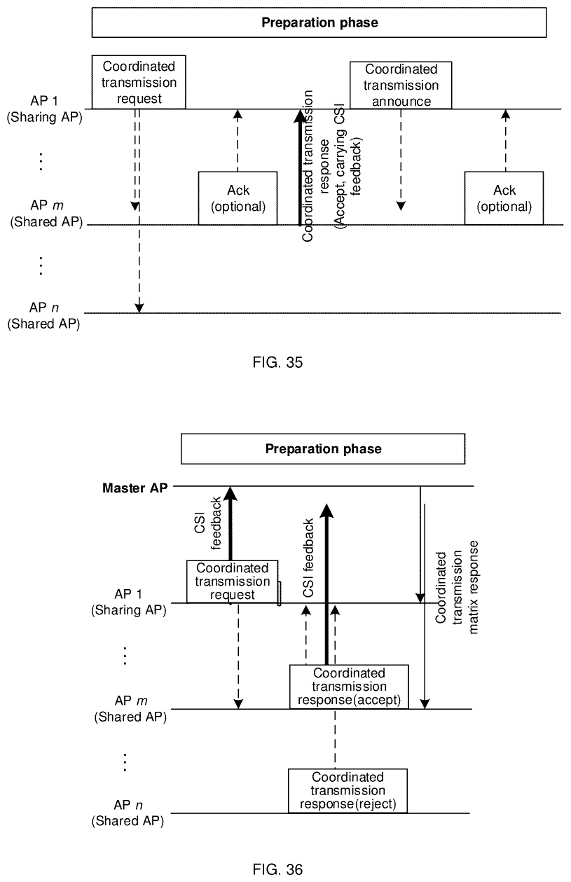

FIG. 35 shows a schematic diagram of the interaction of the CSI and the steering matrix when the sharing AP and the shared APs are connected via a wired backhaul. For example, the following steps may be included.

First, the sharing AP transmits a coordinated transmission request frame to each shared AP, to inquire whether the shared AP participates in C-BF.

Each shared AP that receives the coordinated transmission request frame may reply with an Ack frame, to confirm the coordinated transmission request frame transmitted by the sharing AP, or may not reply with the Ack frame.

Then, the shared APs participating in C-BF transmit the aforementioned first information and first CSI to the sharing AP via a wired signaling.

The sharing AP calculates the steering matrix of each AP participating in C-BF according to the CSI information collected via the wired signaling, and then transmits the steering matrix to each AP participating in C-BF via a wireless signaling. Alternatively, the sharing AP may also transmit the calculated steering matrix to each AP participating in C-BF via a wired signaling. Herein, contents included in the wireless signaling and the wired signaling refer to the frame structure design of the aforementioned coordinated transmission announce frame, which will not be repeated here.

That is, the sharing AP may collect the CSI information obtained by the shared APs via the wired signaling, and may transmit the corresponding steering matrix to the shared APs participating in C-BF via the wired signaling, which is conducive to reducing wireless signaling overhead.

FIG. 36 shows a schematic diagram of the interaction of the CSI and the steering matrix, when the sharing AP and the master AP, and the master AP and the shared APs are connected via a wired backhaul, which may include, for example, the following steps.

First, the sharing AP transmits a coordinated transmission request frame to each shared AP, to inquire whether the shared AP participates in C-BF, or, the sharing AP may also transmit its obtained CSI and participation information of its associated STAs to the master AP via the wired signaling.

Each shared AP replies with the coordinated transmission response frame to the sharing AP, to inform whether the shared AP participates in C-BF and/or a list of associated STAs participating in C-BF, or, the shared APs participating in C-BF may also transmit its obtained CSI and participation information of its associated STAs to the master AP via the wired signaling.

The master AP calculates the steering matrix of each AP participating in C-BF according to the information collected via the wired signaling, and then may transmit the steering matrix of each AP participating in C-BF to each AP participating in C-BF via the wired signaling.

That is, both the shared APs and the sharing AP may transmit the CSI information to the MAP via the wired signaling. The MAP, after calculating the steering matrix according to the CSI information, may transmit the corresponding steering matrix to the AP participating in C-BF via the wired signaling, which is conducive to reducing wireless signaling overhead.

It should be understood that the information interaction methods and the interacted contents between the sharing AP, the shared APs and the master AP in FIG. 35 and FIG. 36 are only examples, but the present application is not limited thereto. The interaction methods via the wired connection in FIG. 35 and FIG. 36 may also be applicable for other scenarios in the aforementioned embodiments, which are not limited to the present application.

In summary, the sharing AP may collect the participation of the shared APs of the multi-AP coordinated set and its associated STAs in the multi-AP coordinated transmission with C-BF, as well as the CSI information obtained by the shared APs, and further, determine the target CSI according to the participation information and the obtained CSI information, and then, for each of the APs participating in C-BF, calculate the steering matrix corresponding to the AP based on the target CSI. Specifically, the sharing AP, when calculating the steering matrix, only considers the CSI between the AP participating in the multi-AP coordinated transmission with C-BF and the STA. Therefore, performing the multi-AP coordinated transmission based on the steering matrix is conductive to the AP to transmit useful signals to the target STA and transmit nulls to the OBSS STAs, thereby reducing interference and improving transmission performance.

In some embodiments, when a processing capability of the sharing AP is insufficient, the sharing AP may transmit the obtained CSI information to the master AP and the master AP calculates the steering matrix. Optionally, after the master AP calculates the steering matrix, the master AP may transmit the steering matrix to the sharing AP, and the sharing AP transmits the steering matrix to the APs participating in C-BF, or, the master AP may directly transmit the calculated steering matrix to the APs participating in C-BF.

In some embodiments, the sharing AP may transmit the steering matrix to the APs participating in C-BF during the preparation phase, or may transmit the steering matrix to the APs participating in C-BF during the coordinated transmission phase, for example, by transmitting the steering matrix to the APs participating in C-BF by a coordinated transmission trigger frame.

In some embodiments, the master AP may transmit the steering matrix to the APs participating in C-BF during the preparation phase, or may transmit the steering matrix to the APs participating in C-BF during the coordinated transmission phase, for example, by transmitting the steering matrix to the APs participating in C-BF by a coordinated transmission trigger frame.

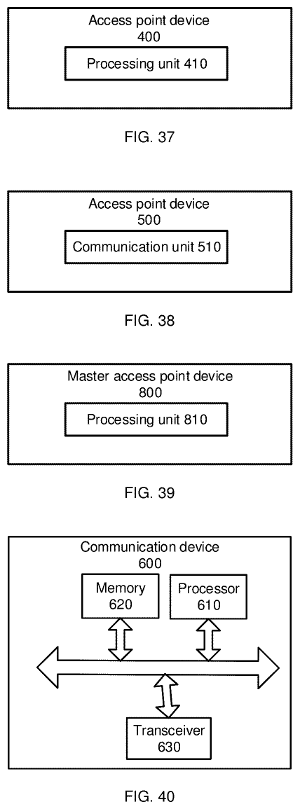

The method embodiments of the present application are described in detail above with reference to FIG. 6 to FIG. 36, and apparatus embodiments of the present application are described in detail below with reference to FIG. 37 to FIG. 42, and it should be understood that the apparatus embodiments and the method embodiments correspond to each other and the similar description may refer to the method embodiments.

FIG. 37 shows a schematic block diagram of an access point device 400, according to the embodiments of the present application. As shown in FIG. 19, the access point device 400 includes:
a processing unit 410, configured to acquire target channel state information (CSI), where the target CSI includes CSI between a first-type AP and a first-type station (STA), where the first-type AP is an AP participating in a multi-AP coordinated transmission with a coordinated beamforming (C-BF) scheme in a multi-AP coordinated set, the first-type STA is an STA participating in the multi-AP coordinated transmission with the C-BF scheme, the target CSI is used to calculate a steering matrix corresponding to each first-type AP in the multi-AP coordinated set, and the steering matrix corresponding to the first-type AP is used by the first-type AP to perform the multi-AP coordinated transmission with the C-BF scheme.

In some embodiments, the target CSI includes first-type CSI and/or second-type CSI, where the first-type CSI includes CSI between the first-type AP and the first-type STA associated with the first-type AP, and the second-type CSI includes CSI between the first-type AP and the first-type STA in an overlapping basic service set (OBSS) of the first-type AP.

In some embodiments, the access point device is a sharing AP, and the target CSI is determined according to CSI acquired by the sharing AP from at least one shared AP and/or CSI acquired by the sharing AP through channel sounding.

In some embodiments, the CSI acquired by the sharing AP from the at least one shared AP is acquired by the sharing AP from the at least one shared AP via a wired connection; or
the CSI acquired by the sharing AP from the at least one shared AP is acquired by the sharing AP from the at least one shared AP via a wireless connection.

In some embodiments, the access point device 400 includes:
a communication unit, configured to transmit a first request frame to at least one second access point device in the multi-AP coordinated set, where the first request frame is used to request the at least one second access point device to participate in the multi-AP coordinated transmission with the C-BF scheme.

In some embodiments, the first request frame is transmitted by broadcasting, multicasting, or unicasting.

In some embodiments, the first request frame includes at least one of:
first indication information, to indicate a coordinated transmission scheme requested to be used;
second indication information, to indicate whether to feed back the first-type CSI obtained by the second access point device; or
third indication information, to indicate whether to feed back CSI between the second access point device and an OBSS STAs of the second access point device, obtained by the second access point device.

In some embodiments, the first request frame includes a coordinated transmission request field, and the coordinated transmission request field includes at least one of:
a coordinated transmission scheme used field, to indicate a coordinated transmission scheme requested to be used;
a C-BF command field, to indicate a command used when the multi-AP coordinated transmission with the C-BF scheme is adopted;
a coordinated orthogonal frequency division multiple access (C-OFDMA) command field, to indicate a command used when the multi-AP coordinated transmission with a C-OFDMA scheme is adopted;
a coordinated spatial reuse (C-SR) command field, to indicate a command used when the multi-AP coordinated transmission with a C-SR scheme is adopted;
a joint transmission (J-TX) command field, to indicate a command used when the multi-AP coordinated transmission with a J-TX scheme is adopted; or
a coordinated uplink multiple user multiple input multiple output (C-UL MU MIMO) command field, to indicate a command used when the multi-AP coordinated transmission with a C-UL MU MIMO scheme is adopted.

In some embodiments, the C-BF command field includes at least one of:
a reporting associated STA's CSI field, to indicate whether to feed back the first-type CSI obtained by the second access point device; or
a reporting OBSS STA's CSI field, to indicate whether to feed back CSI between the second access point device and an OBSS STAs of the second access point device, obtained by the second access point device.

In some embodiments, the coordinated transmission scheme used field includes at least one of:
a C-BF used field, to indicate whether to request to use the multi-AP coordinated transmission with the C-BF scheme;
a C-OFDMA used field, to indicate whether the access point device requests to use the multi-AP coordinated transmission with the C-OFDMA scheme;
a C-SR used field, to indicate whether the access point device requests to use the multi-AP coordinated transmission with the C-SR scheme;
a J-TX used field, to indicate whether the access point device requests to use the multi-AP coordinated transmission with the J-TX scheme; or
a C-UL MU MIMO used field, to indicate whether the access point device requests to use the multi-AP coordinated transmission with the C-UL MU MIMO scheme.

In some embodiments, the access point device 400 further includes:
a communication unit, configured to receive a first response frame transmitted by the at least one second access point device, where the first response frame is used to indicate whether the second access point device accepts to participate in the multi-AP coordinated transmission with the C-BF scheme.

In some embodiments, the first response frame is transmitted synchronously or asynchronously by the at least one second access point device.

In some embodiments, the first response frame includes at least one of:
fourth indication information, to indicate whether the second access point device accepts a coordinated transmission scheme requested to be used;
a list of associated STAs participating in C-BF, including STAs associated with the second access point device and participating in the multi-AP coordinated transmission with the C-BF scheme;
a list of associated STAs not participating in C-BF, including STAs associated with the second access point device and not participating in the multi-AP coordinated transmission with the C-BF scheme; or
at least one CSI, including the first-type CSI obtained by the second access point device and/or CSI between the second access point device and an OBSS STAs of the second access point device obtained by the second access point device.

In some embodiments, the first response frame includes a coordinated transmission response field, and the coordinated transmission response field includes at least one of:
a coordinated transmission scheme accept field, to indicate a coordinated transmission scheme accepted by the second access point device;
a C-BF information field, to indicate information related to the second access point device with C-BF;
a C-OFDMA information field, to indicate information related to the second access point device with C-OFDMA;
a C-SR information field, to indicate information related to the second access point device with C-SR;
a J-TX information field, to indicate information related to the second access point device with J-TX; or
a C-UL MU MIMO information field, to indicate information related to the second access point device with C-UL MU MIMO.

In some embodiments, the C-BF information field includes at least one of:
an associated STA list participating in C-BF field, to indicate STAs associated with the second access point device participating in the multi-AP coordinated transmission with the C-BF scheme;
an associated STA list non-participating in C-BF field, to indicate STAs associated with the second access point device not participating in the multi-AP coordinated transmission with the C-BF scheme; or
a CSI information field, to indicate the first-type CSI obtained by the second access point device and/or CSI between the second access point device and an OBSS STA of the second access point device obtained by the second access point device.

In some embodiments, the coordinated transmission scheme accept field includes at least one of:
a C-BF accept field, to indicate whether the second access point device accepts a coordinated transmission with the C-BF scheme;
a C-OFDMA accept field, to indicate whether the second access point device accepts a coordinated transmission with a C-OFDMA scheme;
a C-SR accept field, to indicate whether the second access point device accepts a coordinated transmission with a C-SR scheme;
a J-TX accept field, to indicate whether the second access point device accepts a coordinated transmission with a J-TX scheme; or
a C-UL MU MIMO accept field, to indicate whether the second access point device accepts a coordinated transmission with a C-UL MU MIMO scheme.

In some embodiments, the processing unit 410 is further configured to:
if the first response frame includes CSI between the second access point device and an OBSS STA of the second access point device obtained by the second access point device, remove the following CSI from among the CSI between the second access point device and the OBSS STA of the second access point device according to participation of APs of the multi-AP coordinated set in the multi-AP coordinated transmission with the C-BF scheme and/or participation of STAs associated with the APs in the multi-AP coordinated transmission with the C-BF scheme, to obtain the target CSI:
CSI between the second access point device and an STA associated with an AP not participating in the multi-AP coordinated transmission with the C-BF scheme.

In some embodiments, the access point device 400 further includes:
a communication unit, configured to transmit a second request frame to at least one third access point device in the multi-AP coordinated set, where the second request frame is used to request the third access point device to feed back CSI information.

In some embodiments, the second request frame is transmitted by broadcasting, multicasting, or unicasting.

In some embodiments, the second request frame includes at least one of:
fifth indication information, where the fifth indication information is used to indicate the third access point device to feed back first-type CSI and/or second-type CSI;
AP number information, to indicate a number of APs included in the second request frame;
an AP list, including an AP participating in the multi-AP coordinated transmission with the C-BF scheme and/or an AP not participating in the multi-AP coordinated transmission with the C-BF scheme in the multi-AP coordinated set;
at least one list of associated STAs participating in C-BF, where each list of associated STAs participating in C-BF corresponds to an AP participating in the multi-AP coordinated transmission with the C-BF scheme, and the list of associated STAs participating in C-BF is used to indicate STAs participating in the multi-AP coordinated transmission with the C-BF scheme and associated with a corresponding AP; or
at least one list of associated STAs not participating in C-BF, where each list of associated STAs not participating in C-BF corresponds to an AP participating in the multi-AP coordinated transmission with the C-BF scheme, and the list of associated STAs not participating in C-BF is used to indicate STAs associated with a corresponding AP and not participating in the multi-AP coordinated transmission with the C-BF scheme.

In some embodiments, the second request frame includes a CSI request field, and the CSI request field includes at least one of:
a CSI request command field, to indicate to request the third access point device to feed back the first-type CSI and/or the second-type CSI;
an AP number field, to indicate a number of APs included in the second request frame;
at least one AP identification (ID) field, to indicate an AP participating in the multi-AP coordinated transmission with the C-BF scheme and/or an AP not participating in the multi-AP coordinated transmission with the C-BF scheme;
at least one associated STA list participating in C-BF field, where each STA list participating in C-BF field corresponds to an AP indicated by the at least one AP ID field, and the STA list participating in C-BF field is used to indicate STAs participating in the multi-AP coordinated transmission with the C-BF scheme and associated with a corresponding AP; or
at least one associated STA list non-participating in C-BF field, where each STA list non-participating in C-BF field corresponds to an AP indicated by the at least one AP ID field, and the STA list non-participating in C-BF field is used to indicate STAs not participating in the multi-AP coordinated transmission with the C-BF scheme and associated with a corresponding AP.

In some embodiments, the access point device 400 further includes:
a communication unit, configured to receive a second response frame transmitted by the at least one third access point device, where the second response frame includes CSI information fed back by the third access point device.

In some embodiments, the second response frame is transmitted synchronously or asynchronously by the at least one third access point device.

In some embodiments, the second response frame includes first-type CSI obtained by the third access point device and/or second-type CSI obtained by the third access point device.

In some embodiments, the second response frame includes a CSI information field, and the CSI information field is used to indicate the first-type CSI obtained by the third access point device and/or the second-type CSI obtained by the third access point device.

In some embodiments, the processing unit 410 is further configured to:

calculate the steering matrix corresponding to each first-type AP in the multi-AP coordinated set according to the target CSI.

In some embodiments, the access point device 400 further includes:
a communication unit, configured to transmit the target CSI to a master access point device.

In some embodiments, the access point device transmits the target CSI to the master access point device via a wired connection or a wireless connection.

In some embodiments, the access point device 400 further includes:
a communication unit, configured to transmit a third request frame to the master access point device by the access point device, where the third request frame includes the target CSI, and the third request frame is used to request the master access point device to calculate the steering matrix according to the target CSI.

In some embodiments, the third request frame includes a coordinated steering matrix request field, and the coordinated steering matrix request field includes at least one of:
an AP information number field, to indicate a number of AP information carried by the third request frame; or
at least one AP information field, to indicate information of an AP participating in the multi-AP coordinated transmission with the C-BF scheme.

In some embodiments, the AP information field includes at least one of:
an AP ID field, to indicate an AP participating in the multi-AP coordinated transmission with the C-BF scheme;
an associated STA list participating in C-BF field, to indicate STAs participating in the multi-AP coordinated transmission with the C-BF scheme and associated with the AP indicated by the AP ID;
an associated STA list non-participating in C-BF field, to indicate STAs not participating in the multi-AP coordinated transmission with the C-BF scheme and associated with the AP indicated by the AP ID field; or
a CSI information field, to indicate first-type CSI and/or second-type CSI obtained by an AP indicated by the AP ID field.

In some embodiments, the access point device 400 further includes:
a communication unit, configured to receive the steering matrix corresponding to each first-type AP in the multi-AP coordinated set, transmitted by the master access point device.

In some embodiments, the access point device receives the steering matrix corresponding to each first-type AP in the multi-AP coordinated set, transmitted by the master access point device, via a wired connection or a wireless connection.

In some embodiments, the access point device 400 further includes:
a communication unit, configured to receive a third response frame transmitted by the master access point device, where the third response frame includes the steering matrix corresponding to each first-type AP in the multi-AP coordinated set.

In some embodiments, the third response frame includes a coordinated steering matrix response field, and the coordinated steering matrix response field includes at least one of:
a steering matrix number field, to indicate a number of steering matrices of APs, carried by the third response frame;
at least one AP ID field, to indicate an AP participating in the multi-AP coordinated transmission with the C-BF scheme; or
at least one steering matrix field, where each steering matrix field corresponds to an AP indicated by the at least one AP ID field, and the steering matrix field is used to indicate the steering matrix adopted by a corresponding AP to perform the multi-AP coordinated transmission with the C-BF scheme.

In some embodiments, the access point device 400 further includes:
a communication unit, configured to transmit the steering matrix corresponding to each first-type AP, to the each first-type AP in the multi-AP coordinated set.

In some embodiments, the access point device transmits the steering matrix corresponding to each first-type AP, to the each first-type AP in the multi-AP coordinated set, via a wired connection or a wireless connection.

In some embodiments, the access point device 400 further includes:
a communication unit, configured to transmit a first announce frame, where the first announce frame includes the steering matrix corresponding to each first-type AP.

In some embodiments, the first announce frame includes a coordinated transmission announce field, and the coordinated transmission announce field is used to carry the steering matrix corresponding to each first-type AP.

In some embodiments, the coordinated transmission announce field includes at least one of:
a coordinated transmission scheme adopted field, to indicate a scheme adopted by performing the multi-AP coordinated transmission;
a C-BF parameter field, to indicate a parameter adopted by performing the multi-AP coordinated transmission with the C-BF scheme;
a C-OFDMA parameter field, to indicate a parameter adopted by performing the multi-AP coordinated transmission with a C-OFDMA scheme;
a C-SR parameter field, to indicate a parameter adopted by performing the multi-AP coordinated transmission with a C-SR scheme;
a J-TX parameter field, to indicate a parameter adopted by performing the multi-AP coordinated transmission with a J-TX scheme; or
a C-UL MU MIMO parameter field, to indicate a parameter adopted by performing the multi-AP coordinated transmission with a C-UL MU MIMO scheme.

In some embodiments, the C-BF parameter field includes at least one of:
an AP number field, to indicate a number of steering matrices of APs carried by the first announce frame;
at least one AP ID field, to indicate an AP participating in the multi-AP coordinated transmission with the C-BF scheme; or
at least one steering matrix field, where each steering matrix field corresponds to an AP indicated by the at least one AP ID field, and the steering matrix field is used to indicate the steering matrix adopted by a corresponding AP to perform the multi-AP coordinated transmission with the C-BF scheme.

In some embodiments, the coordinated transmission scheme adopted field includes at least one of:
a C-BF adopted field, to indicate whether to adopt the multi-AP coordinated transmission with the C-BF scheme;
a C-OFDMA adopted field, to indicate whether to adopt the multi-AP coordinated transmission with the C-OFDMA scheme;
a C-SR adopted field, to indicate whether to adopt the multi-AP coordinated transmission with the C-SR scheme;
a J-TX adopted field, to indicate whether to adopt the multi-AP coordinated transmission with the J-TX scheme; or
a C-UL MU MIMO adopted field, to indicate whether to adopt the multi-AP coordinated transmission with the C-UL MU MIMO scheme.

In some embodiments, the first announce frame is further used by an AP participating in the multi-AP coordinated transmission with the C-BF scheme to perform the multi-AP coordinated transmission with the C-BF scheme.

Optionally, in some embodiments, the above communication unit may be a communication interface or a transceiver, or an input and output interface of a communication chip or a system-on-chip. The above processing unit may be one or more processors.

It should be understood that the access point device 400 according to the embodiments of the present application may correspond to the first AP or the sharing AP in the method embodiments of the present application, and the above and other operations and/or functions of various units in the access point device 400 are respectively to implement the corresponding procedures of the first AP or the sharing AP in the method 200 shown in FIG. 6 to FIG. 36, which will not be repeated here for the sake of brevity.

FIG. 38 is a schematic block diagram of an access point device 500, according to the embodiments of the present application. The access point device 500 of FIG. 38 includes:
a communication unit 510, configured to transmit first-type channel state information (CSI) and/or second-type CSI obtained by the access point device to a first access point device, where the access point device is a first-type AP in a multi-AP coordinated set, the first-type CSI obtained by the access point device includes CSI between the access point device and a first-type station (STA) associated with the access point device, the second-type CSI obtained by the access point device includes CSI between the access point device and a first-type STA in an overlapping basic service set (OBSS) of the access point device, the first-type AP is an AP participating in a multi-AP coordinated transmission with a coordinated beamforming (C-BF) scheme, and the first-type STA is an STA participating in the multi-AP coordinated transmission with the C-BF scheme.

In some embodiments, the first access point device is a sharing AP, and the access point device is a shared AP.

In some embodiments, the first-type CSI and/or the second-type CSI obtained by the access point device is transmitted by the access point device to a sharing AP via a wired connection.

In some embodiments, the first-type CSI and/or the second-type CSI obtained by the access point device is transmitted by the access point device to a sharing AP via a wireless link.

In some embodiments, the communication unit 510 is further configured to:
receive a first request frame transmitted by the first access point device, where the first request frame is used to request the access point device to participate in the multi-AP coordinated transmission with the C-BF scheme.

In some embodiments, the first request frame is transmitted by broadcasting, multicasting, or unicasting.

In some embodiments, the first request frame includes at least one of:
first indication information, to indicate a coordinated transmission scheme requested to be used;
second indication information, to indicate whether to feed back the first-type CSI obtained by the access point device; or
third indication information, to indicate whether to feed back CSI between the access point device and non-associated OBSS STAs, obtained by the access point device.

In some embodiments, the first request frame includes a coordinated transmission request field, and the coordinated transmission request field includes at least one of:
a coordinated transmission scheme used field, to indicate a coordinated transmission scheme requested to be used;
a C-BF command field, to indicate a command used when the multi-AP coordinated transmission with the C-BF scheme is adopted;
a coordinated orthogonal frequency division multiple access (C-OFDMA) command field, to indicate a command used when the multi-AP coordinated transmission with a C-OFDMA scheme is adopted;
a coordinated spatial reuse (C-SR) command field, to indicate a command used when the multi-AP coordinated transmission with a C-SR scheme is adopted;
a joint transmission (J-TX) command field, to indicate a command used when the multi-AP coordinated transmission with a J-TX scheme is adopted; or
a coordinated uplink multiple user multiple input multiple output (C-UL MU MIMO) command field, to indicate a command used when the multi-AP coordinated transmission with a C-UL MU MIMO scheme is adopted.

In some embodiments, the C-BF command field includes at least one of:
a reporting associated STA's CSI field, to indicate whether to feed back the first-type CSI obtained by the access point device; or
a reporting OBSS STA's CSI field, to indicate whether to feed back CSI between the access point device and non-associated OBSS STAs, obtained by the access point device.

In some embodiments, the coordinated transmission scheme used field includes at least one of:
a C-BF used field, to indicate whether to request to use the multi-AP coordinated transmission with the C-BF scheme;
a C-OFDMA used field, to indicate whether the first access point device requests to use the multi-AP coordinated transmission with the C-OFDMA scheme;
a C-SR used field, to indicate whether the first access point device requests to use the multi-AP coordinated transmission with the C-SR scheme;
a J-TX used field, to indicate whether the first access point device requests to use the multi-AP coordinated transmission with the J-TX scheme; or
a C-UL MU MIMO used field, to indicate whether the first access point device requests to use the multi-AP coordinated transmission with the C-UL MU MIMO scheme.

In some embodiments, the communication unit 510 is further configured to:
transmit a first response frame to the first access point device, where the first response frame is used to indicate whether the access point device accepts to participate in the multi-AP coordinated transmission with the C-BF scheme.

In some embodiments, the first response frame includes at least one of:
fourth indication information, to indicate whether the access point device accepts a coordinated transmission scheme requested to be used;
a list of associated STAs participating in C-BF, including an STA associated with the access point device and participating in the multi-AP coordinated transmission with the C-BF scheme;
a list of associated STAs not participating in C-BF, including an STA associated with the access point device and not participating in the multi-AP coordinated transmission with the C-BF scheme; or
at least one CSI, including the first-type CSI obtained by the access point device and/or CSI between the access point device and non-associated OBSS STAs obtained by the access point device.

In some embodiments, the first response frame includes a coordinated transmission response field, and the coordinated transmission response field includes at least one of:
a coordinated transmission scheme accept field, to indicate a coordinated transmission scheme accepted by the access point device;
a C-BF information field, to indicate information related to the access point device with C-BF;
a C-OFDMA information field, to indicate information related to the access point device with C-OFDMA;
a C-SR information field, to indicate information related to the access point device with C-SR;
a J-TX information field, to indicate information related to the access point device with J-TX; or
a C-UL MU MIMO information field, to indicate information related to the access point device with C-UL MU MIMO.

In some embodiments, the C-BF information field includes at least one of:
an associated STA list participating in C-BF field, to indicate an STA associated with the access point device participating in the multi-AP coordinated transmission with the C-BF scheme;
an associated STA list non-participating in C-BF field, to indicate an STA associated with the access point device not participating in the multi-AP coordinated transmission with the C-BF scheme; or
a CSI information field, to indicate the first-type CSI obtained by the access point device and/or the second-type CSI obtained by the access point device.

In some embodiments, the coordinated transmission scheme accept field includes at least one of:
a C-BF accept field, to indicate whether the access point device accepts a coordinated transmission with the C-BF scheme;
a C-OFDMA accept field, to indicate whether the access point device accepts a coordinated transmission with a C-OFDMA scheme;
a C-SR accept field, to indicate whether the access point device accepts a coordinated transmission with a C-SR scheme;
a J-TX accept field, to indicate whether the access point device accepts a coordinated transmission with a J-TX scheme; or
a C-UL MU MIMO accept field, to indicate whether the access point device accepts a coordinated transmission with a C-UL MU MIMO scheme.

In some embodiments, the communication unit 510 is further configured to:
receive a second request frame transmitted by the first access point device, where the second request frame is used to request the access point device to feed back CSI information.

In some embodiments, the second request frame is transmitted by broadcasting, multicasting, or unicasting.

In some embodiments, the second request frame includes at least one of:
fifth indication information, where the fifth indication information is used to indicate the access point device to feed back first-type CSI and/or second-type CSI;
AP number information, to indicate a number of APs included in the second request frame;
an AP list, including an AP participating in the multi-AP coordinated transmission with the C-BF scheme and/or an AP not participating in the multi-AP coordinated transmission with the C-BF scheme in the multi-AP coordinated set;
at least one list of associated STAs participating in C-BF, where each list of associated STAs participating in C-BF corresponds to an AP participating in the multi-AP coordinated transmission with the C-BF scheme, and the list of associated STAs participating in C-BF is used to indicate STAs participating in the multi-AP coordinated transmission with the C-BF scheme and associated with a corresponding AP;
at least one list of associated STAs not participating in C-BF, where each list of associated STAs not participating in C-BF corresponds to an AP participating in the multi-AP coordinated transmission with the C-BF scheme, and the list of associated STAs not participating in C-BF is used to indicate STAs associated with a corresponding AP and not participating in the multi-AP coordinated transmission with the C-BF scheme.

In some embodiments, the second request frame includes a CSI request field, and the CSI request field includes at least one of the following fields:
a CSI request command field, to indicate to request the access point device to feed back the first-type CSI and/or the second-type CSI;
an AP number field, to indicate a number of APs included in the second request frame;
at least one AP identification (ID) field, to indicate an AP participating in the multi-AP coordinated transmission with the C-BF scheme and/or an AP not participating in the multi-AP coordinated transmission with the C-BF scheme;
at least one associated STA list participating in C-BF field, where each STA list participating in C-BF field corresponds to an AP indicated by the at least one AP ID field, and the STA list participating in C-BF field is used to indicate STAs participating in the multi-AP coordinated transmission with the C-BF scheme and associated with a corresponding AP; or
at least one associated STA list non-participating in C-BF field, where each STA list non-participating in C-BF field corresponds to an AP indicated by the at least one AP ID field, and the STA list non-participating in C-BF field is used to indicate STAs not participating in the multi-AP coordinated transmission with the C-BF scheme and associated with a corresponding AP.

In some embodiments, the communication unit 510 is further configured to:
transmit a second response frame to the first access point device, where the second response frame includes CSI information fed back by the access point device.

In some embodiments, the second response frame includes the second-type CSI obtained by the access point device.

In some embodiments, the second response frame includes the first-type CSI and the second-type CSI obtained by the access point device.

In some embodiments, the second response frame includes a CSI information field, and the CSI information field is used to indicate the first-type CSI obtained by the access point device and/or the second-type CSI obtained by the access point device.

In some embodiments, the communication unit 510 is further configured to:
receive a steering matrix corresponding to each first-type AP in the multi-AP coordinated set, transmitted by the first access point device.

In some embodiments, the steering matrix corresponding to each first-type AP is transmitted via a wired connection or a wireless connection.

In some embodiments, the communication unit 510 is further configured to:
receive a first announce frame, where the first announce frame includes the steering matrix corresponding to each first-type AP.

In some embodiments, the first announce frame includes a coordinated transmission announce field, and the coordinated transmission announce field is used to carry the steering matrix corresponding to each first-type AP.

In some embodiments, the coordinated transmission announce field includes at least one of:
a coordinated transmission scheme adopted field, to indicate a scheme adopted by performing the multi-AP coordinated transmission;
a C-BF parameter field, to indicate a parameter adopted by performing the multi-AP coordinated transmission with the C-BF scheme;
a C-OFDMA parameter field, to indicate a parameter adopted by performing the multi-AP coordinated transmission with a C-OFDMA scheme;
a C-SR parameter field, to indicate a parameter adopted by performing the multi-AP coordinated transmission with a C-SR scheme;
a J-TX parameter field, to indicate a parameter adopted by performing the multi-AP coordinated transmission with a J-TX scheme; or
a C-UL MU MIMO parameter field, to indicate a parameter adopted by performing the multi-AP coordinated transmission with a C-UL MU MIMO scheme.

In some embodiments, the C-BF parameter field includes at least one of:
an AP number field, to indicate a number of steering matrices of APs carried by the first announce frame;
at least one AP ID field, to indicate an AP participating in the multi-AP coordinated transmission with the C-BF scheme;
at least one steering matrix field, where each steering matrix field corresponds to an AP indicated by the at least one AP ID field, and the steering matrix field is used to indicate the steering matrix adopted by a corresponding AP to perform the multi-AP coordinated transmission with the C-BF scheme.

In some embodiments, the coordinated transmission scheme adopted field includes at least one of the following fields:
a C-BF adopted field, to indicate whether to adopt the multi-AP coordinated transmission with the C-BF scheme;
a C-OFDMA adopted field, to indicate whether to adopt the multi-AP coordinated transmission with the C-OFDMA scheme;
a C-SR adopted field, to indicate whether to adopt the multi-AP coordinated transmission with the C-SR scheme;
a J-TX adopted field, to indicate whether to adopt the multi-AP coordinated transmission with the J-TX scheme; or
a C-UL MU MIMO adopted field, to indicate whether to adopt the multi-AP coordinated transmission with the C-UL MU MIMO scheme.

In some embodiments, the first announce frame is also used to trigger an AP participating in the multi-AP coordinated transmission with the C-BF scheme to perform the multi-AP coordinated transmission with the C-BF scheme.

In some embodiments, the communication unit 510 is further configured to:
receive a steering matrix corresponding to each first-type AP in the multi-AP coordinated set, transmitted by a master access point device.

In some embodiments, the steering matrix corresponding to each first-type AP is transmitted via a wired connection or a wireless connection.

In some embodiments, the communication unit 510 is further configured to:
receive a second announce frame transmitted by the master access point device, where the second announce frame includes the steering matrix corresponding to each first-type AP.

In some embodiments, the second announce frame includes a coordinated transmission announce field, and the coordinated transmission announce field is used to carry the steering matrix corresponding to each first-type AP.

In some embodiments, the coordinated transmission announce field includes at least one of:
a coordinated transmission scheme adopted field, to indicate a scheme adopted by performing the multi-AP coordinated transmission;
a C-BF parameter field, to indicate a parameter adopted by performing the multi-AP coordinated transmission with the C-BF scheme;
a C-OFDMA parameter field, to indicate a parameter adopted by performing the multi-AP coordinated transmission with a C-OFDMA scheme;
a C-SR parameter field, to indicate a parameter adopted by performing the multi-AP coordinated transmission with a C-SR scheme;
a J-TX parameter field, to indicate a parameter adopted by performing the multi-AP coordinated transmission with a J-TX scheme; or
a C-UL MU MIMO parameter field, to indicate a parameter adopted by performing the multi-AP coordinated transmission with a C-UL MU MIMO scheme.

In some embodiments, the C-BF parameter field includes at least one of:
an AP number field, to indicate a number of steering matrices of APs carried by the second announce frame;
at least one AP ID field, to indicate an AP participating in the multi-AP coordinated transmission with the C-BF scheme; or
at least one steering matrix field, where each steering matrix field corresponds to an AP indicated by the at least one AP ID field, and the steering matrix field is used to indicate the steering matrix adopted by a corresponding AP to perform the multi-AP coordinated transmission with the C-BF scheme.

In some embodiments, the coordinated transmission scheme adopted field includes at least one of:
a C-BF adopted field, to indicate whether to adopt the multi-AP coordinated transmission with the C-BF scheme;
a C-OFDMA adopted field, to indicate whether to adopt the multi-AP coordinated transmission with the C-OFDMA scheme;
a C-SR adopted field, to indicate whether to adopt the multi-AP coordinated transmission with the C-SR scheme;
a J-TX adopted field, to indicate whether to adopt the multi-AP coordinated transmission with the J-TX scheme; or
a C-UL MU MIMO adopted field, to indicate whether to adopt the multi-AP coordinated transmission with the C-UL MU MIMO scheme.

In some embodiments, the second announce frame is further used to trigger an AP participating in the multi-AP coordinated transmission with the C-BF scheme to perform the multi-AP coordinated transmission with the C-BF scheme.

Optionally, in some embodiments, the above communication unit may be a communication interface or a transceiver, or an input and output interface of a communication chip or a system-on-chip. The above processing unit may be one or more processors.

It should be understood that the second access point device 500 according to the embodiments of the present application may correspond to the second AP or the shared AP in the method embodiments of the present application, and the above and other operations and/or functions of various units in the second access point device 500 are respectively to implement the corresponding procedures of the second AP or the shared AP in the method 200 shown in FIG. 6 to FIG. 36, which will not be repeated here for the sake of brevity.

FIG. 39 is a schematic block diagram of a master access point device 800 according to the embodiments of the present application. The master access point device 800 of FIG. 39 includes:
a processing unit 810, configured to acquire target channel state information (CSI), where the target CSI includes CSI between a first-type AP and a first-type station (STA);
where the first-type AP is an AP participating in a multi-AP coordinated transmission with a coordinated beamforming (C-BF) scheme in a multi-AP coordinated set, the first-type STA is an STA participating in the multi-AP coordinated transmission with the C-BF scheme, the target CSI is used to calculate a steering matrix corresponding to each first-type AP in the multi-AP coordinated set, and the steering matrix corresponding to the first-type AP is used by the first-type AP to perform the multi-AP coordinated transmission with the C-BF scheme.

In some embodiments, the target CSI includes first-type CSI and/or second-type CSI, where the first-type CSI includes CSI between the first-type AP and the first-type STA associated with the first-type AP, and the second-type CSI includes CSI between the first-type AP and the first-type STA in an overlapping basic service set (OBSS) of the first-type AP.

In some embodiments, the target CSI is acquired by the master access point device from the first access point device, or the target CSI is determined by the master access point device according to candidate CSI and target information;
where the first access point device is a sharing AP, the candidate CSI includes CSI obtained by the sharing AP from at least one shared AP and/or CSI obtained by the sharing AP, and the target information is used to indicate participation of APs of the multi-AP coordinated set in the multi-AP coordinated transmission with the C-BF scheme and/or participation of STAs associated with the APs in the multi-AP coordinated transmission with the C-BF scheme.

In some embodiments, the target CSI is acquired by the master access point device from the first access point device via a wired connection or a wireless connection; or the candidate CSI and the target information are acquired by the master access point device from the first access point device via a wired connection or a wireless connection.

In some embodiments, the processing unit 810 is further configured to:
remove the following CSI among the candidate CSI according to the target information, to obtain the target CSI:
CSI between the first-type AP and a second-type STA associated with the first-type AP;
CSI between the first-type AP and an STA associated with a second-type AP;
where the second-type STA is an STA not participating in the multi-AP coordinated transmission with the C-BF scheme, and the second-type AP is an AP not participating in the multi-AP coordinated transmission with the C-BF scheme in the multi-AP coordinated set.

In some embodiments, the master access point device 800 further includes:
a communication unit, configured to receive a third request frame transmitted by the sharing AP, where the third request frame is used to request the master access point device to calculate the steering matrix according to the target CSI, where the third request frame includes the target CSI or the third request frame includes the candidate CSI and the target information.

In some embodiments, the third request frame includes a coordinated steering matrix request field, and the coordinated steering matrix request field includes at least one of:
an AP information number field, to indicate a number of AP information carried by the third request frame; or at least one AP information field, to indicate information of an AP participating in the multi-AP coordinated transmission with the C-BF scheme.

In some embodiments, the AP information field includes at least one of:
an AP ID field, to indicate an AP participating in the multi-AP coordinated transmission with the C-BF scheme;
an associated STA list participating in C-BF field, to indicate STAs participating in the multi-AP coordinated transmission with the C-BF scheme and associated with the AP indicated by the AP ID;
an associated STA list non-participating in C-BF field, to indicate STAs not participating in the multi-AP coordinated transmission with the C-BF scheme and associated with the AP indicated by the AP ID field; or
a CSI information field, to indicate first-type CSI and/or second-type CSI obtained by an AP indicated by the AP ID field.

9. The method according to any one of claims 1 to 8, where the method further includes:
calculating by the master access point device, the steering matrix corresponding to each first-type AP in the multi-AP coordinated set according to the target CSI.

In some embodiments, the master access point device 800 further includes: a communication unit, configured to transmit the steering matrix corresponding to each first-type AP in the multi-AP coordinated set to the first AP.

In some embodiments, the steering matrix corresponding to each first-type AP is transmitted via a wired connection or a wireless connection.

In some embodiments, the master access point device 800 further includes:
a communication unit, configured to transmit a third response frame to the first access point device, where the third response frame includes the steering matrix corresponding to each first-type AP in the multi-AP coordinated set.

In some embodiments, the third response frame includes a coordinated steering matrix response field, and the coordinated steering matrix response field includes at least one of:
a steering matrix number field, to indicate a number of steering matrices of APs, carried by the third response frame;
at least one AP ID field, to indicate an AP participating in the multi-AP coordinated transmission with the C-BF scheme; or
at least one steering matrix field, where each steering matrix field corresponds to an AP indicated by the at least one AP ID field, and the steering matrix field is used to indicate the steering matrix adopted by a corresponding AP to perform the multi-AP coordinated transmission with the C-BF scheme.

In some embodiments, the master access point device 800 further includes:
a communication unit, configured to transmit the steering matrix corresponding to each first-type AP, to the each first-type AP in the multi-AP coordinated set.

In some embodiments, the master access point device 800 further includes:
a communication unit, configured to transmit a second announce frame, where the second announce frame includes the steering matrix corresponding to each first-type AP.

In some embodiments, the second announce frame includes a coordinated transmission announce field, and the coordinated transmission announce field is used to carry the steering matrix corresponding to each first-type AP.

In some embodiments, the second announce frame includes a coordinated transmission announce field, and the coordinated transmission announce field is used to carry the steering matrix corresponding to each first-type AP.

In some embodiments, the second announce frame includes a coordinated transmission announce field, and the coordinated transmission announce field is used to carry the steering matrix corresponding to each first-type AP.

In some embodiments, the coordinated transmission announce field includes at least one of:
a coordinated transmission scheme adopted field, to indicate a scheme adopted by performing the multi-AP coordinated transmission;
a C-BF parameter field, to indicate a parameter adopted by performing the multi-AP coordinated transmission with the C-BF scheme;
a C-OFDMA parameter field, to indicate a parameter adopted by performing the multi-AP coordinated transmission with a C-OFDMA scheme;
a C-SR parameter field, to indicate a parameter adopted by performing the multi-AP coordinated transmission with a C-SR scheme;
a J-TX parameter field, to indicate a parameter adopted by performing the multi-AP coordinated transmission with a J-TX scheme; or
a C-UL MU MIMO parameter field, to indicate a parameter adopted by performing the multi-AP coordinated transmission with a C-UL MU MIMO scheme.

In some embodiments, the C-BF parameter field includes at least one of:
an AP number field, to indicate a number of steering matrices of APs carried by the second announce frame;
at least one AP ID field, to indicate an AP participating in the multi-AP coordinated transmission with the C-BF scheme; or
at least one steering matrix field, where each steering matrix field corresponds to an AP indicated by the at least one AP ID field, and the steering matrix field is used to indicate the steering matrix adopted by a corresponding AP to perform the multi-AP coordinated transmission with the C-BF scheme.

In some embodiments, the coordinated transmission scheme adopted field includes at least one of:
a C-BF adopted field, to indicate whether to adopt the multi-AP coordinated transmission with the C-BF scheme;
a C-OFDMA adopted field, to indicate whether to adopt the multi-AP coordinated transmission with the C-OFDMA scheme;
a C-SR adopted field, to indicate whether to adopt the multi-AP coordinated transmission with the C-SR scheme;
a J-TX adopted field, to indicate whether to adopt the multi-AP coordinated transmission with the J-TX scheme; or
a C-UL MU MIMO adopted field, to indicate whether to adopt the multi-AP coordinated transmission with the C-UL MU MIMO scheme.

In some embodiments, the second announce frame is further used to trigger an AP participating in the multi-AP coordinated transmission with the C-BF scheme to perform the multi-AP coordinated transmission with the C-BF scheme.

Optionally, in some embodiments, the above communication unit may be a communication interface or a transceiver, or an input and output interface of a communication chip or a system-on-chip. The above processing unit may be one or more processors.

It should be understood that the master access point device 800 according to the embodiments of the present application may correspond to the master AP in the method embodiments of the present application, and the above and other operations and/or functions of various units in the master access point device 800 are respectively to implement the corresponding procedures of the master AP in the method 200 shown in FIG. 6 to FIG. 36, which will not be repeated here for the sake of brevity.

FIG. 40 is a schematic structural diagram of a communication device 600, provided by the embodiments of the present application. The communication device 600 shown in FIG. 40 includes a processor 610, the processor 610 may invoke and execute a computer program from a memory to implement the method in the embodiments of the present application.

Optionally, as shown in FIG. 21, the communication device 600 may further include a memory 620. Herein, the processor 610 may invoke and execute a computer program from the memory 620 to implement the method in the embodiments of the present application.

Herein, the memory 620 may be a separate device independent from the processor 610, or may also be integrated into the processor 610.

Optionally, as shown in FIG. 21, the communication device 600 may further include a transceiver 630, and the processor 610 may control the transceiver 630 to communicate with other devices, specifically, to transmit information or data to other devices, or receive information or data transmitted by other devices.

Herein, the transceiver 630 may include a transmitter and a receiver. The transceiver 630 may further include antenna(s), and the number of the antenna(s) may be one or more.

Optionally, the communication device 600 may specifically be the first AP or sharing AP in the embodiments of the present application, and the communication device 600 may implement the corresponding processes implemented by the first AP or sharing AP in various methods of the embodiments of the present application, which will not be repeated here, for the sake of brevity.

Optionally, the communication device 600 may specifically be the second AP or shared AP in the embodiments of the present application, and the communication device 600 may implement the corresponding processes implemented by the second AP or shared AP in various methods of the embodiments of the present application, which will not be repeated here, for the sake of brevity.

Optionally, the communication device 600 may specifically be the master AP in the embodiments of the present application, and the communication device 600 may implement the corresponding processes implemented by the master AP in various methods of the embodiments of the present application, which will not be repeated here, for the sake of brevity.

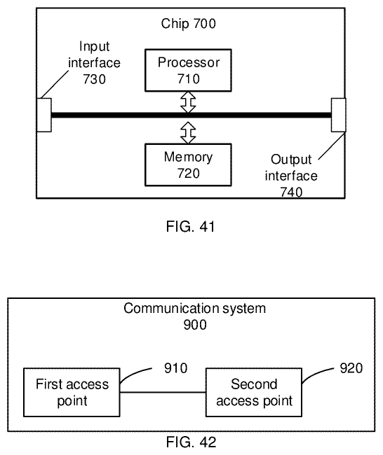

FIG. 41 is a schematic structural diagram of a chip of the embodiments of the present application. The chip 700 shown in FIG. 41 includes a processor 710, the processor 710 may invoke and execute a computer program from a memory to implement the method in the embodiments of the present application.

Optionally, as shown in FIG. 41, the chip 700 may further include a memory 720. Herein, the processor 710 may invoke and execute a computer program from the memory 720 to implement the method in the embodiments of the present application.

Herein, the memory 720 may be a separate device independent from the processor 710, or may also be integrated into the processor 710.

Optionally, the chip 700 may further include an input interface 730. Herein, the processor 710 may control the input interface 730 to communicate with other devices or chips, and specifically, the input interface 730 may acquire information or data sent by other devices or chips.

Optionally, the chip 700 may further include an output interface 740. Herein, the processor 710 may control the output interface 740 to communicate with other devices or chips, and specifically, the output interface 740 may output information or data to other devices or chips.

Optionally, the chip may be applied to the first AP or sharing AP in the embodiments of the present application, and the chip may implement the corresponding procedure implemented by the first AP or sharing AP in the various methods of the embodiments of the present application, which will not be repeated here for the sake of brevity.

Optionally, the chip may be applied to the second AP or shared AP in the embodiments of the present application, and the chip may implement the corresponding procedure implemented by the second AP or shared AP in the various methods of the embodiments of the present application, which will not be repeated here for the sake of brevity.

Optionally, the chip may be applied to the master AP in the embodiments of the present application, and the chip may implement the corresponding procedure implemented by the master AP in the various methods of the embodiments of the present application, which will not be repeated here for the sake of brevity.

It should be understood that the chip mentioned in the embodiments of the present application may also be referred to as a system on chip, a system chip, a chip system or a system-on-chip chip, etc.

FIG. 42 is a schematic block diagram of a communication system 900, provided in the embodiments of the present application. As shown in FIG. 42, the communication system 900 includes a first access point 910 and a second access point 920.

Herein, the first access point 910 may be used to implement the corresponding functions implemented by the first AP or sharing AP in the above method, and the second access point 920 may be used to implement the corresponding functions implemented by the second AP or shared AP in the above method, which will not be repeated here for the sake of brevity.

Optionally, the communication system 900 may further include a master AP for implementing the corresponding functions implemented by the master AP in the above methods, which will not be repeated here for the sake of brevity.

It should be understood that the processor in the embodiments of the present application may be an integrated circuit chip and have a processing capability of signals. In the implementation process, various steps of the above method embodiments may be completed by an integrated logic circuit of hardware in the processor or an instruction in a software form. The above processor may be a general-purpose processor, a Digital Signal Processor (DSP), an Application Specific Integrated Circuit (ASIC), a Field Programmable Gate Array (FPGA) or other programmable logic devices, a discrete gate or transistor logic device, a discrete hardware component. Various methods, steps and logical block diagrams disclosed in the embodiments of the present application may be implemented or performed. A general-purpose processor may be a microprocessor, or the processor may also be any conventional processor, etc. The steps of the method disclosed in combination with the embodiments of the present application may be directly embodied as being performed and completed by a hardware decoding processor, or by using a combination of hardware and software modules in the decoding processor. The software module may be located in the mature storage medium in the art such as the random memory, the flash memory, the read-only memory, the programmable read-only memory or electrically erasable programmable memory, the register. The storage medium is located in the memory, and the processor reads the information in the memory and completes the steps of the above methods in combination with its hardware.

It may be understood that the memory in the embodiments of the present application may be a volatile memory or a non-volatile memory, or may include both volatile and non-volatile memories. Herein, the non-volatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM) or a flash memory. The volatile memory may be a Random Access Memory (RAM), which is used as an external cache. Through illustrative, rather than limiting, illustration, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM) and a direct rambus random access memory (Direct Rambus RAM, DR RAM). It should be noted that the memory of the system and the method described herein is intended to include, but not limited to, these and any other suitable types of memories.

It should be understood that the above memory is exemplary but not limiting illustration, e.g., the memory in embodiments of the present application may also be a static Random Access Memory (static RAM, SRAM), a Dynamic Random Access Memory (dynamic RAM, DRAM), a synchronous DRAM (SDRAM), a double data rate SDRAM (DDR SDRAM), an enhanced SDRAM (ESDRAM), a synch link DRAM (SLDRAM), and a Direct Rambus RAM (DR RAM), etc. That is, the memory in the embodiments of the present application is intended to include, but not limited to, these and any other suitable types of memories.

The embodiments of the present application further provide a non-transitory computer readable storage medium for storing a computer program.

Optionally, the non-transitory computer readable storage medium may be applied to the first AP or sharing AP in the embodiments of the present application, and the computer program causes a computer to perform the corresponding procedure implemented by the first AP or sharing AP in the various methods of the embodiments of the present application, which will not be repeated here for the sake of brevity.

Optionally, the non-transitory computer readable storage medium may be applied to the second AP or shared AP in the embodiments of the present application, and the computer program causes a computer to perform the corresponding procedure implemented by the second AP or shared AP in various methods of the embodiments of the present application, which will not be repeated here for the sake of brevity.

Optionally, the non-transitory computer-readable storage medium may be applied to the master AP in the embodiments of the present application, and the computer program enables the computer to execute the corresponding procedures implemented by the master AP in the various methods of the embodiments of the present application, which will not be repeated here for the sake of brevity.

The embodiments of the present application further provide a computer program product including a computer program instruction.

Optionally, the computer program product may be applied to the first AP or sharing AP in the embodiments of the present application, and the computer program instruction causes a computer to perform the corresponding procedure implemented by the first AP or sharing AP in the various methods of the embodiments of the present application, which will not be repeated here for the sake of brevity.

Optionally, the computer program product may be applied to the second AP or shared AP in the embodiments of the present application, and the computer program instruction causes a computer to perform the corresponding procedure implemented by the second AP or shared AP in various methods of the embodiments of the present application, which will not be repeated here for the sake of brevity.

Optionally, the computer program product may be applied to the master AP in the embodiments of the present application, and the computer program instruction enables the computer to execute the corresponding procedures implemented by the master AP in the various methods of the embodiments of the present application, which will not be repeated here for the sake of brevity.

The embodiments of the present application further provide a computer program.

Optionally, the computer program may be applied to the first AP or sharing AP in the embodiments of the present application, the computer program when being executed on a computer, causes the computer to perform the corresponding procedure implemented by the first AP or sharing AP in various methods of the embodiments of the present application, which will not be repeated here for the sake of brevity.

Optionally, the computer program may be applied to the second AP or shared AP in the embodiments of the present application, the computer program when being executed on a computer, causes the computer to perform the corresponding procedure implemented by the second AP or shared AP in various methods of the embodiments of the present application, which will not be repeated here for the sake of brevity.

Optionally, the computer program may be applied to the master AP in the embodiments of the present application, the computer program when being executed on a computer, causes the computer to perform the corresponding procedures implemented by the master AP in various methods of the embodiments of the present application, which will not be repeated here for the sake of brevity.

Those ordinary skilled in the art may realize that, units and algorithm steps of the examples described in combination with the embodiments disclosed herein can be implemented in electronic hardware or in a combination of computer software and electronic hardware. Whether these functions are performed by way of hardware or software depends on a specific application and a design constraint of the technical solution. A skilled person may use different methods for each specific application, to implement the described functions, but such implementation should not be considered beyond the scope of the present application.

It may be clearly understood by those skilled in the art that, for convenience and brevity of the description, the specific working procedures of the system, the apparatus and the unit described above may refer to the corresponding procedures in the above method embodiments, which will not be repeated here.

In the several embodiments provided by the application, it should be understood that, the disclosed systems, apparatus, and method may be implemented in other ways. For example, the apparatus embodiments described above are only schematic, for example, division of the units is only division of logical functions, and there may be other division methods in an actual implementation, for example, a plurality of units or components may be combined or integrated into another system, or some features may be ignored or not performed. On the other hand, the coupling or direct coupling or communicative connection between each other as shown or discussed may be indirect coupling or communicative connection of apparatus or units via some interfaces, which may be electrical, mechanical, or in other forms.

The units illustrated as separate components may be or may not be physically separated, and the components shown as units may be or may not be physical units, that is, they may be located in one place, or may be distributed onto a plurality of network units. A part or all of the units may be selected according to actual needs, to implement the purpose of the schemes of the embodiments.

In addition, the various functional units in the various embodiments of the present application may be integrated into one processing unit, or the various units may exist physically separately, or two or more units may be integrated into one unit.

If the described functions are implemented in a form of a software functional unit and sold or used as an independent product, they may be stored in a non-transitory computer readable storage medium. Based on this understanding, the technical solution of the present application essentially, or a part of the technical solution that contributes to the prior art, or a part of the technical solution, may be embodied in a form of a software product, and the computer software product is stored in a non-transitory storage medium, and includes a plurality of instructions for enabling a computer device (which may be a personal computer, a server, or a network device, etc.) to perform all or some of steps of the methods described in the various embodiments of the present application. And, the non-transitory storage medium mentioned above includes a USB flash drive (U disk), a mobile hard disk, a Read-Only Memory (ROM), a Random Access Memory (RAM), a diskette, or an optical disk, and various mediums that may store program codes.

The above content is only specific implementations of the present application, but the protection scope of the present application is not limited thereto, and any skilled familiar with this technical field may easily think of changes or substitutions within the technical scope disclosed in the present application, which should be all covered within the protection scope of the present application. Therefore, the protection scope of the present application should be subject to the protection scope of the claims.

What is claimed is:

1. A first access point (AP), comprising:
a memory, configured to store a computer program; and
a processor, configured to invoke and execute the computer program stored in the memory, to perform:
acquiring target channel state information (CSI), wherein the target CSI comprises CSI between a first-type AP and a first-type station (STA), wherein the first-type AP is an AP participating in a multi-AP coordinated transmission with a coordinated beamforming (C-BF) scheme in a multi-AP coordinated set, the first-type STA is an STA participating in the multi-AP coordinated transmission with the C-BF scheme, the target CSI is used to calculate a steering matrix corresponding to each first-type AP in the multi-AP coordinated set, and the steering matrix corresponding to the first-type AP is used by the first-type AP to perform the multi-AP coordinated transmission with the C-BF scheme.

2. The first AP according to claim 1, wherein the target CSI comprises first-type CSI and/or second-type CSI, wherein the first-type CSI comprises CSI between the first-type AP and the first-type STA associated with the first-type AP, and the second-type CSI comprises CSI between the first-type AP and the first-type STA in an overlapping basic service set (OBSS) of the first-type AP.

3. The first AP according to claim 1, wherein the first AP is a sharing AP, and the target CSI is determined according to CSI acquired by the sharing AP from at least one shared AP and/or CSI acquired by the sharing AP through channel sounding.

4. The first AP according to claim 1, wherein the first AP further comprises:
a transceiver, configured to perform, under control of the processor, transmitting a first request frame to at least one second AP in the multi-AP coordinated set, wherein the first request frame is used to request the at least one second AP to participate in the multi-AP coordinated transmission with the C-BF scheme.

5. The first AP according to claim 4, wherein the first request frame comprises at least one of the following information:
first indication information, to indicate a coordinated transmission scheme requested to be used;
second indication information, to indicate whether to feed back the first-type CSI obtained by the second AP;
third indication information, to indicate whether to feed back CSI between the second AP and non-associated OBSS STAs, obtained by the second AP.

6. The first AP according to claim 4, wherein the transceiver is further configured to perform:
receiving a first response frame transmitted by the at least one second AP, wherein the first response frame is used to indicate whether the second AP accepts to participate in the multi-AP coordinated transmission with the C-BF scheme.

7. The first AP according to claim 6, wherein the first response frame comprises at least one of:
fourth indication information, to indicate whether the second AP accepts a coordinated transmission scheme requested to be used;
a list of associated STAs participating in C-BF, comprising an STA associated with the second AP and participating in the multi-AP coordinated transmission with the C-BF scheme;
a list of associated STAs not participating in C-BF, comprising an STA associated with the second AP and not participating in the multi-AP coordinated transmission with the C-BF scheme; or
at least one CSI, comprising the first-type CSI obtained by the second AP and/or CSI between the second AP and non-associated OBSS STAs obtained by the second AP.

8. The first AP according to claim 6, wherein the processor further performs:
if the first response frame comprises CSI between the second AP and non-associated OBSS STAs obtained by the second AP, removing according to participation of APs of the multi-AP coordinated set in the multi-AP coordinated transmission with the C-BF scheme and/or participation of STAs associated with the APs in the multi-AP coordinated transmission with the C-BF scheme, CSI between the second AP and an STA associated with an AP not participating in the multi-AP coordinated transmission with the C-BF scheme from among the CSI between the second AP and the non-associated OBSS STAs, to obtain the target CSI.

9. The first AP according to claim 1, wherein the first AP further comprises:
a transceiver, configured to perform, under control of the processor, transmitting a second request frame to at least one third AP in the multi-AP coordinated set, wherein the second request frame is used to request the third AP to feed back CSI information.

10. The first AP according to claim 9, wherein the second request frame is transmitted by broadcasting, multicasting, or unicasting.

11. The first AP according to claim 10, wherein the second request frame comprises at least one of:
fifth indication information, wherein the fifth indication information is used to indicate the third AP to feed back first-type CSI and/or second-type CSI;
AP number information, to indicate a number of APs comprised in the second request frame;
an AP list, comprising an AP participating in the multi-AP coordinated transmission with the C-BF scheme and/or an AP not participating in the multi-AP coordinated transmission with the C-BF scheme in the multi-AP coordinated set;
at least one list of associated STAs participating in C-BF, wherein each list of associated STAs participating in C-BF corresponds to an AP participating in the multi-AP coordinated transmission with the C-BF scheme, and the list of associated STAs participating in C-BF is used to indicate STAs participating in the multi-AP coordinated transmission with the C-BF scheme and associated with a corresponding AP; or
at least one list of associated STAs not participating in C-BF, wherein each list of associated STAs not participating in C-BF corresponds to an AP participating in the multi-AP coordinated transmission with the C-BF scheme, and the list of associated STAs not participating in C-BF is used to indicate STAs associated with a corresponding AP and not participating in the multi-AP coordinated transmission with the C-BF scheme.

12. The first AP according to claim 9, wherein the second request frame comprises a CSI request field, and the CSI request field comprises at least one of:
a CSI request command field, to indicate to request the third AP to feed back the first-type CSI and/or the second-type CSI;
an AP number field, to indicate a number of APs comprised in the second request frame;
at least one AP identification (ID) field, to indicate an AP participating in the multi-AP coordinated transmission with the C-BF scheme and/or an AP not participating in the multi-AP coordinated transmission with the C-BF scheme;
at least one associated STA list participating in C-BF field, wherein each STA list participating in C-BF field corresponds to an AP indicated by the at least one AP ID field, and the STA list participating in C-BF field is used to indicate STAs participating in the multi-AP coordinated transmission with the C-BF scheme and associated with a corresponding AP; or
at least one associated STA list non-participating in C-BF field, wherein each STA list non-participating in C-BF field corresponds to an AP indicated by the at least one AP ID field, and the STA list non-participating in C-BF field is used to indicate STAs not participating in the multi-AP coordinated transmission with the C-BF scheme and associated with a corresponding AP.

13. The first AP according to claim 9, wherein the transceiver is further configured to perform:
receiving a second response frame transmitted by the at least one third AP, wherein the second response frame comprises CSI information fed back by the third AP.

14. The first AP according to claim 1, wherein the first AP further comprises:
a transceiver, configured to perform, under control of the processor, transmitting the target CSI to a master AP.

15. The first AP according to claim 14, wherein transmitting the target CSI to the master AP, comprises:
transmitting a third request frame to the master AP, wherein the third request frame comprises the target CSI, and the third request frame is used to request the master AP to calculate the steering matrix according to the target CSI.

16. The first AP according to claim 15, wherein the third request frame comprises a coordinated steering matrix request field, and the coordinated steering matrix request field comprises at least one of:
an AP information number field, to indicate a number of AP information carried by the third request frame; or
at least one AP information field, to indicate information of an AP participating in the multi-AP coordinated transmission with the C-BF scheme.

17. The first AP according to claim 14, wherein the transceiver is further configured to perform:
receiving the steering matrix corresponding to each first-type AP in the multi-AP coordinated set, transmitted by the master AP.

18. The first AP according to claim 17, wherein receiving the steering matrix corresponding to each first-type AP in the multi-AP coordinated set, transmitted by the master AP, comprises:
receiving a third response frame transmitted by the master AP, wherein the third response frame comprises the steering matrix corresponding to each first-type AP in the multi-AP coordinated set.

19. A second access point (AP), comprising:
a transceiver;
a memory, configured to store a computer program; and
a processor, configured to invoke and execute the computer program stored in the memory, to control the transceiver to perform:
transmitting first-type channel state information (CSI) and/or second-type CSI obtained by the second AP to a first AP, wherein the second AP is a first-type AP in a multi-AP coordinated set, the first-type CSI obtained by the second AP comprises CSI between the second AP and a first-type station (STA) associated with the second AP, the second-type CSI obtained by the second AP comprises CSI between the second AP and a first-type STA in an overlapping basic service set (OBSS) of the second AP, the first-type AP is an AP participating in a multi-AP coordinated transmission with a coordinated beamforming (C-BF) scheme, and the first-type STA is an STA participating in the multi-AP coordinated transmission with the C-BF scheme.

20. A master access point (AP), comprising:
a memory, configured to store a computer program; and
a processor, configured to invoke and execute the computer program stored in the memory, to perform:
acquiring target channel state information (CSI), wherein the target CSI comprises CSI between a first-type AP and a first-type station (STA);
wherein the first-type AP is an AP participating in a multi-AP coordinated transmission with a coordinated beamforming (C-BF) scheme in a multi-AP coordinated set, the first-type STA is an STA participating in the multi-AP coordinated transmission with the C-BF scheme, the target CSI is used to calculate a steering matrix corresponding to each first-type AP in the multi-AP coordinated set, and the steering matrix corresponding to the first-type AP is used by the first-type AP to perform the multi-AP coordinated transmission with the C-BF scheme.
